(19) United States
(12) Patent Application Publication
(10) Pub. No.: US 2024/0262750 A1
(43) Pub. Date: Aug. 8, 2024

(54) CEMENTITIOUS MATERIALS FOR APPLICATIONS IN SUPER-HOT AND SUPERCRITICAL UNDERGROUND WELLS

(71) Applicant: Brookhaven Science Associates, LLC, UPTON, NY (US)

(72) Inventors: Tatiana Pyatina, Stony Brook, NY (US); Toshifumi Sugama, Wading River, NY (US)

(21) Appl. No.: 18/432,615

(22) Filed: Feb. 5, 2024

Related U.S. Application Data
(60) Provisional application No. 63/483,485, filed on Feb. 6, 2023.

(51) Int. Cl. C04B 28/06; C04B 14/02; C04B 14/04; C04B 14/30; C04B 28/04; C04B 28/34; C04B 40/00; C04B 111/20; C09K 8/467; E21B 33/14

(52) U.S. Cl. CPC C04B 28/06; C04B 14/024; C04B 14/026; C04B 14/045; C04B 14/306; C04B 28/04; C04B 28/34; C04B 40/0071; C04B 40/0082; C09K 8/467; E21B 33/14; C04B 2111/2084; C04B 2201/32; C04B 2201/50

(57) ABSTRACT

In one aspect, the disclosure relates to calcium-free aluminum-based cement formulations designed for applications under supercritical conditions and in corrosive environments. In an aspect, alkali activation of aluminum hydroxide at high temperatures leads to the formation of mineral phases stable under supercritical and superhot conditions. In another aspect, these include, but are not limited to, crystalline phases of boehmite and paragonite and, optionally, a minor vlasovite phase. In yet another aspect, the compositions and articles made therefrom, such as geothermal well sheaths, are stable under the extreme conditions, and water-fillable porosity and mechanical properties of these cement formulations persist through super-critical exposure.

### CROSS REFERENCE TO RELATED APPLICATIONS

This application claims the benefit of U.S. Provisional Application No. 63/483,485 filed on Feb. 6, 2023, which is incorporated herein by reference in its entirety.

### STATEMENT OF GOVERNMENT RIGHTS

The present invention was made with government support under contract number DE-SC0012704 awarded by the U.S. Department of Energy. The United States government may have certain rights in this invention.

### BACKGROUND

As well documented, the natural hydrous fluid as energy conversion resources present in the supercritical geothermal environment at depths of 3-5 km at temperatures ≥400° C. and pressure ≥24.1 MPa plays a pivotal role in significantly augmenting the power output at geothermal steam-generated powerplants. In contrast, the utilization of geofluid in the conventional geothermal well located at a downhole pressure of ˜3 MPa and temperature of 300° C. generally yields the electric power of ˜5 MW at volumetric steam inflow rate of 0.67 m³/sec. At same inflow rate, supercritical hydrous fluid serves in providing high-enthalpy steam to yield ˜50 MW of electric power at pressure of ˜26 MPa and temperature of 450° C., corresponding to a 10-fold augment in power output compared to that of conventional geofluid. Additionally, such high pressure leads to the enhanced mass-flow rate. Thus, it is no doubt that utilizing the supercritical hydrous fluid as considerable high geothermal energy conversion resource has a high potential for substantially reducing the levelized cost of electricity (LCOE) generated from geothermal power stations.

Considering the supercritical environments, it promotes the reactions of superheat water with rocks, leading to the dissolution of basalt rock minerals [albite (NaAlSi₃O₈) as Na-feldspar, orthoclase and microcline (KAlSi₃O₈) as K-feldspars, volcanic glasses (SiO₂), olivine [(Mg, Fe)₂SiO₄], pyroxene as silicates including Al, Fe, Ti, Cr, V, Zr, Mg, Mn, Li, Zn, Ca, and Na elements, halite rock mineral (NaCl), and carbonate (CaCO₃). The main oxide composition (wt %) of basalt rock is composed of 52-45 SiO₂, ˜14Al₂O₃, 14-5FeO, 12-5MgO, ˜10CaO, 5-2 total alkali metals including Li₂O, Na₂O, and K₂O, and 2-0.5 TiO₂. Thus, complicated hydrous fluids encompass multitude ionic species, H₄SiO_{4 (aq)}, Fe²⁺, Mg²⁺, Ca²⁺, Li⁺, Na⁺, K⁺, Ti³⁺, Al(OH)₄⁻, OH⁻, Cl⁻, and the like, brought about by dissolution of these oxides, chloride, and carbonate with many different elemental fractions.

In very hostile thermochemical geothermal environments such as these, the geothermal well cement sheath between the casing string and rock/clay formation encounters variable mechanical-and chemical-stresses that can lead to micro-annuli and cracks, increased cement permeability, cement debondement from metal casing and formation, casing corrosion by geothermal fluids migrating through defected cement sheath and compromised zonal isolation. Current cement formulations using Portland cement are not acid and thermal shock resistant.

Based upon the above information, a considerable attention was paid to the cementitious sheath materials placing in the annulus between the metal casing and rock formations. The placed cement is required to withstand such a harsh, corrosive supercritical condition for sustaining the well integrity. In particular, the raising concerns about the durability of cement sheath are as follows: supercritical-led water oxidation (scO₂) and carbonation (scCO₂) as well as very hot acid-initiated erosion.

Very high temperature (>400° C.) geothermal wells could provide competitive power at potentially $20-35 per megawatt-hour (MWh). Currently most geothermal plants rely on concentrated heat located near the surface producing globally only 15 gigawatts (GW). Development and exploitation of super-critical wells may increase energy production by 10 times per well over conventional geothermal and 4-5 times more energy per well than typical shale gas fields. Several worldwide projects have already demonstrated a possibility of reaching super-hot conditions and hot wells potential for power production. They include Iceland Deep Drilling Project, Newberry Super-Hot Rock project, Japan Beyond Brittle project, Italy's Larderello geothermal field DESCRAMBLE project, and the New Zealand Hotter and Deeper project.

One of the necessary components for the construction of hot-temperature wells are materials that can survive under the well conditions. Cements that provide zonal isolation, well structure support, and corrosion protection for metallic casing must be designed for temperatures above about 300° C. typical for current well cements.

Despite advances in geothermal cement research, there is still a scarcity of cementitious materials that are stable under hydrothermal (e.g. high temperature, high pressure, and the like) conditions while maintaining acceptable physical properties. These needs and other needs are satisfied by the present disclosure.

### SUMMARY

In accordance with the purpose(s) of the present disclosure, as embodied and broadly described herein, the disclosure, in one aspect, relates to calcium-free aluminum-based cement formulations designed for applications under supercritical conditions and in corrosive environments. In an aspect, alkali activation of aluminum hydroxide at high temperatures leads to the formation of mineral phases stable under supercritical and superhot conditions. In another aspect, these include, but are not limited to, crystalline phases of boehmite and paragonite and, optionally, a minor vlasovite phase. In yet another aspect, the compositions and articles made therefrom, such as geothermal well sheaths, are stable under the extreme conditions, and water-fillable porosity and mechanical properties of these cement formulations persist through super-critical exposure.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows XRD patterns of CaO—SiO₂ (S-1) cement formulation after 300° C. curing and 400° C. curing. X—Xonotlite-Ma2bc (ICDD: 00-023-0125), Si—Silicon oxide (ICDD: 04-015-7165/01-077-8641/01-085-0797/01-0762980/01-089-8936/04-015-7167), W—Wollastonite-1A (ICDD: 00-042-0547), CC—Calcium Carbonate (ICDD: 01-085-6714/01-086-4274/04-013-7324), An—Andradite (ICDD: 01-084-8181), Pt—Pitiglianoite (ICDD: 04-014-5729), P—Portlandite (ICDD: 00-050-0008).

FIG. 2 shows photomicrographs of CaO—SiO₂ (S-1) cement formulation after 300° C. curing and 400° C. curing.

FIG. 3 shows XRD patterns of P₂O₅—Na₂O—CaO—Al₂O₃—SiO₂ (S-2, Al₂O₃/SiO₂=1.4) cement formulation after 300° C. curing and 400° C. curing. Dm—Dmisteinbergite (ICDD: 00-051-0064), B—Bohmite (04-012-5050/01-088-2487), A—Analcime (ICDD: 01-070-1575), HA—Hydroxyapatite (ICDD: 01-074-9775), Prg—Paragonite-3T (ICDD: 01-083-2129), Mrg—Margarite 2M1 (ICDD: 04-013-3004), Si—Silicon oxide (ICDD: 01-088-2487), Dw—Donwilhelmsite (ICDD: 00-051-0093)

FIG. 4 shows photomicrographs of P₂O₅—Na₂O—CaO—Al₂O₃—SiO₂ (S-2, Al₂O₃/SiO₂=1.4) cement formulation after 300° C. curing and 400° C. curing.

FIG. 5 shows XRD patterns of P₂O₅—Na₂O—CaO—Al₂O₃—SiO₂ (S-3, Al₂O₃/SiO₂=2.9) cement formulation after 300° C. curing and 400° C. curing. B—Bohmite (ICDD: 04-014-2197), CA—Carbonated Apatite (ICDD: 04-012-6510), Sd—Sodalite (ICDD: 01-073-5298), Cn—Cancrinite (ICDD: 04-011-2738), HA—Hydroxyapatite (ICDD: 04-013-6655), Prg—Paragonite-3T (ICDD: 01-083-2129), Ab—Albite (00-009-0466).

FIG. 6 shows photomicrographs of P₂O₅—Na₂O—CaO—Al₂O₃—SiO₂ (S-3, Al₂O₃/SiO₂=2.9) cement formulation after 300° C. curing and 400° C. curing.

FIG. 7 shows XRD patterns of P₂O₅—Na₂O—CaO—Al₂O₃—SiO₂—Fe₂O₃(S-4, Al₂O₃/SiO₂=3.9) cement formulation after 300° C. curing and 400° C. curing. B—Bohmite (ICDD: 04-014-2197), HA—Hydroxylapatite (ICDD: 01-080-3243), CA—Carbonate apatite (ICDD: 01-072-9861), Sd—Sodalite (ICDD: 01-073-5298), Si—silicon oxide (ICDD: 04-008-8222), Prg—Paragonite-3T (ICDD: 01-083-2129), Ab—Albite (ICDD: 00-009-0466), Cn—Cancrinite (ICDD: 04-011-2738), CC—calcium carbonate (ICDD: 04-014-1681), Srb—Srebrodolskite (ICDD: 01-084-9445), FeSi—Asimowite ferrian (ICDD: 00-050-0088).

FIG. 8 shows photomicrographs of P₂O₅—Na₂O—CaO—Al₂O₃—SiO₂—Fe₂O₃(S-4, Al₂O₃/SiO₂=3.9) cement formulation after 300° C. curing and 400° C. curing.

FIG. 9 shows XRD patterns of Na₂O—CaO—Al₂O₃—SiO₂—MgO—Fe₂O₃(S-5, Al₂O₃/SiO₂=0.43) cement formulation after 300° C. curing and 400° C. curing. Dm—Dmisteinbergite (ICDD: 00-051-0064), An—Anorthite Na-bearing (ICDD: 01-078-2330), Si—Silicon oxide (ICDD: 01-077-8623/01-075-8322), K—Katoite (ICDD: 01-074-2900/01-077-1713), B—Boehmite (ICDD: 04-017-4319), Gr—Grossular, Fe-bearing (ICDD: 01-076-0923), Dp—Diopside (ICDD: 01-085-2500), Pg—Pigeonite (ICDD: 01-071-0712), Mrg—Margarite-2M1 (ICDD: 01-076-0883), Fe—Hematite (ICDD: 01-080-5408), CC—Calcite (ICDD: 04-012-8072), NaAl—Sodium oxide aluminum oxide (ICDD: 01-076-0923).

FIG. 10 shows photomicrographs of Na₂O—CaO—Al₂O₃—SiO₂—MgO—Fe₂O₃(S-5, Al₂O₃/SiO₂=0.43) cement formulation after 300° C. curing and 400° C. curing.

FIG. 11 shows XRD patterns of Na₂O—CaO—Al₂O₃—SiO₂—MgO (S-6, Al₂O₃/SiO₂=0.15) cement formulation after 300° C. curing and 400° C. curing. Dm—Dmisteinbergite (ICDD: 04-011-6236), Si—Silicon oxide (ICDD: 01-080-2157/01-086-4007), B—Bohmite (ICDD: 04-010-5683), Gr—Grossular, Fe-bearing (ICDD: 01-076-0923/00-003-0801), Ge—Gehlenite (ICDD: 04-014-7820), Sd—Sodalite (ICDD: 00-011-0401), X—Xonotlite-2M (ICDD: 01-076-1846), An—Anorthite (ICDD: 01-074-2539), MS—Magnesium Silicate (ICDD: 01-076-6764/04-008-5467), PW—Pseudowollastonite (ICDD: 04-011-3072), W—Wollastonite (ICDD: 01-076-1846), AMN—Aluminum Magnesium Sodium oxide (ICDD: 01-073-9552).

FIG. 12 shows photomicrographs of Na₂O—CaO—Al₂O₃—SiO₂—MgO (S-6, Al₂O₃/SiO₂=0.15) cement formulation after 300° C. curing and 400° C. curing.

FIG. 13 shows XRD patterns of Na₂O—Al₂O₃—SiO₂ (S-7, Al₂O₃/SiO₂=1.5) cement formulation after 400° C. curing. Al₂O₃— corundum (ICDD: 01-073-6190), Si—Quartz (ICDD: 01-075-8320), Ab—Albite (ICDD: 01-089-6430), Gar—Garronite (ICDD: 00-070-0072).

FIG. 14 shows photomicrographs of Na₂O—Al₂O₃—SiO₂ (S-7, Al₂O₃/SiO₂=1.5) cement formulation after 400° C. curing.

FIG. 15 shows surface of Inconel rapture disk after 72 hrs in an autoclave with cement samples at 400° C., 25.5 MPa hydrothermal environment. The bright spots are locations of pitting corrosion seen all over the disk. The profile of the deepest corrosion spot is plotted at the bottom of the figure. The black images on the right are the 3D views of the disk (two views) with the downward corrosion peak nearly penetrating through the thickness of the disk.

FIG. 16 shows ATR-FTIR spectra for select starting materials.

FIG. 17 shows diffractograms for 300° C.-autoclaved Zr-free cements after 1- and 7-day-exposer in scH₂O.

FIG. 18 shows the gibbsite→boehmite octahedral structure transformation at 300° C.

FIG. 19 shows the analcime (zeolite)→paragonite (mica) structural transformation after 7 days exposure in scH₂O.

FIG. 20 shows ATR-FTIR absorption spectra and absorbance height ratios, AA at 1065 cm⁻¹ of boehmite/AA at 996 cm⁻¹ of zeolite or paragonite for 300° C.-autoclaved Zr-free cements after exposure to scH₂O for 1 and 7 days.

FIG. 21 shows XRD patterns for 300° C.-autocalved 5% Zr cements after exposure for 1 and 7 days in scH₂O.

FIG. 22 shows the Na-coordinated Si—O tetrahedral chain-linking ZrO₆ octahedra structure of vlasovite.

FIG. 23 shows ATR-FTIR spectra in conjunction with AA at 1065 cm⁻¹/AA at 996 cm⁻¹ height ratios for 5% Zr cements.

FIG. 24 shows XRD patterns for 300° C.-autoclaved 10% Zr cements after 1- and 7-day exposure in scH₂O.

FIG. 25 shows ATR-FTIR spectra and AA at 1065 cm⁻¹/AA at 996 cm⁻¹ height ratios for 10% Zr cements.

FIG. 26 shows a schematic diagram in the phase transitions and phase compositions of SMS-activated gibbsite cement in hydrothermal temperature, ranging from ambient temperature to 400° C. and for duration of scH₂O exposure.

FIGS. 27A-27C show TGA/DTG analyses for gibbsite and hydrous ZrO₂ as starting materials and commercial boehmite product.

FIGS. 28A-28B show TGA/DTG analyses for 300° C.-autoclaved Zr-free and 10% Zr cements.

FIGS. 29A-29B show TGA/DTG analyses for Zr-free and 10% Zr cements after exposure for 7 days in scH₂O.

FIG. 30 shows a comparison of TGA curve features for all TGA/DTA samples and assessment of their thermal stability.

FIG. 31 shows morphology of fractured surface for 300° C.-autoclaved Zr-free cement. Elemental analysis of samples performed at locations marked 1 and 2 in the SEM image can be found in Tables 3A-3B.

FIG. 32 shows morphology for 5% Zr-containing cement after exposure for 1 day in scH₂O. Elemental analysis of samples performed at locations marked 1 and 2 in the SEM image can be found in Tables 4A-4B.

FIG. 33 shows SEM analysis of 5% Zr-containing cement after exposure for 7 days in scH₂O. Elemental analysis of samples performed at locations marked 1 and 2 in the SEM image can be found in Tables 5A-5B.

FIGS. 34A-34B show morphologies of silica flour surfaces present in 300° C.-autoclaved 10% Zr cements before (FIG. 34A) and after (FIG. 34B) 7-day scH₂O exposures. Elemental analysis of samples performed at location marked 1 in the SEM image (FIG. 34A) can be found in Table 6A, and at location marked 2 in the SEM image (FIG. 34B) can be found in Table 6B.

FIG. 35 shows phase identification by crystal morphology for Zr-free cement after 1 day exposure in scH₂O. Elemental analysis of samples performed at locations marked 1 and 2 in the SEM image can be found in Tables 7A-7B.

FIG. 36 shows phase identification by crystal morphology for the post-7 day exposed 5% Zr cement. Elemental analysis of samples performed at location marked 1 in the SEM image can be found in Table 8A.

FIG. 37 shows phase identification by morphology for post-7 day exposed 10% Zr cement. Elemental analysis of samples performed at location marked 1 in the SEM image can be found in Table 9A.

FIG. 38 shows changes in porosity of 300° C.-autoclaved cements by Zr contents and exposure periods in scH₂O.

FIG. 39 shows compressive strength of Zr-free and 5 and 10% Zr cements after exposure in 300° C. and 400° C. autoclaves.

FIG. 40 shows Young's modulus (stiffness) of Zr-free and 5 and 10% Zr cements after exposure in 300° and 400° C. autoclaves.

FIG. 41 shows compressive fracture toughness of Zr-free and 5 and 10% Zr cements after exposure in 300° C. and 400° C. autoclaves.

FIG. 42 shows a comparison of compressive fracture toughness in basis of the compressive stress-strain curves for 0, 5, and 10% Zr cements after exposure to scH₂O for 1 day at 400° C.

FIG. 43 shows an SEM image of a Hastelloy rapture disk covered with Si-rich scale after a 7-day exposure to pure water.

FIGS. 44A-44B show comparative SEM images for a Ni-alloy cement sample. FIG. 44A: control and FIG. 44B: sample after two weeks of exposure in supercritical conditions.

FIGS. 45A-45B show comparative SEM images for a second Ni-alloy cement sample. FIG. 45A: control and FIG. 45B: sample after two weeks of exposure in supercritical conditions

FIG. 46 shows water fillable porosity and changes thereto based on different formulations of high temperature ordinary Portland cement formulations modified with different amounts of metakaolin (MK).

FIG. 47 shows compressive strength for the samples described in FIG. 46.

FIG. 48 shows Young's modulus for the samples described in FIG. 46.

FIG. 49 shows XRD spectra for ordinary Portland cement samples showing phase changes as shown in FIG. 2.

FIG. 50 shows porosity of the systems of FIG. 46 after 30 days in supercritical conditions.

FIG. 51 shows compressive strength of the systems of FIG. 47 after 30 days in supercritical conditions.

FIG. 52 shows Young's modulus of the systems of FIG. 48 after 30 days in supercritical conditions.

FIG. 53 shows porosity for calcium aluminate cement (CAC) systems with and without MK.

FIG. 54 shows compressive strength for the CAC systems in FIG. 53.

FIG. 55 shows Young's modulus for the CAC systems shown in FIG. 53.

FIGS. 56A-56B show XRD analysis of different grades of CAC systems including phase changes with supercritical treatment.

FIG. 57 shows XRD analysis of a modified CAC system relative to the unmodified system.

FIG. 58 shows XRD analysis of a second modified CAC system relative to the unmodified system.

FIG. 59 shows porosity for a calcium aluminum phosphate (CAP) cement system after supercritical exposure.

FIG. 60 shows compressive strength for the system shown in FIG. 59.

FIG. 61 shows Young's modulus for the system shown in FIG. 59.

FIG. 62 shows XRD spectra for CAP samples showing phase changes as shown in FIG. 6.

FIG. 63 shows compressive strength for the system of FIG. 60 after 30 days in supercritical conditions.

FIG. 64 shows Young's modulus for the system of FIG. 61 after 30 days in supercritical conditions.

FIG. 65 shows porosity for the system of FIG. 59 after 30 days in supercritical conditions.

FIG. 66 shows porosity of a calcium-free, aluminum-based cement system after supercritical exposure.

FIG. 67 shows compressive strength of the system of FIG. 66 after supercritical exposure.

FIG. 68 shows Young's modulus of the system of FIG. 66 after supercritical exposure.

FIG. 69 shows XRD spectra for calcium-free samples showing phase changes as shown in FIG. 36.

FIG. 70 shows compressive strength for the system of FIG. 67 after 30 days in supercritical conditions.

FIG. 71 shows Young's modulus for the system of FIG. 68 after 30 days in supercritical conditions.

FIG. 72 shows porosity for the system of FIG. 66 after 30 days in supercritical conditions.

FIG. 73 shows a typical stress-strain curve for selected formulations after 30-day supercritical curing.

FIG. 74 shows thermal conductivity of supercritical cements after 1 day at 300° C. and 30 days at 400° C.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Disclosed herein are several super-critical cementitious systems evaluated after a short-term curing of 24 hours at 400° C. and 25.5 MPa. In one aspect, the systems are suitable for use in the construction of hot-temperature wells.

In one aspect, in the disclosed systems, zeolite phases formed in hydrated cement can provide the hydrothermal stability, CO₂ resistance, improved adhesion to metal and formation, and corrosion protection of carbon steel (CS) against brine at temperatures up to 300° C. However, in the supercritical environments under the high pressure, one concern about zeolite-rich cement is the increase in porosity of cement because of the natural porous microstructure of zeolites constituting of a three-dimensional framework of tetrahedral SiO₄ and AlO₄ unites. Thus, the cement may have a high rate of water permeability. Hence, in the present case, the modification of zeolites was explored to reduce the rate of porosity and to assemble dense framework. Among various zeolites, of particular interest herein is analcime. In one aspect, in the field of environmental protection, there are two different strategies for modification of analcime through hydrothermal synthesis: One is to substitute the silica (Si) at tetrahedral T (Si and Al)—O bond sites for various metallic ions like Zr⁴⁺, Mn²⁺, Ti⁴⁺, Ag²⁺, and Sr²⁺ with large effective ionic radii of 0.072, 0.061, 0.094, and 0.118 nm, respectively, compared with 0.04 nm of Si; the other is the incorporation of these ions into porous structure for utilizing in different environmental fields. In an aspect, in the disclosed compositions and methods, Zr⁴⁺ was opted as substitutional ion in the tetrahedra unites or bearing the ions in the porous framework and/or both. In a further aspect, utilizing the zirconium (IV) hydroxide (Zr) as Zr⁴⁺ resources, it is frequently called as hydrous zirconia, ZrO₂·nH₂O and Zr(OH)₄·nH₂O. In another aspect, as for the solubility of Zr at 25° C., it increases with an increasing pH. However, in some aspects, no solubility equilibrium was found instead of the transition of ZrO₂→alkali hydrolyzation→amorphous phase comprised of polycondensation species containing water molecules. In still another aspect, this polycondensation species was formed by two-stage deprotonation reactions as shown in following solubility equilibriums; 3[Zr(H₂Oₓ]^{4←}+4H₂O↔[Zr₃(H₂O)₃ₓ₋₄ (OH)₄]⁸⁺+4H₃O⁺ (1) and then [Zr₃(H₂O)₃ₓ₋₄ (OH)₄]⁸⁺+4H₂O↔Zr₃O₄(H₂O)_{3x_4}]⁸⁺+4H₃O+(2). In yet another aspect, nevertheless, small polymeric species may dissolve in alkali solution for a certain period. In another aspect, unlike at ambient temperature, the geothermal hydrothermal environment of >pH 13 at ≥300° C. may potential to acciderate the dissolution of complex polymeric spices.

In another aspect, the boehmite as one of the major phases formed in thermal shock-resistant cement (TSRC) may provide same contribution of strength development to TSRC. In an aspect, the boehmite as engineering ceramic can used as reactive binder for melt-extrusion ceramic manufacture at high temperatures. In a further aspect, the phase transition of boehmite→γ-Al₂O₃ occurred at ˜460° C. In a further aspect, for adapting the chemically gelatinated boehmite, the foamed boehmite lightweight ceramic was fabricated through gel-sintering pathways. Further in this aspect, the lightweight ceramic as end-product possessed an excellent compressive strength of 34.1-89.1 MPa along with a high porosity, ranging from 66 to 87%. Thus, it is possible to assume that the boehmite of plate-like crystals along with rhombic, hexagonal, and lath-like profiles may serve to support weak strength of porous analcime. In another aspect, if the volumetric phase fraction of boehmite to analcime is adequately higher, the issue of porous structure in cement matrix may be alleviated. In one aspect, the gibbsite, Al(OH)₃→boehmite represents a known phase transition at hydrothermal temperature ≥175° C.

In one aspect, regarding the use of SMS as alkali activator, one inevitable concern is a strong reactivity of Na⁺OH⁻ alkalis liberated from hydrolysis of sodium metasilicate (SMS) with the pozzolans like silica, silicates, and aluminosilicates, resulting in the dissociation of H₄SiO_{4(aq)}, Ca²⁺, and Al(OH)₄⁻ ionic species from pozzolans. In a further aspect, if these pozzolans are used as fillers aimed at improving strength and toughness of cement, the erosion of these fillers is unavoidable. In an alternative aspect, although ZrO₂ is non-pozzolanic material, it may undergo some alkali dissolution in supercritical environment as described earlier. In one aspect, in the dental cement fields, Zr-based fillers were used to modify Portland cement and tricalcium silicate (C₃S) cement at ambient temperature. Further in this aspect, Zr fillers displayed the inertness to Ca²⁺ OH²⁻ alkali attack, correspondingly, there is no reaction with the hydration products of cements. Thus, in an aspect, Zr has a potential as substituting material for conventional cements, while the mechanical properties of cement remained unchanged. However, in scH₂O, the reactivity of Zr fillers with cement may be different.

In the present application, the following five starting materials, gibbsite powder, sodium metasilicate as alkali activator, silica flour as filler, and hydrous Zr (IV) oxide as Zr⁴⁺ resources and filler, are adapted to conduct the hydrothermal synthesis of hydrous ZrO₂-incorporating and no corporation boehmite/zeolite blending cement at 300° C., followed by the exposure of synthesized cement for up to one week in scH₂O at 400° C. and pressure of 24.1 MPa. In another aspect, all starting materials were blended to make dry blending cement prior to preparing cement slurry. In one aspect, to assess the integrity and reliability as supercritical geothermal well cements (scGWC), the following five factors were investigated for cement samples synthesized in 300° C. autoclave: 1) Chemistry and properties of cement slurry, 2) changes in water-fillable porosity, 3) crystalline and amorphous phase composition and transition, 4) thermal stability of phase compositions, and 5) microstructure characterization and alteration.

### Cementitious Material Compositions

In one aspect, disclosed herein is a cementitious material composition including an aluminum source, a filler, and an alkali activator. In a further aspect, the aluminum source can be aluminum hydroxide, aluminum chloride, aluminum sulfate, aluminum nitrate, or any combination thereof. In still another aspect, the filler can be silica flour, hydrous Zr (IV) oxide, metakaolin, fly ash, diatomaceous earth, perlite, silica fume, blast furnace slag, rice husk ash, or any combination thereof. In one aspect, the alkali activator is sodium metasilicate, potassium silicate, sodium hydroxide, potassium hydroxide, or any combination thereof. In one aspect, the aluminum source is greater than 50% by weight of the cementitious material.

In another aspect, the cementitious material composition further includes one or more transition metals including, but not limited to, Zr, Ni, Zn, or any combination thereof. In a further aspect, the one or more transition metals is from about 1% by weight to about 15% by weight of the aluminum source, or is about 1, 2, 3, 4, 5, 6, 7, 8, 9, 10, 11, 12, 13, 14, or about 15% by weight of the aluminum source, or a combination of any of the foregoing values, or a range encompassing any of the foregoing values.

In some aspects, the cementitious material composition includes thermally conductive particles such as, for example, graphene, carbon nanotubes, carbon fibers, carbon black, graphite, or any combination thereof.

In an aspect, the aluminum source is about 50% to about 90% by weight of the cementitious material, or is about 50, 55, 60, 65, 70, 75, 80, 85, or about 90% by weight of the cementitious material, or a combination of any of the foregoing values, or a range encompassing any of the foregoing values. In a further aspect, the filler is about 0.1% to about 90% by weight of the cementitious material, or about 0.1%, 5, 10, 15, 20, 25, 30, 35, 40, 45, 50, 55, 60, 65, 70, 75, 80, 85, or about 90% by weight of the cementitious material, or a combination of any of the foregoing values, or a range encompassing any of the foregoing values, while the alkali activator is about 0.1% by weight to about 90% by weight of the cementitious material or about 0.1%, 5, 10, 15, 20, 25, 30, 35, 40, 45, 50, 55, 60, 65, 70, 75, 80, 85, or about 90% by weight of the cementitious material, or a combination of any of the foregoing values, or a range encompassing any of the foregoing values.

In any of these aspects, the cementitious material composition is at least 50% calcium free, or at least 50, 55, 60, 65, 70, 75, 80, 85, 90, 95, or 99% calcium free, or a combination of any of the foregoing values, or a range encompassing any of the foregoing values. In another aspect, the cementitious material composition is substantially calcium free.

### Method for Making a Cementitious Article

In another aspect, disclosed herein is a method for making a cementitious article, the method including at least the steps of:
(a) admixing an aluminum source, a filler, and an alkali activator to form a slurry;
(b) admixing a sufficient amount of water with the slurry to form a self-flowing slurry;
(c) pouring the self-flowing slurry into a mold; and
(d) curing the self-flowing slurry to form a cementitious article;
wherein curing the cementitious article comprises an initial curing step at 85° C., a second curing step at 300° C., and a final curing step conducted at a temperature of about 400° C. and a pressure of about 24.5 MPa to about 25.5 MPa.

In a further aspect, in the disclosed method, at least one intermediate phase selected from harmotome, p-zeolite, and analcime is suppressed during curing of the cementitious article.

### Cementitious Articles

In yet another aspect, disclosed herein is a cementitious article made by the disclosed methods. In an aspect, the cementitious article includes one or more crystalline phases selected from boehmite, paragonite, and vlasovite.

In a further aspect, the cementitious article has a change in water-fillable porosity of about 10% or less after 7 days at 400° C., has a compressive strength of about 2000 psi or greater after 7 days at 400° C., and/or has a Young's modulus of about 200 kpsi or greater after 7 days at 400° C. In a still further aspect, the cementitious article can be a sheath for a geothermal well.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a source of aluminum,” “a filler,” or “an alkali activator,” include, but are not limited to, mixtures or combinations of two or more such sources of aluminum, fillers, or alkali activators, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less' and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of a filler refers to an amount that is sufficient to achieve the desired improvement in the property modulated by the formulation component, e.g. achieving desired properties in the final cement article including, but not limited to, change in water fillable porosity, compressive strength, Young's modulus, and the like. The specific level in terms of wt % in a composition required as an effective amount will depend upon a variety of factors including the amount and type of filler, desired aluminum to silica ratio in compositions including a silica filler, presence or absence of calcium in the composition, and end use of the article made using the composition.

As used herein, the terms “optional” or “optionally” means that the subsequently described event or circumstance can or cannot occur, and that the description includes instances where said event or circumstance occurs and instances where it does not.

As used herein, “supercritical conditions” or “supercritical exposure” refer to conditions such as might be experienced in or around a geothermal well such as, for example, when water is in a supercritical state. Supercritical conditions can include high heat such as, for example, about 400° C., high pressure such as, for example, between 24.5 and about 25.5 MPa, or other suitable high temperature and high temperature conditions. Supercritical conditions can be imposed in a laboratory setting or in a real-world experimental setting and include conditions both for curing of a cementitious article as well as for extended testing of such an article. In one aspect, the disclosed compositions and articles are stable and have desirable mechanical properties under supercritical conditions.

Unless otherwise specified, temperatures referred to herein are based on atmospheric pressure (i.e. one atmosphere).

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### ASPECTS

The present disclosure can be described in accordance with the following numbered aspects, which should not be confused with the claims.
Aspect 1. A cementitious material composition, comprising an aluminum source, a filler; and an alkali activator.
Aspect 2. The cementitious material composition of aspect 1, wherein the aluminum source comprises aluminum hydroxide, aluminum chloride, aluminum sulfate, aluminum nitrate, or any combination thereof.
Aspect 3. The cementitious material composition of aspect 1 or 2, wherein the filler comprises silica flour, hydrous Zr (IV) oxide, metakaolin, fly ash, diatomaceous earth, perlite, silica fume, blast furnace slag, rice husk ash, or any combination thereof.
Aspect 4. The cementitious material composition of any one of aspects 1-3, wherein the alkali activator comprises sodium metasilicate, potassium silicate, sodium hydroxide, potassium hydroxide, or any combination thereof.
Aspect 5. The cementitious material composition of any one of aspects 1-4, wherein the aluminum source is greater than 50% by weight of the cementitious material.
Aspect 6. The cementitious material composition of any one of aspects 1-5, further comprising one or more transition metals.
Aspect 7. The cementitious material composition of aspect 6, wherein the one or more transition metals comprise Zr, Ni, Zn, or any combination thereof.
Aspect 8. The cementitious material composition of aspect 6 or 7, wherein the one or more transition metals is from about 1% by weight to about 15% by weight of the aluminum source.
Aspect 9. The cementitious material composition of any one of aspects 1-8, further comprising thermally conductive particles.
Aspect 10. The cementitious material composition of aspect 9, wherein the thermally conductive particles comprise graphene, carbon nanotubes, carbon fibers, carbon black, graphite, or any combination thereof.
Aspect 11. The cementitious material composition of any one of aspects 1-10, wherein the aluminum source is about 50% to 90% by weight of the cementitious material;
   wherein filler is about 0.1% to 90% by weight of the cementitious material; and
   wherein the alkali activator is about 0.1% to 90% by weight of the cementitious material.
Aspect 12. The cementitious material composition of any one of aspects 1-11, wherein the cementitious material composition is at least 50% calcium free.
Aspect 13. A method for making a cementitious article, the method comprising:
(a) admixing an aluminum source, a filler, and an alkali activator to form a slurry;
(b) admixing a sufficient amount of water with the slurry to form a self-flowing slurry;
© pouring the self-flowing slurry into a mold; and
(d) curing the self-flowing slurry to form a cementitious article;
wherein curing the cementitious article comprises an initial curing step at 85° C., a second curing step at 300° C., and a final curing step conducted at a temperature of about 400° C. and a pressure of about 24.5 MPa to about 25.5 MPa.
Aspect 14. The method of aspect 13, wherein at least one intermediate phase selected from harmotome, p-zeolite, and analcime is suppressed during curing of the cementitious article.
Aspect 15. A cementitious article made by the method of aspect 13 or 14.
Aspect 16. The cementitious article of any one of aspects 15, wherein the cementitious article includes one or more crystalline phases selected from boehmite, paragonite, and vlasovite.
Aspect 17. The cementitious article of aspect 15 or 16, wherein the cementitious article has a change in water-fillable porosity of about 10% or less after 7 days at 400° C.
Aspect 18. The cementitious article of any one of aspects 15-17, wherein the cementitious article has a compressive strength of about 2000 psi or greater after 7 days at 400° C.
Aspect 19. The cementitious article of any one of aspects 15-18, wherein the cementitious article has a Young's modulus of about 200 kpsi or greater after 7 days at 400° C.
Aspect 20. The cementitious article of any one of aspects 15-19, wherein the cementitious article comprises a sheath for a geothermal well.

### Examples

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Cement Formulations for Super-Critical Geothermal Wells

### Materials and Methods

Sample preparation and testing. The tested formulations included high-temperature formulation of Portland cement modified with silica (CaO—SiO₂ system (S-1)), P₂O₅—Na₂O—CaO—Al₂O₃—SiO₂— based systems with varied Al₂O₃/SiO₂ ratios (Al₂O₃/SiO₂=1.4—system S-2, Al₂O₃/SiO₂=2.9—system S-3), and P₂O₅—Na₂O—CaO—Al₂O₃—SiO₂—Fe₂O₃(Al₂O₃/SiO₂=3.9—S-4 system) phosphate system, Na₂O—CaO—Al₂O₃—SiO₂—MgO—Fe₂O₃(Al₂O₃/SiO₂=0.43—S-5 system) and Na₂O—CaO—Al₂O₃—SiO₂—MgO (Al₂O₃/SiO₂=0.15—S-6 system) Mg-containing systems, and Na₂OAl₂O₃—SiO₂ cement system (Al₂O₃/SiO₂=1.4—S-7). OPC, class G, Dykerhoff North, cement in combination with silica flour was used as a reference cement. Calcium aluminate cements and alfa aluminum-oxide were supplied by Imerys Inc. Pozzolanic materials were obtained from Lafarge North America Inc and Imerys Inc. The blends were dry-mixed before adding water; the slurries were hand-mixed until getting a uniform suspension for about 2 minutes, then poured into 20×40 mm cylindrical molds and cured under hydrothermal conditions at 85° C. (overnight) followed by overnight hydrothermal curing at 300° C. and the final curing under the super-critical conditions at 400° C. and pressure of 25.5 MPa in Parr autoclave reactor rated up to temperatures of 500° C. and pressures of 34.46 MPa (5,000 psi).

Inconel steel rapture disk rated to that pressure was used for the reported formulations. However, it should be noted, that some high alkalinity tested systems caused fast corrosion of rapture disks under super-critical conditions, which resulted in premature disk failures under the experimental pressures in less than 24 hr. Inconel steel disk replacement with corrosion resistant Hastelloy steel did not resolve this problem.

Samples' water-fillable porosities were measured by weighing the samples after the curing and after 3 days in a vacuum oven at 60° C. The porosity was calculated as (weight after curing—weight after vacuum oven)/(weight after curing)×100%. Electromechanical Instron System Model 5967 was used to obtain all mechanical properties. XRD (40 kV, 40 mA copper anode X-ray tube) was used for samples characterizations. The results of XRD tests were analyzed using PDF-4/Minerals 2021 database of International Center for Diffraction Data (ICDD). Additionally, JEOL 7600F Scanning Electron Microscope (SEM) image analyses coupled with EDX elemental composition survey were done for the typical spots on freshly broken samples. Cement samples were coated with silver to decrease the charging effects prior to the analyses.

### Results

Mechanical properties. Several potential cement chemistries of interest for super-critical environments were identified for the screening tests. The mechanical properties of some of them are shown in Table 1. For most tested systems compressive strength decreased after the exposure to supercritical conditions. The two systems with the persisting strength were calcium-silicate system S-1 and magnesium-containing system S-6. Phosphate cements and magnesium S-5 system showed very high strength after the 300° C. curing, which decreased after the 400° C. exposure. The initial strength decrease is a known phenomenon for the phosphates cement and under hydrothermal conditions below super-critical, strength stabilization is generally observed after longer curing time. The strength decrease for the tested cements was accompanied by the increase in toughness and decrease of Young's modulus suggesting less brittle cement after super-critical curing.

TABLE 1
Mechanical Properties of Tested Cement Systems

| System | Compressive Strength, | | Toughness, | | Young's Modulus, GPa | |
|---|---|---|---|---|---|---|
| (Al₂O₃/ | MPa (psi) | | Nmm/mm³ | | (kpsi) | |
| SiO₂) | 300° C. | 400° C. | 300° C. | 400° C. | 300° C. | 400° C. |
| S-1 (0.04) | 21 ± 2 | 24 ± 1 | 0.44 ± 0.12 | 0.39 ± 0.09 | 1.7 ± 0.1 | 2.2 ± 0.2 |
| | (3100 ± 340) | (3450 ± 160) | | | (245 ± 15) | (322 ± 29) |
| S-2 (1.4) | 31 ± 4 | 23 ± 2 | 0.23 ± 0.12 | 0.48 ± 0.09 | 3.4 ± 0.2 | 2.2 ± 0.4 |
| | (4560 ± 600) | (3300 ± 250) | | | (496 ± 34) | (320 ± 57) |
| S-3 (2.9) | 28 ± 2 | 24 ± 1 | 0.38 ± 0.12 | 0.48 ± 0.11 | 2.7 ± 0.3 | 2.2 ± 0.2 |
| | (4000 ± 240) | (3400 ± 150) | | | (396 ± 41) | (316 ± 25) |
| S-4 (3.9) | 35 ± 3 | 26 ± 2 | 0.18 ± 0.04 | 0.35 ± 0.05 | 4.0 ± 0.02 | 3.7 ± 0.2 |
| | (5080 ± 390) | (3700 ± 245) | | | (585 ± 4) | (542 ± 25) |
| S-5 (0.43) | 28 ± 2 | 6.4 ± 0.7 | 0.53 ± 0.18 | 0.24 ± 0.1 | 2.3 ± 0.2 | 0.6 ± 0.1 |
| | (4000 ± 300) | (920 ± 100) | | | (334 ± 26) | (95 ± 20) |
| S-6 (0.15) | 10 ± 1 | 11 ± 2 | 0.22 ± 0.05 | 0.19 ± 0.06 | 0.7 ± 0.1 | 1 ± 0.3 |
| | (1390 ± 95) | (1550 ± 260) | | | (105 ± 12) | (145 ± 47) |
| S-7 (1.5) | NA | 8 ± 0.7 | NA | 0.24 ± 0.02 | NA | 0.65 ± 0.01 |
| | | (1140 ± 100) | | | | (94 ± 2) |

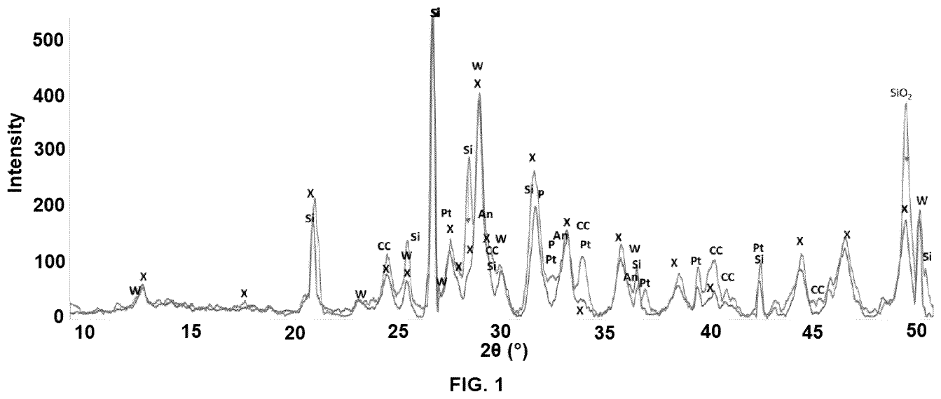

Crystalline phase composition, microstructural development, water-fillable porosities. FIG. 1 shows crystalline composition of the S-1 formulation after 300° C. and 400° C. curing. The patterns are similar, both are dominated by xonotlite peaks. Dehydrated calcium silicate wollastonite contributes some peaks to the pattern of 400° C.-cured sample (2θ 26.92, 36.37). Iron reacts at that temperature with formation of andradite (major peak at 2θ of 32.97 and a new peak at 36.22). The main difference in the patterns is the disappearance or a strong decrease in the intensity of silica peaks after samples curing at 400° C. (2θ 25.42, 28.38, 49.45, 50.43). Calcium carbonate peaks also decrease (2θ 24.44, the right shoulder between 29.24 and 29.68, 33.9, 40.23, 40.87, 44.89-45.45). Finally, sulphate mineral from cancrinite group, pitiglianoite, seem to decompose under super critical conditions (decrease of the peaks at 2θ 27.5, 32.44, 33.92, 39.43, 42.47).

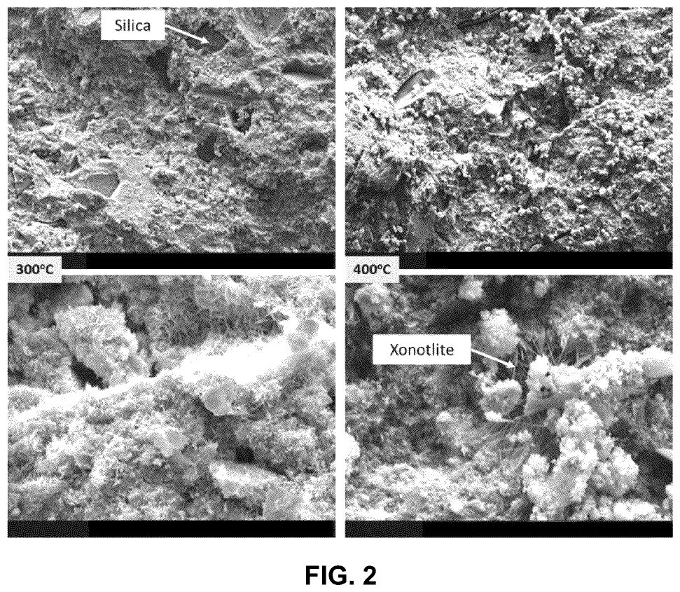

The morphological investigation confirms disappearance of silica (FIG. 2)—the large dark inclusions of silica on the left photomicrograph of the sample cured at 300° C. disappear from the photomicrograph of the sample cured at 400° C. (right). Long xonotlite crystals are clearly visible in the sample after the exposure to super-critical conditions. Significant part of the matrix is still amorphous after the short period curing of this study. The porosity of the system increased by 4.5% after the super-critical curing.

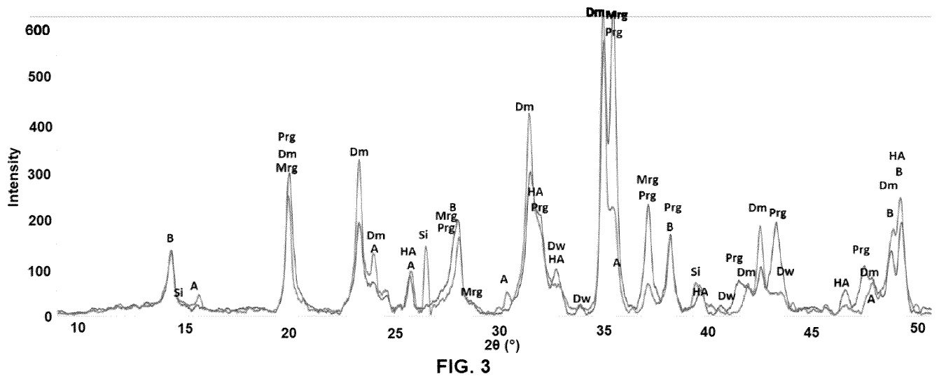

XRD patterns of S-2 phosphate system are shown in FIG. 3. The main phases for that system included dmisteinbergite (a polymorph of a stable high-temperature phase anorthite), bohmite, and hydroxyapatite. After the exposure to super-critical conditions the peaks of the mica group mineral margarite and a mineral related to muscovite phyllosilicate, paragonite, appeared in the XRD patterns. Additionally, small peaks of high-pressure, high-temperature calcium-aluminum-silicate donwilhelmsite were detected. Like in the case of S-1, silica peaks strongly decreased (2θ 26.66). High-temperature zeolite analcime present after 300° C. (low peak intensity) also decomposed under super-critical conditions.

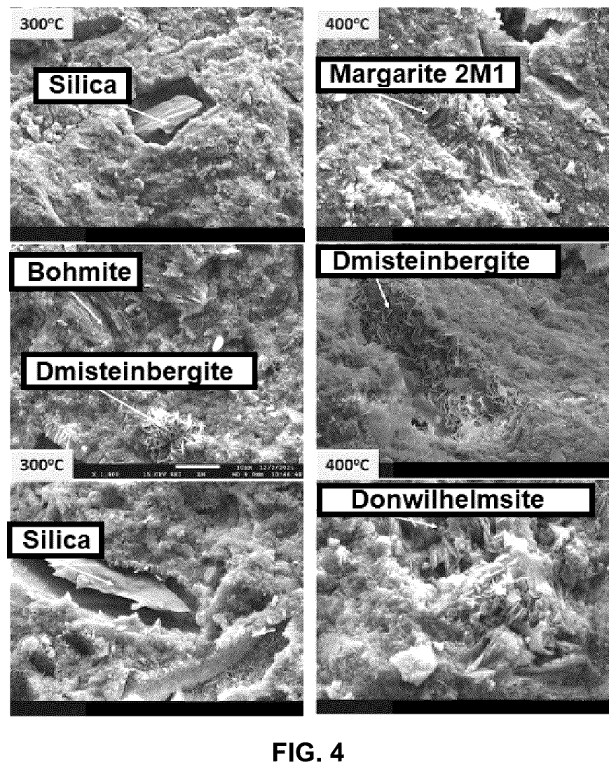

Morphology of S-2 sample was mostly amorphous both after 3000 and 400° C. curing. Crystals of dmisteinbergite, bohmite, margarite, silica, and donwilhelmsite, identified by XRD analysis were seen in the matrix (FIG. 4). Big silica crystals clearly visible in the 300° C. cured sample were not present in the sample cured at 400° C. The porosity of this system increased by 3.0% after the super-critical curing.

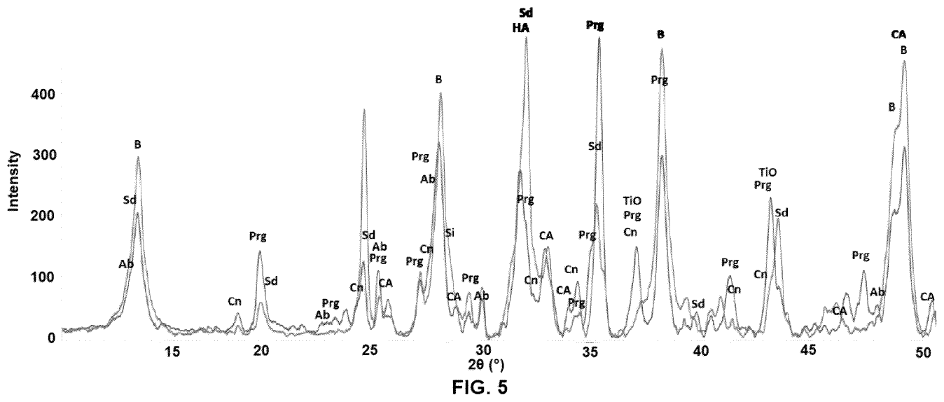

When aluminum content increases in the P₂O₅—Na₂O—CaO—Al₂O₃—SiO₂ (S-3, Al₂O₃/SiO₂=2.9) the XRD pattern does not include anorthite type minerals or zeolites after 300° C. curing. It is dominated by apatite phases and bohmite. The peaks' intensities of these minerals decrease after the super-critical curing and like in the case of S-1 sample, paragonite peaks become predominant in the pattern. A feldspathoid group mineral cancrinite replaces sodalite and peaks of sodium-aluminum silicate, albite, appear in the pattern (FIG. 5).

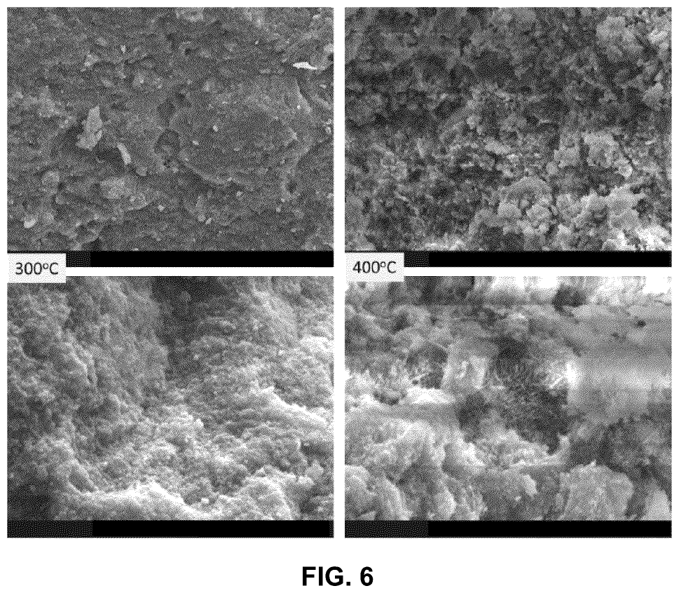

Matrix of the sample is very dense and mostly amorphous (FIG. 6). Small crystals of Al-rich bohmite are visible in the matrix in the bottom right photomicrograph of 400° C.-cured sample. There was a very little increase in porosity of this system after the super-critical curing—0.14%.

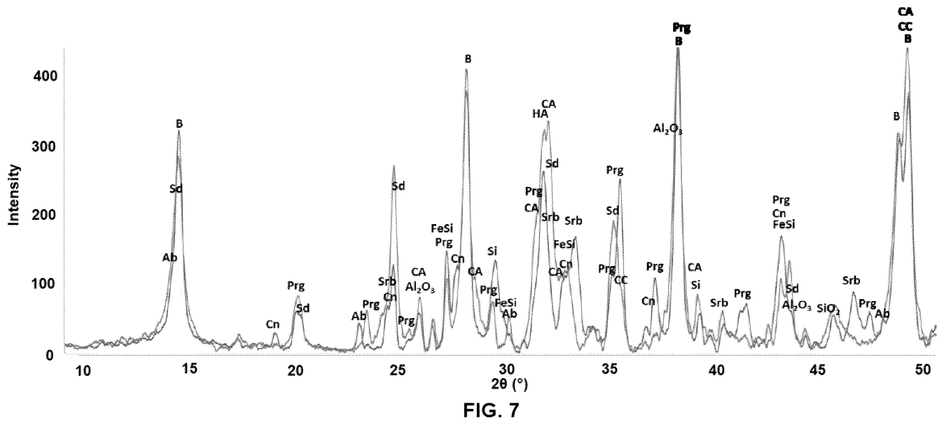

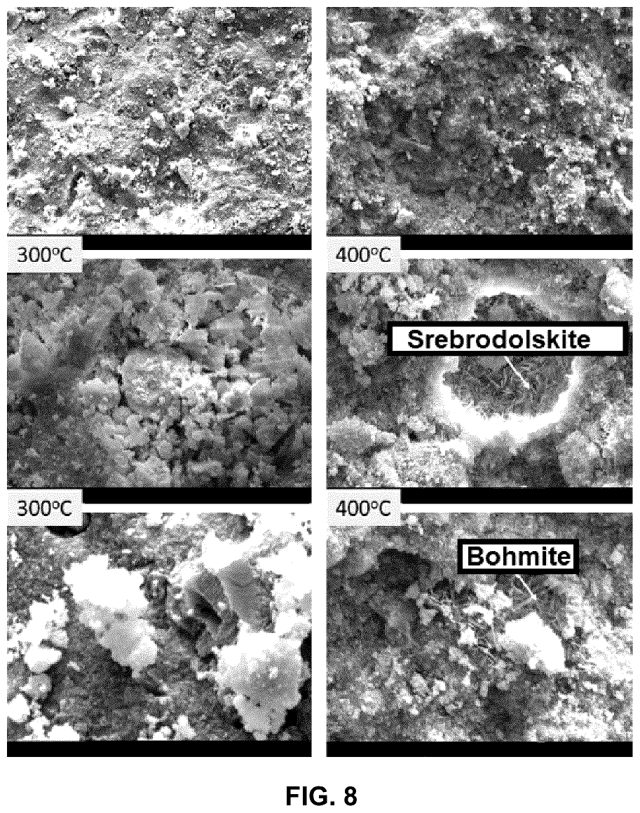

Further increase of aluminum content does not dramatically change the XRD patterns (FIG. 7, sample S-4). They are still dominated by apatite and bohmite. However, bohmite is stabilized by the higher aluminum presence and its peaks persist after the super-critical curing, while the peaks of apatite decrease in intensity like in the case of S-3 sample. Like for S-3 sample paragonite becomes an important phase after the super-critical curing and small albite peaks appear. Iron-containing minerals srebrodolskite and asimowite ferrian are present in the patterns of 400° C.-cured sample for this system containing iron. Mostly amorphous matrix after 300° C. curing remains amorphous after the 400° C. exposure (FIG. 8). But it is clearly less dense than that of S-3 sample. The porosity of S-4 increased by 3.1% after the supercritical curing.

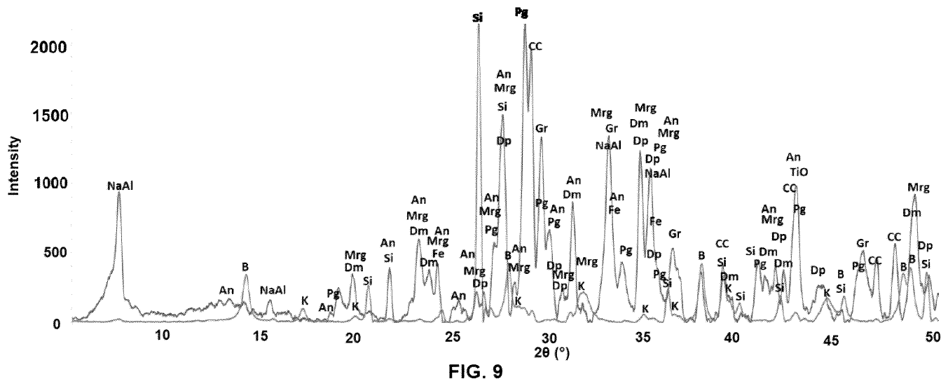

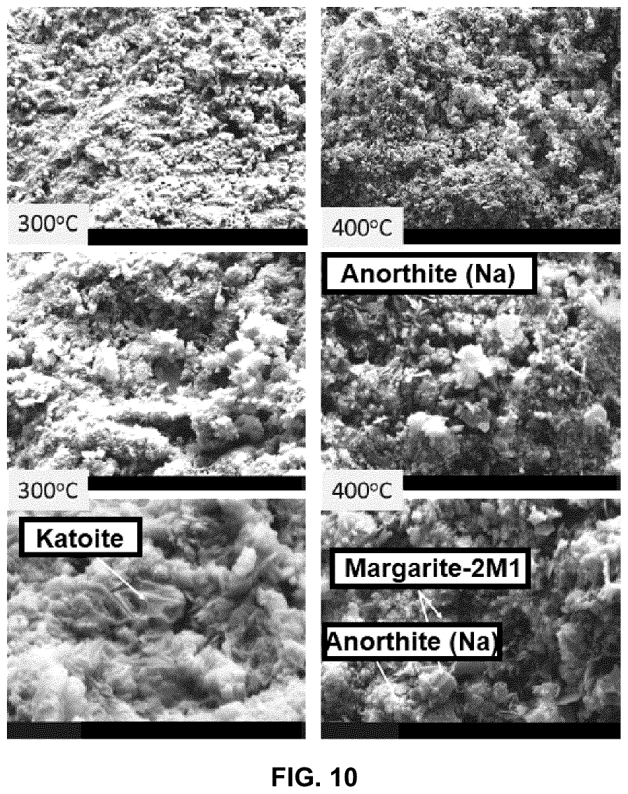

Magnesium-containing system S-5 was mostly amorphous after the 300° C. curing (FIGS. 9-10). The major peaks in the XRD pattern belong to crystalline silica (FIG. 9). There were also peaks of bohmite and katoite. Crystals of katoite were also visible in the photomicrograph of the sample (FIG. 10). A complex XRD pattern was obtained for the sample cured at 400° C. Silica, bohmite, and katoite peaks dramatically decreased while a combination of high-temperature phases including paragonite, margarite, anorthite, and dmisteinbergite appeared. If these phases were present in other earlier described systems, diopside and grossular were specific to S-5. The photomicrographs confirmed the findings of XRD with the visible crystals of anorthite and margarite (FIG. 10). The porosity of the system increased by 10.4%.

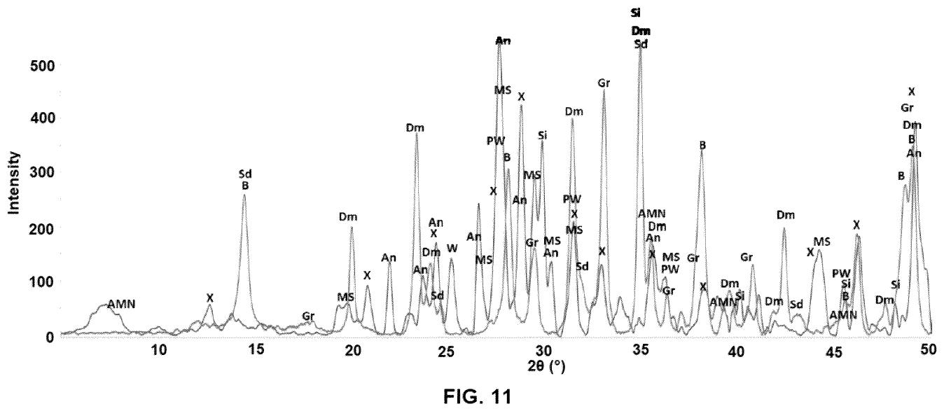

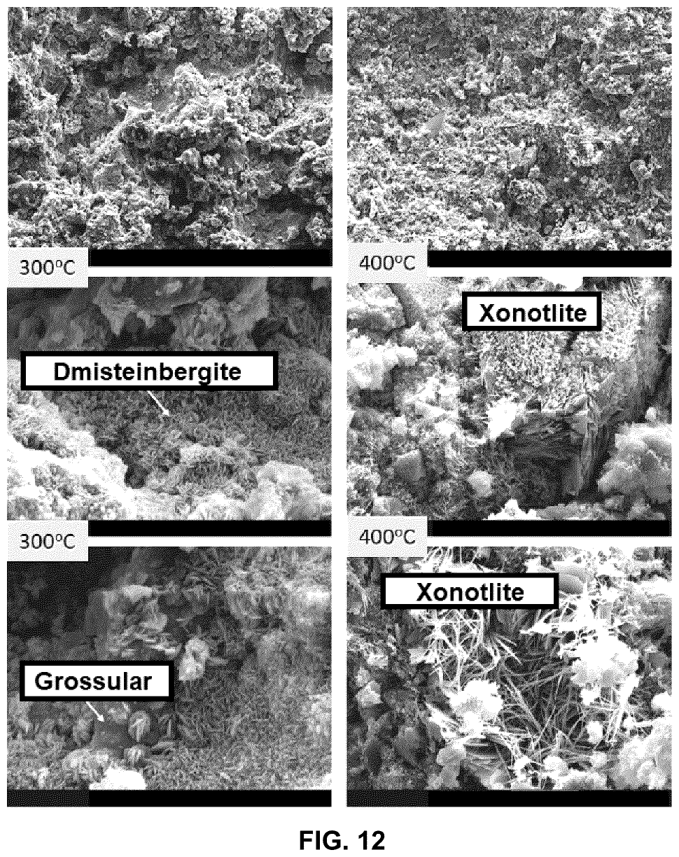

The system Na₂O—CaO—Al₂O₃—SiO₂—MgO (S-6, Al₂O₃/SiO₂=0.15), with lower aluminum content formed dmisteinbergite, grossular and bohmite after 300° C. curing (FIGS. 11-12). Exposure to super-critical conditions resulted in crystallization of xonotlite, magnesium silicate, transformation of dmisteinbergite to anorthite, and decomposition of bohmite. Peaks of wollastonite and pseudo wollastonite showed up in the XRD patterns. Aluminum magnesium sodium oxide that gives peaks at low angle may be formed during cooling the autoclave before samples removal. The increase in the system porosity was 9.9%.

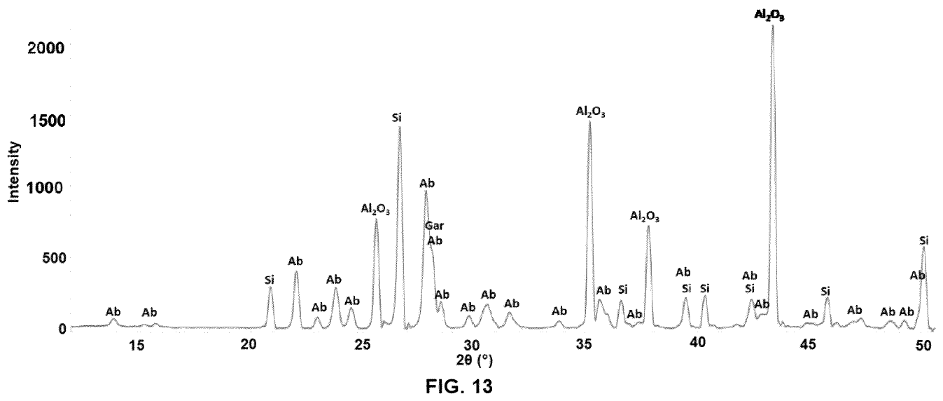

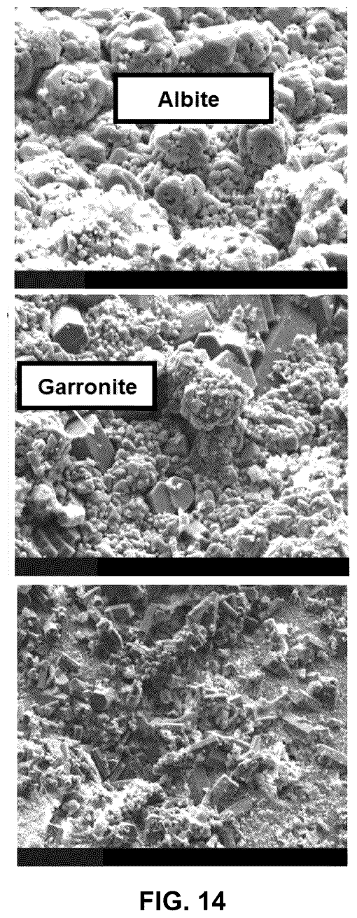

A simple system of Na₂O—Al₂O₃—SiO₂ (S-7, Al₂O₃/SiO₂=1.5) was tested after 400° C. (FIGS. 13-14). Crystalline composition of the sample was made of sodium aluminum silicate albite, sodium garronite (Na₆(Al₆Si₁₀O₃₂)·7.3 H₂O) and non-reacted aluminum oxide. These crystals were densely packed in partially amorphous matrix (FIG. 14).

### Discussion and Conclusions

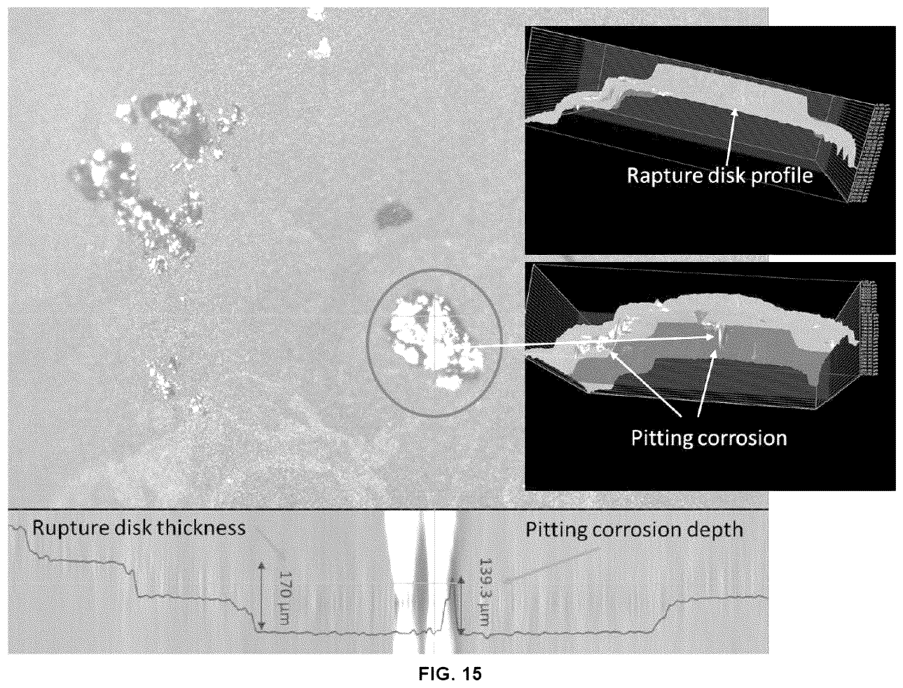

Super-critical conditions present very special environments for materials to survive. Significant pitting corrosion of rapture disk made of steel alloys (Inconel and Hastelloy) occurred during the experiments at 400° C. and 25.5 MPa under hydrothermal conditions. The corrosion rate was higher when highly alkaline cement samples were tested. For cement formulations with the pH of pore water around 13 Hastelloy rapture disk corroded within less than 18 hours of the experiment. However, the corrosion occurred even for the samples with pore water pH between 8 and 12. FIG. 15 shows the Inconel rapture disk images after 72 hrs under supercritical conditions in the presence of cement samples.

Forty-two samples (sample volume 6 mL) were tested in an autoclave (volume 1.8 L) in four separate runs at 400° C., 25.5 MPa. All cement samples were alkaline with the pH of pore solution ranging between ˜9 and 12. After completion of the tests, the Inconel rapture disk was removed and analyzed with the 3D optical microscope. The image in FIG. 15 reveals strong pitting corrosion (silver spots) detected over the whole surface of the disk. The profile of the deepest corrosion spot at the bottom of the figure indicates that the corrosion penetrated through more than 80% of the disk thickness. In addition to the difficulties of testing cements under the super critical conditions, casing corrosion should be carefully considered for super-critical geothermal wells.

In CaO—SiO₂ system (S-1) the major crystalline phase, xonotlite, persisted after the short-term curing under super-critical conditions, changing its morphology to longer needles. Crystalline silica, carbonate, and sulfate phases were not stable disappearing from the XRD patterns of the 400° C.-cured sample. Mechanical properties of the system were not compromised in a short term with both compressive strength and Young's modulus being higher for the super-critical sample (24 MPa at 400° C. vs. 21 MPa at 300° C.). However, morphological changes resulted in the increase in system's porosity by more than 4%.

In the P₂O₅—Na₂O—CaO—Al₂O₃—SiO₂ systems (S-2, S-3, S-4) phosphate-containing apatite phases, partially decomposed under super-critical conditions been replaced by the high-temperature stable phase, paragonite. At low Al₂O₃/SiO₂=1.4 feldspathoid calcium-aluminumsilicate, dmisteinbergite, and high-temperature zeolite, analcime, formed after 300° C. along with bohmite and hydroxyapatite.

Dmisteinbergite and analcime did not form in S-3 and S-4 systems with higher Al₂O₃/SiO₂ ratios of 2.9 and 3.9 respectively. Bohmite persisted through 400° C. curing, cancrinite, albite, srebrodolskite (Fe-bearing mineral in S-4) were present in samples with Al₂O₃/SiO₂=2.9 and 3.9.

Higher aluminum content stabilized both bohmite and apatite phases as seen by the intensity of their peaks at the patterns of 400° C.-cured samples. The matrix of these systems was for the most part amorphous after high-temperature curing. After the short-term curing phosphate systems developed very high strength after 300° C. (31 MPa for S-2, 28 MPa for S-3, and 35 MPa for S-4), The strength decrease after the exposure to super critical conditions was more important for the systems with the higher initial compressive strength (26% for S-2 and S-4 vs.24% for S-3). S-3 system with the intermediate Al₂O₃/SiO₂ of 2.9 possessed the higher toughness of 0.38 that further increased to 0.48 Nmm/mm³ after the 400° C. curing. As mentioned above, strength-stabilization is expected for phosphate cements after the initial strength decrease. The porosity increase was less important for the tested phosphate systems than for the calcium-silicate S-1. S-2 and S-4 porosity increase was around 3% while S-3 showed only 0.14% of the porosity increase after the super-critical curing.

Magnesium-containing systems S-5 and S-6 underwent significant crystalline phase changes during the super-critical curing. This was especially visible for S-5 (Al₂O₃/SiO₂=0.43) that started with silica, bohmite, and some katoite (low peaks' intensities) after the 300° C. curing. After the super-critical exposure, the XRD patterns were very complex. For the higher Al₂O₃/SiO₂ (0.43) they were dominated by feldspathoid minerals dmisteinbergite and its polymorph anorthite, mica-type mineral margarite, grossular, and Mg-containing mineral diopside. Anorthite and diopside were shown to have desirable cementitious properties under super-critical conditions of 400° C. and anorthite, wollastonite, and magnesium silicate were among the dominant phases. Grossular and dmisteinbergite peaks that were major after 300° C. greatly diminished after the 400° C. curing. Unlike for other systems bohmite is not stable at 400° C. in MgO-systems with low Al₂O₃/SiO₂ ratio. The matrix of these samples was more crystalline than for the phosphate systems. The dramatic changes in crystallinity for the S-5 system during the super-critical curing resulted in striking decrease in mechanical properties from 28 MPa after 300° C. curing to 6.4 MPa after 400° C. exposure. The strength of the S-5 system, on the other hand, persisted through super-critical curing (10 MPa before 400° C. exposure and 11 MPa after the exposure). Intergrown crystalline microstructures apparently served to enhance the strength of the S-5 sample. Nevertheless, both systems experienced significant increase in porosity, which was 10.4% for S-5 and 9.9% for S-6.

The Na₂O—Al₂O₃—SiO₂ (S-7, Al₂O₃/SiO₂=1.5) system formed highly crystalline matrix of high-temperature stable mineral albite, zeolite garronite with some non-reacted silica and aluminum oxide.

It should be noted that some changes in the tested systems could have taken place during the cooling of the autoclaves from super critical conditions. Among the tested systems phosphate system with the intermediate Al₂O₃/SiO₂ ratio of 2.9 showed the most promise as new geothermal cement for super-critical conditions. It demonstrated acceptable and persisting mechanical properties, crystalline phase development and morphological composition, as well as very little porosity increase after the 400° C. curing (0.14%). Although Mg-containing systems developed high initial compressive strength and formed high-temperature stable crystalline phases, such as anorthite and diopside, dramatic phase changes caused strength decrease for the system with lower aluminum content and significant increase in porosity (around 10%) in both systems after the super-critical curing. Further long-term testing is needed to fully evaluate the real potential of the selected formulations.

### Example 2: Alkali-Activated Gibbsite Cements with Hydrous ZrO₂ for Use in Supercritical Geothermal Wells at 400° C.

### Experimental Procedure

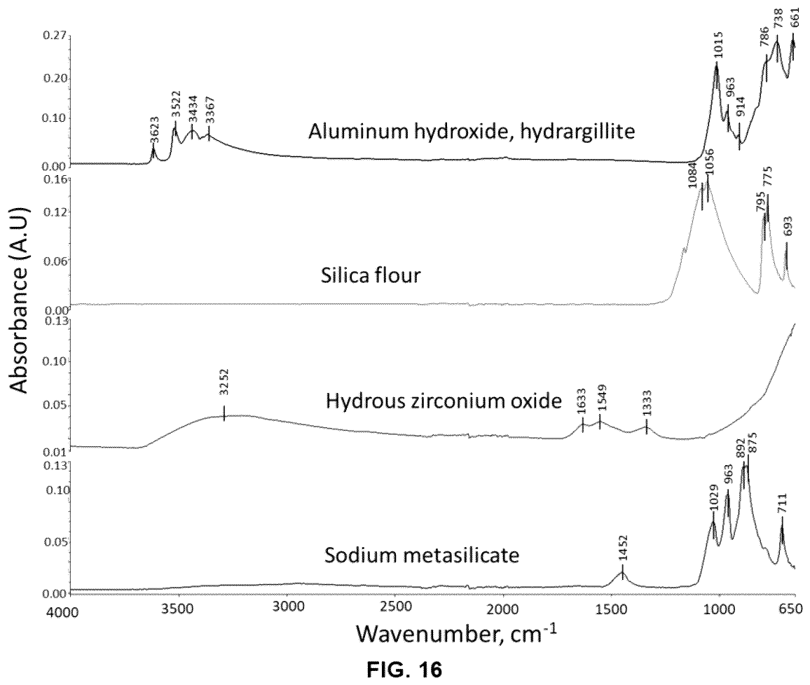

Starting materials. Aluminum hydroxide, Al(OH)₃, EMPLURA® hydrargillite powder having bulk density of ˜90 g/100 ml and particle size <150 μm in 90% was obtained from Signa Aldrich, while U.S. Silica Corporation provided silica flour with particle size 40-250 μm as filler. Zirconium (IV) hydroxide as hydrous zirconium oxide, ZrO₂·nH₂O (Zr) gained from Signa Aldrich. Sodium metasilicate (SMS, Na₂SiO₃, trade named “MetsoBeads 2048”) alkali-activating powder of 93% purity was supplied by PQ Corporation. It had a particle size, ranging from 0.23- to 0.85-mm, and a 50.5/46.6 Na₂O/SiO₂ weight ratio. FIG. 16 shows Attenuated Total Reflectance-Fourier Transform Infrared Spectroscopy (ATR-FTIR) spectra in the frequency region from 4000 to 650 cm⁻¹ for these stating materials. For aluminum hydroxide, Al(OH)₃, EMPLURA® hydrargillite, the spectral feature clearly verified as gibbsite. Since gibbsite crystal structure constitutes of octahedral sheets of aluminum hydroxide which is coordinated by Al³⁺ cation, the O—H bond stretching (v_{O—H}) and O—H bending (δ_{O—H}) vibration modes for OH group encompasses the six frequencies at 3621, 3522, 3434, and 3367 cm⁻¹ belonging to v_{O—H}, and 1015 and 963 cm⁻¹ as δ_{O—H}, while the Al—O bond stretching (v_{Al—O}) in octahedral AlO₆ groups can be recognized by the presences of 738 cm⁻¹ and 661 cm⁻¹ bands. For silica flour, all bands were directly related to SiO₂ in SiO₄(tetrahedral) groups. First two bands at 1084 and 1056 cm⁻¹ are represent asymmetric stretching (v_{as Si—O}) of Si—O bond and next two bands at 795 and 775 cm⁻¹ belong to symmetric stretching (v_{s Si-O}) of Si—O, while 693 cm⁻¹ band is associated with Si—O—Si bending (δ_{O—Si—O}) mode. The spectrum of “as-received” zirconium (IV) hydroxide revealed hydrous zirconium oxide; namely, quite broad band emerged in region of 3600-2800 cm⁻¹ and the band at 1633 cm⁻¹ are attributed to O—H asymmetric stretching (v_{as O—H}) of and H—O—H bending (δ_{H—O—H}) vibration modes, respectively, in the water (H₂O) molecule. The other two bands at 1549 and 1332 cm⁻¹ were due to Zr—O bond stretching (v_{Zr—O}) and bending (δ_{Zr—O}) modes, respectively, in Zr—OH group. As for sodium metasilicate, the implications of these bands are as follows; v_{Si—O} stretching in Si—O—Na bond at the bands of 1029 and 963 cm⁻¹ and v_{Si—O} in tetrahedral SiO₄ at 892, 875, and 711 cm⁻¹ bands. Additionally, the contributor of band at 1452 cm⁻¹ may be assignable to v_{as C—O} in CO₃²⁻ group of carbonate compound like NaCO₃. If so, 875 cm⁻¹ band overlapping with SiO₄ is O—C—O out-of-plane bending (δ_{O—C—O}) in CO₃₂— group.

Preparation of samples. In this work, all starting materials were blended to prepare the dry cement mixture prior to adding any water to them. The major dry cement component was composed of 60 wt % aluminum hydroxides, Al(OH)₃, as gibbsite and 40 wt % silica flour, SiO₂. Two additives, sodium metasilicate (SMS) and hydrous zirconium oxide (Zr), were incorporated into the major cement component [Al(OH)₃+SiO₂]. The contents of these additives were 5 wt % for SMS, and 0, 5, and 10 wt % for Zr by total weight of the major dry component. The cementitious materials were prepared in the following six step sequences: 1) A certain amount of water was added to dry blending cement, followed by hand mixing for 1 min.→2) the hand-mixed slurry was poured in borosilicate glass tubes (18 mm inner diam.×150 mm long)→3) slurry-filled tubes were placed in a 99±1% relative humidity (R.H.) for 24 hours at 85° C. to promote the hydrolyzation of SMS and to initiate alkali dissolution of gibbsite by hydrolyzed SMS→4) 85° C.-initiated colloidal cement paste with minimal hydration was moved in autoclave reactor at 300° C. and left for 24 hours to conduct hydrothermal synthesis→5) synthesized solid state cement was removed from alkali-degraded glass tube at ambient temperature→6) removed cement was exposed for 1 and 7 days in scH₂O reactor at 400° C. and 24.1 MPa pressure.

Measurements. Since the consistency of cement slurry plays a pivotal role in governing the workability and pumpability of fresh slurry in geothermal borehole, such a property can be evaluated from the slump flowing test of slurry; namely, a good slump flowing rate is responsible for readily accepted workability and pumpability in geothermal wells. The slump flowing rate, mm, was measured by non-regulated testing method under the use of temporary polyethylene flow cone with the dimension of top open hole of 20 mm diam., bottom hole of 45 mm diam., and 40 mm height. The cement slurry was filled in the cone placed on carbon steel flat flow plate. Thereafter, the cone was slowly lifted, allowing slurry to flow. The slurry slump flowing rate, mm, was determined after 20 seconds from the onset of flowing. The pH of slurry was determined from pore solution extracted by centrifuging 5 min-aged cement slurry after blending thoroughly dry cement and water. The bulk density of slurry was simply measured by dividing the weight (g) of slurry filled completely in plastic container by volume (40 cm³) of container.

The water-fillable porosity for water-saturated samples after exposure in 300° C. autoclave and 400° C. scH₂O was computed by W_{wet}-W_{dry}/W_{wet}×100, where W_{wet} is the weight of water-saturating sample and W_{dry} is the weight of sample dried for at least 4 days in vacuuming oven at 65° C. until the water-absorbed cement becomes constant weight.

X-ray powder diffraction (XRD, 40 kV, 40 mA copper anode X-ray tube) and ATR-FTIR were used to identify amorphous and crystalline phase compositions and phase transitions of tested samples based upon PDF-4/Minerals 2021 database of International Center for Diffraction Data (ICDD).

Thermogravimetric analysis (TGA) concomitant with derivative thermogravimetry (DTG) was used to collect the thermal decomposition parameters including the overall decomposition pattern, onset and peak decomposition temperatures, and mass loss rate. TGA/DTA (model Q50, TA Instruments) analyses ran at the heating rate of 20° C./min in a N₂ flow.

For the compressive strength, young's modulus, and compressive fracture toughness, the long cylindrical cement sample (size, 18 mm diam×˜145 mm long) made in 18 mm inner diam.×150 mm long glass tube was cut to prepare the testing sample with size in 18 mm diam.×36 mm high. Electromechanical Instorn System Model 5967 was used to obtain these mechanical properties. The compressive strength is the capacity of material or structure to resist or withstand under compression. However, even though the cement possessed high compressive strength, the brittle nature of cement engenders a lack of stress energy absorption, reflecting a rapid propagation of pre-existing and newly created cracks in cement bodies. Thus, adequate ductility and stiffness (young's modulus) referring to elongation and elastic, respectively, are required. On the other hand, the compressive fracture toughness is the resistance of brittle cement to the propagation of cracks developed at ultimate compressive strength point (yield point). The development of micro-size initial cracks leading to catastrophic fracture damage depends on the fracture toughness. The key to toughness improvement is a good combination of ultimate compressive strength and ductility in response to the delay and totally prevent crack propagation. To obtain quantitative data of compressive fracture toughness, the total energy of pre-stress and post-stress energy absorptions consumed until reaching cement's compressive failure were determined; it was computed from the enclosed area between the beginning and the end of the compressive stress-strain curve.

JEOL 7600F Scanning Electron Microscope (SEM) (Pleasanton, CA, USA) image analysis coupled with Energy Dispersive X-ray (EDX) elemental composition survey of typical areas of fractured cement surfaces was conducted to explore two physicochemical factors: The microstructural development and characterization, and the identification and morphology of phase transition products.

### Results and Discussion

Properties of Cement Slurry. Table 2 gives the properties of cement slurries with 0, 5, and 10% Zr including water/cement (W/C) weight ratio, density, slump flowing rate, and pH of pore solution extracted from slurry by centrifuge. In W/C ratio, C is total weight of all dry cement blending including gibbsite, silica flour, SMS, and hydrous ZrO₂. For deciding an appropriate W/C ratio, the water was added to fresh cement slurry until occurring some bleeding. The bleeding in fresh cement slurry refers to the process that free water in slurry is pushed upward to the surface. The W/C ratio appears to be slightly increased by increasing Zr content. Correspondingly, the slurry density showed its similar upward trend with increasing Zr content from 1.76 g/cm³ of Zr-free slurry to 1.84 g/cm³ of 10% Zr. As expected, the increase of W/C ratio with high Zr content offered the improved workability and pumpability of slurry. In fact, the resulting slump flow noticeably enhanced from 75 mm for Zr-free to 88 mm for 10% Zr. This fact not only is due to a high W/C ratio, but also may be lubricants effect of Zr surface by its good wettability with alkali-base cement pore solution. Interestingly, pH value of 12.98 for Zr-free tends to decline with increased Zr to 12.81 for 10% Zr.

TABLE 2
Properties of Cement Slurries with and Without Zr

| | Cement Slurry | | |
|---|---|---|---|
| Properties | 0% Zr | 5% Zr | 10% Zr |
| W/C ratio | 0.44 | 0.46 | 0.48 |
| Density (g/cm³) | 1.76 | 1.80 | 1.84 |
| Slum flow (mm) | 75 | 81 | 88 |
| pH | 12.98 | 12.85 | 12.81 |

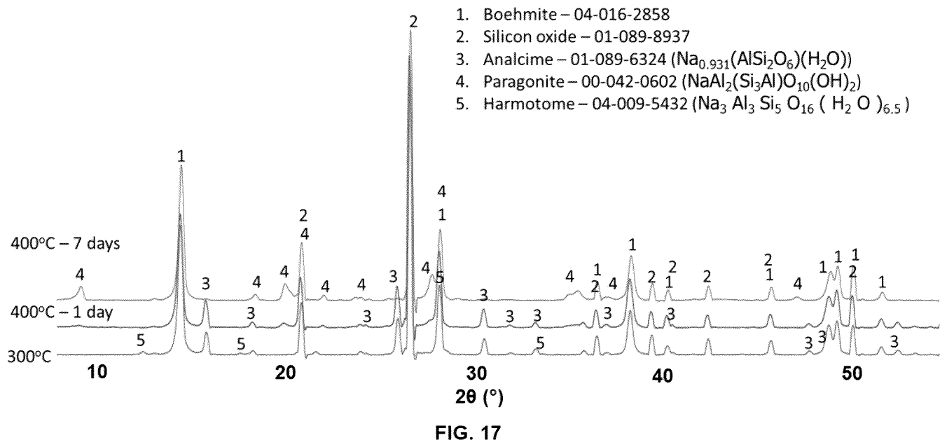

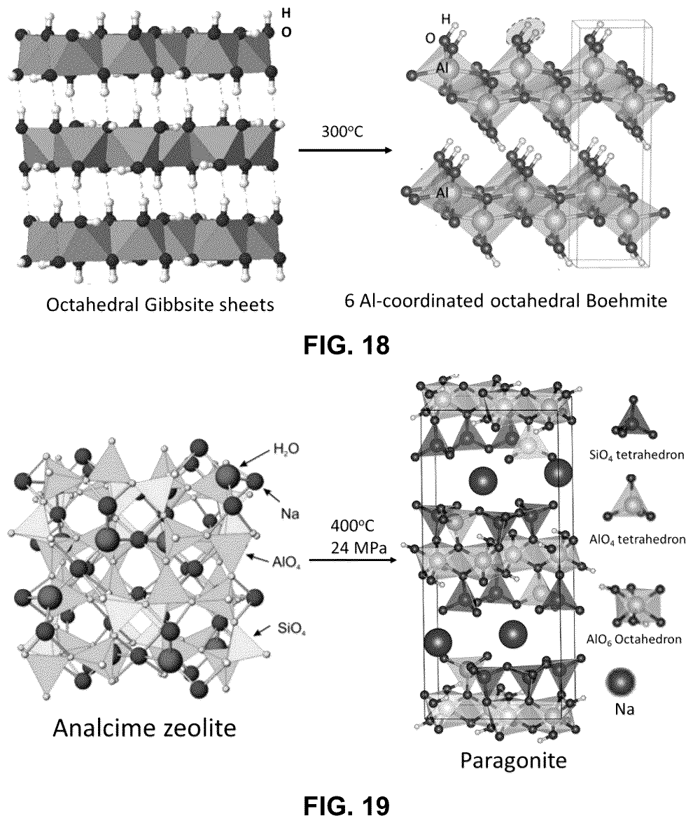

Phase Composition and Transition. FIG. 17 shows XRD patterns of 300° C.-autoclaved Zr-free cements before and after exposure for 1 and 7 days in scH₂O at 400° C. and 24.1 MPa pressure. For the cements made at 300° C., three crystalline hydration phases were identified: One was boehmite as major phase representing an intense line signal of its d-spacings and two zeolites as minor ones, harmotome [Na₃Al₃Si₅O₁₆(H₂O)_{6.5}] and analcime along with weak line intensity. No gibbsite crystal as starting material was found, cleanly displaying that phase transition of gibbsite to boehmite occurred at 300° C. as gibbsite→boehmite octahedral structure transformation drawn in FIG. 18. As well documented, this phase transformation was initiated by alkali dissolution of gibbsite, following by precipitation of boehmite at hydrothermal temperature ≥100° C., Al(OH)_{3(cy)}+OH⁻→Al(OH)₄_{^{−}}_{(aq)}→γ-AlOOH_{(cry)}+H₂O+OH⁻. Since the resources of ionic Al reactant is only Al(OH)₄_{^{−}}_{(aq)} from gibbsite, Al(OH)₄_{^{−}}_{(aq)} not only induces boehmite formation, but also contributed to assembling zeolite structure.

When this 300°-made cement exposed for 1 day in scH₂O, one particular attention in XRD pattern was the disappearance of harmotome. The phase transition of Na-harmotome to analcime appears to occur at hydrothermal temperature of 250° C.; all harmotome are likely to be transferred to analcime at 400° C. Furthermore, the phase transition of analcime to paragonite [NaAl₂(Si₃Al)O₁₀(OH)₂] in mica mineral family can be seen in the XRD pattern after 7 days exposure in scH₂O. This pattern revealed only two major crystalline hydrate phases, paragonite and boehmite. Like analcime zeolite→paragonite phase transition, the zeolite→muscovite in mica family transition already was reported in the study on the phase transition of kaolinite to muscovite through the K−F zeolite as metastable intermediate phase at hydrothermal temperature of 300° C. under a very high pressure of 100 MPa. The crystal structure of muscovite is comprised of sheet of AlO₆ octahedra which was sandwiched by two sheets of AlO₄— and SiO₄-combined tetrahedra units. The sandwiched three layers are linked by large interlayer cations like Na and K. Since the crystal structure of paragonite is almost same as that muscovite, the analcime→paragonite structural transformation can be illustrated in FIG. 19.

In the chemistry aspect of analcime→paragonite phase transition, the solubility studies of corundum (Al₂O₃) in scH₂O indicated that Al(OH)₃^{O}_{(aq)} was a dominate concentrations at 500° C. and 200 MPa pressure. Based upon this information, paragonite was yielded by supercritical hydrothermal synthesis between albite and Al(OH)₃^{O}_{(aq)}, according to the following solubility equilibrium, NaAlSi₃O_{8(cry)} (albite)+2 Al(OH)₃^{O}_{(aq)}↔NaAl₂(Si₃Al)O₁₀(H)_{2(cry)}+2H₂O. Thus, assuming the presence of Al(OH)₃^{O}_{(aq)} and additional SiO_{2 (aq)} in the disclosed cementitious material, the phase transition chemistry of analcime to paragonite in scH₂O may be explained by the following solubility equilibrium model; Na(AlSi₂O₆)(H₂O)_{(cry)} (analcime)+2 Al(OH)₃^{O}_{(aq)}+SiO_{2 (aq)}↔NaAl₂(Si₃Al)O₁₀(OH)_{2(cry)}+3H₂O+2H⁺. If this model is rational, in this work, the paragonite may be formed based on in-situ supercritical hydrothermal synthesis between analcime, Al(OH)₃^{O}_{(aq)}, and SiO_{2 (aq)}.

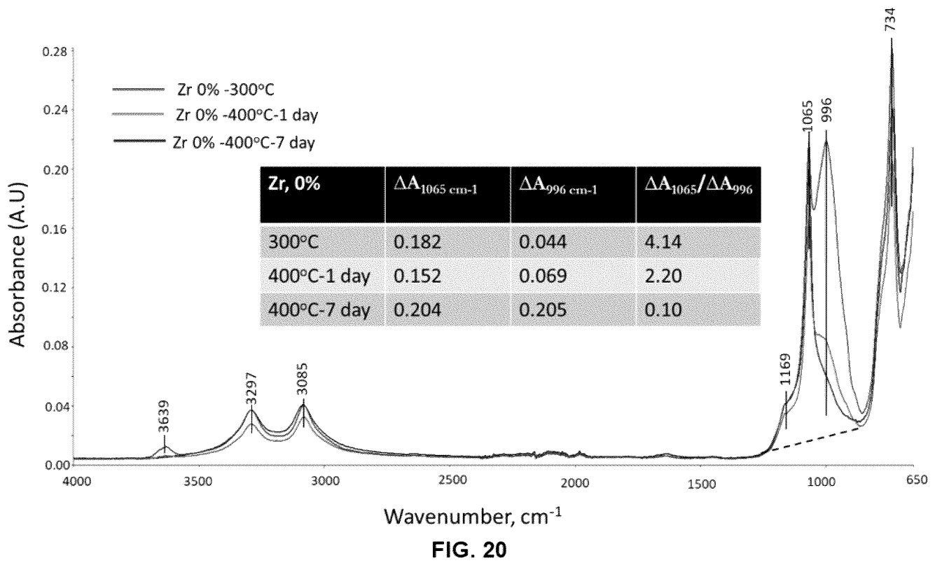

These XRD results were supported by ATR-FTIR probe for using same samples as that in XRD study. FIG. 20 gives ATR-FTIR spectra in the frequency region from 4000 to 650 cm⁻¹ for 300° C.-autoclaved Zr-free cements after exposure in 1- and 7-day-400° C. scH₂O. For 300° C.-autoclaved samples, the spectrum exhibited the four representative bands at 3297, 3085, 1065 and 734 cm⁻¹ and two shoulder bands at 1169 and 996 cm⁻¹. All represented bands and shoulder band at 1169 cm⁻¹ pertinent to boehmite. The 3297, 3085, 1169, 1065 and 734 cm⁻¹ bands, respectively, were ascribed to v_{as O—H}, v_{s O—H}, δ_{as Al—C—H}, δ_{s Al—C—H}, in Al—O—H bond and v_{s Al—O} in octahedral AlO₆. Since XRD results revealed the formation of two zeolites, analcime and harmotome as minor phases, the literature provides the information on which the spectra of zeolites including analcime, phillipsite, harmotome, and gismondite are characterized by providing the asymmetric stretching vibration of tetrahedral Si—O-T (T: Si and Al) oxygen-bridged bond structure in range of 1025 to 998 cm⁻¹ and symmetric stretching vibration of same bridge bond in range of 794 to 709 cm⁻¹. Hence, weak shoulder band at 996 cm⁻¹ and band at 734 cm⁻¹ belong to the v_{as T-O} and v_{s T-O}, respectively, in tetrahedral Si—O-T bond structure. The latter band is likely to be overlap with octahedral AlO₆ in boehmite. After exposure to 400° C. scH₂O for 1 day, these two bans at 996 and 734 cm⁻¹ prominently rose, compered that with 300° C.-made cement. Interestingly, an extending exposure time to 7 days resulted in a striking rise of these bands, strongly demonstrating that the paragonite becomes one of major phases with boehmite. In contrast, there is no significant change in the intensity of boehmite-related bands at 1065 cm⁻¹ for 1- and 7-day-exposed cements in scH₂O. Therefore, attention next was paid to determining the relative proportion of boehmite to zeolite or paragonite by comparing the ratio of absorbance (A.U.) height, ΔA, at 1065 and 996 cm⁻¹ (seen in table). The height was computed based upon the baseline. The ΔA_{1065 cm}⁻¹/ΔA_{996 cm}⁻¹ ratio of 300° C. cement was 4.14. This value declined to 2.20 after exposure at 1-day−400° C. Further decline to 0.10 was observed from 7 days extending exposure. As a result, at 300° C., the boehmite was identical as predominated phase compared with total zeolites including harmotome and analcime, whereas scH₂O served in promoting preferential precipitation of paragonite rather than boehmite. It appears that an aggressive reaction of analcime with Al(OH)₃^{O}_{(aq)} and SiO_{2 (aq)} due to the extended exposure in scH₂O led to yielding a similar quantity of paragonite to boehmite.

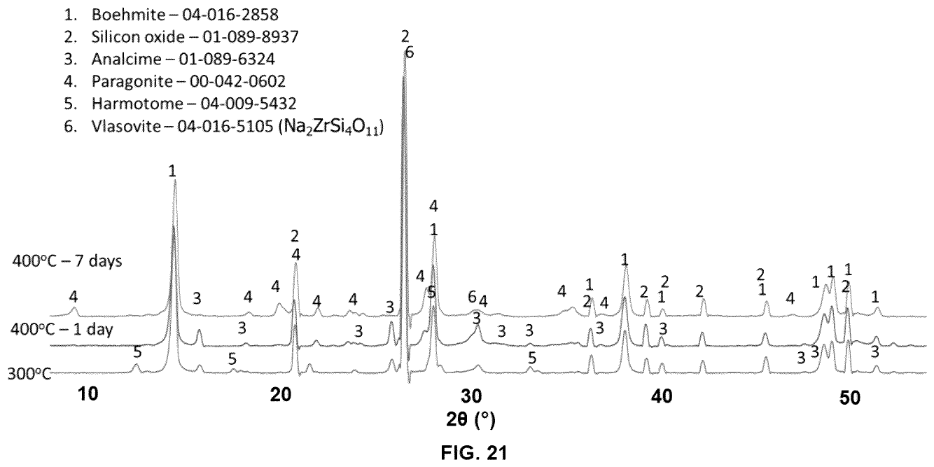

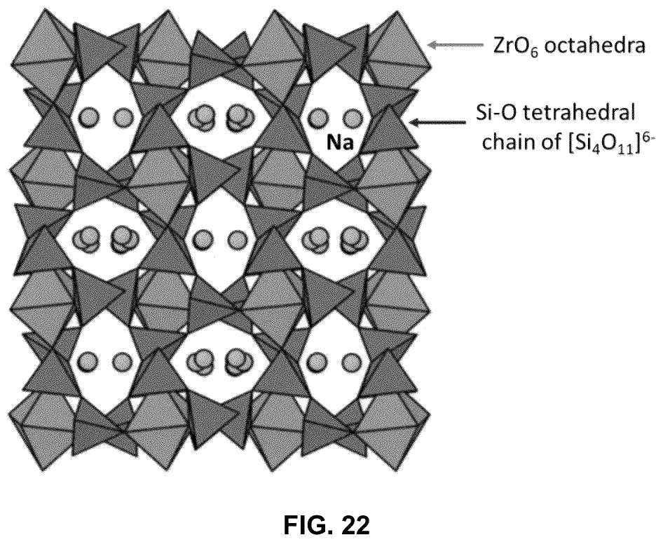

FIG. 21 shows XRD patterns of 5% Zr-incorporated 300° C.-autoclaved cements after exposure for 1 and 7 days in scH₂O. As seen in figure, the feature of overall pattern except for two new crystalline phases closely resembled that of Zr-free samples, namely, 1- and 7-day exposures were responsible to the phase transitions of harmotome to analcime and analcime to paragonite, respectively. Two new phases were baddeleyite (ZrO₂) as starting material and anhydrous vlasovite (Na₂ZrSi₄O₁₁) as in-situ supercritical hydrothermal synthesis product after 7-day exposure. The vlasovite phase was precipitated in coexistence with boehmite and paragonite as major ones. The vlasovite structure is composed of ZrO₆ octahedra linked by Si—O tetrahedral chain of [SiO₄Oi]⁶⁻ under the Na atom coordination (FIG. 22). Regarding the in-situ supercritical hydrothermal synthesis of vlasovite, since the dissolution of crystalline ZrO₂, ZrO_{2(cry)}+2H₂O+Zr(OH)₄^{O}_{(aq)}, potentially occurs in scH₂O, it was synthesized, according to the following solubility equilibrium model, 2Na⁺+Zr(OH)₄⁰_{(aq)}+⁴SiO_{2(aq)}↔Na₂ZrSi₄O_{11(cry)}+H₂O+2H⁺.

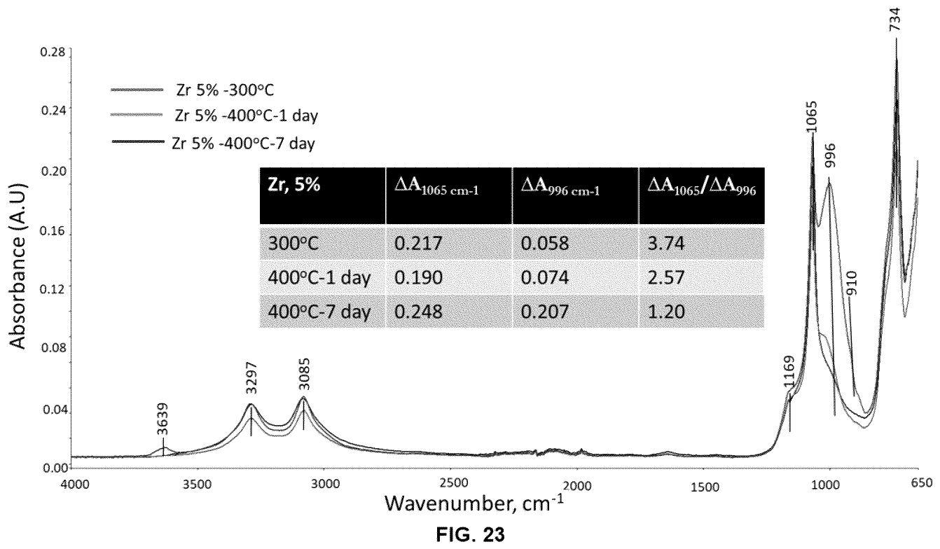

FIG. 23 represents ATR-FTIR spectra of 5% Zr-incorporated 300° C.-autoclaved cements after exposure for 1 and 7 days in scH₂O. Like XRD results, the spectra were similar to that of Zr-free cement. The spectrum of vlasovite involves v_{Si—O} of tetrahedral Si—O chain at 1126, 1093, and 942 cm⁻¹ bands and v_{Zr—O} of octahedral ZrO₆ at 734 cm⁻¹. Thus, the shoulder band at 910 cm⁻¹ may be associated with tetrahedral Si—O chain in vlasovite. However, the other tetrahedral bands were very difficult to identify because of overlapping with boehmite and paragonite, while ZrO₂-related bands at 1549 and 1332 cm⁻¹ were disappeared. The ΔA_{1065 cm}⁻¹/ΔA_{996 cm}⁻¹ ratio indicated, like Zr-free samples, downward trend from 3.74 at 300° C. to 1.20 after 7-day exposure in scH₂O. Compared with Zr-free, one difference was a less yielding of paragonite after 7-day exposure, likely suggesting that adding ZrO₂ may suppress the precipitation of paragonite because of the consumption of limited Na⁺ and SiO_{2(aq)} reactants to assemble vlasovite structure.

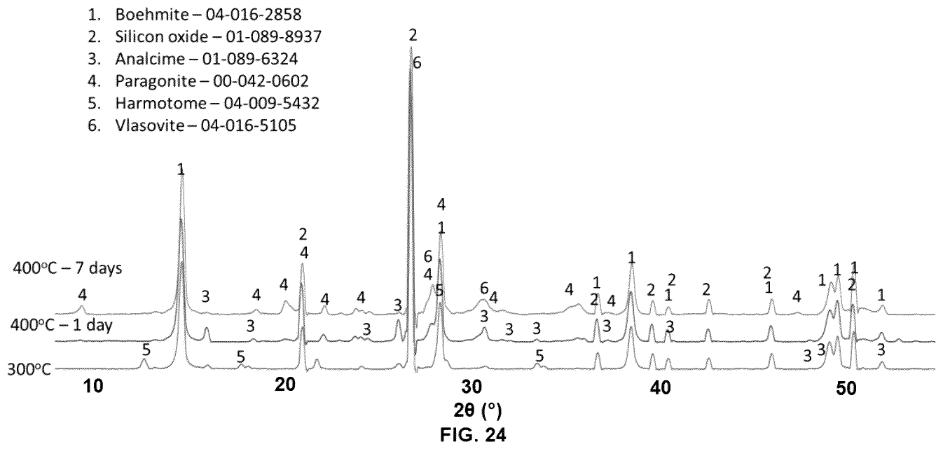

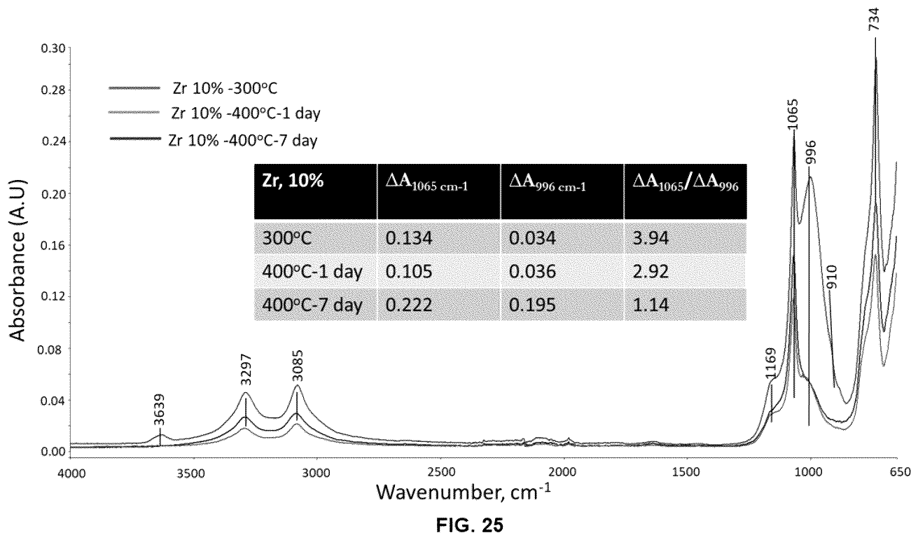

FIG. 24 shows XRD analysis of 10% Zr-incorporated 300° C.-autoclaved cements after exposure for 1 and 7 days in scH₂O. The data obtained was quite same as that of 5% Zr. Correspondingly, ATR-FTIR results including spectrum feature and ΔA_{1065 cm}⁻¹/ΔA_{996 cm}⁻¹ ratio (FIG. 25) were almost identical to 5% Zr.

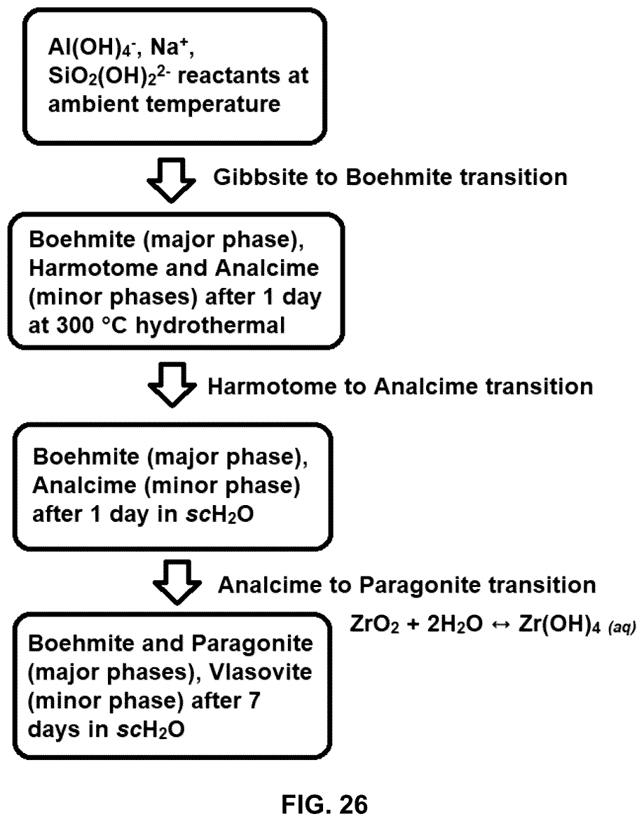

The integration of all XRD and ATR-FTIR results for Zr-free cement gave the following findings: The starting materials in aqueous media liberated these potential ionic reactants, Al(OH)₄_{^{−}}_{(aq)} from gibbsite, SiO₂(OH)₂⁻² as anion ion and 2Na⁺ as cationic ion from SMS (Na₂SiO₃) at ambient temperature. Before reaching at 300° C., the alkali dissolution of gibbsite led to gibbsite→boehmite phase transition as one of hydrothermal syntheses. At 300° C., the other hydrothermal synthesis between these reactants inducted the precipitations of harmotome and analcime as minor phase coexisting with boehmite as major phase. The phase transition of harmotome to analcime took place in a short-term exposure for 1 day in scH₂O. Further extended exposure to 7 days engendered analcime (zeolite)→paragonite (mica) phase transition as well as crystal structure transformation, reflecting that paragonite becomes one of major phases with boehmite. Adding ZrO₂ to cements introduced the formation of vlasovite as in-situ supercritical hydrothermal synthesis product after 7 days exposure in scH₂O. The phase transitions and new in-situ supercritical hydrothermal syntheses product described above was summarized in FIG. 26.

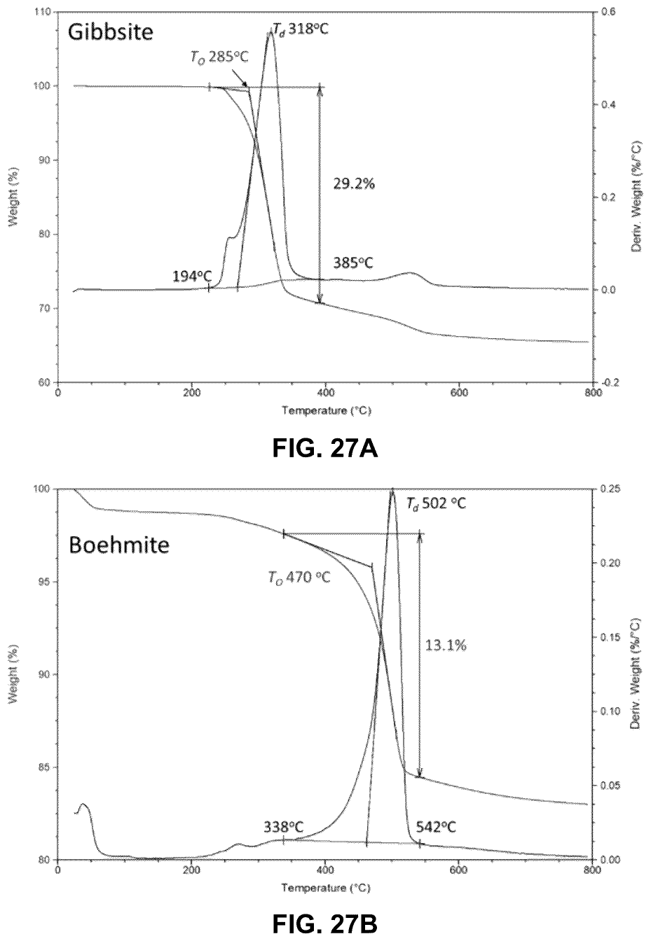

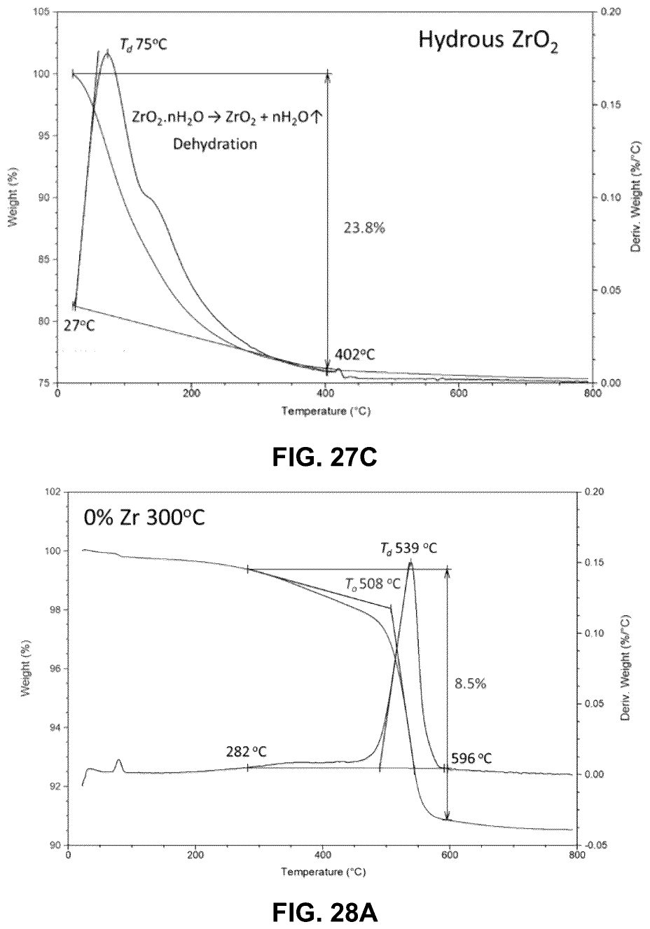

Thermal Stability. To support the above information, the study was shifted towards obtaining information on thermal stability of phase composition formed in pre- and post-7 day scH₂O exposed cements. FIGS. 27A-27C depict the combined curves of TGA and DTG of the “as-received” starting materials. For gibbsite, the combined curves showed the onset temperature (Tₒ, 285° C.) of thermal degradation in TGA curve and peak degradation temperature (T_{d}, 318° C.) in DTG curve. The Tₒ was determined from DTG curve; namely, Tₒ occurred between 194° C. at the beginning and 385° C. at the peak end in DTG curve based upon baseline. Also, the mass percent loss in the temperature range of 194° to 385° C. was 29.2%. Since this mass loss is due to the theoretical dehydroxylation, 2Al(OH)₃→Al₂O₃+3H₂O, at 270° C., the theoretical molar mass loss of water computed from [3H₂O/2Al(OH)₃]×100=H₂O % is 34.6%. Thus, compared with this theoretical mass loss of water, a 29.2% obtained from TGA corresponds to the dehydroxylation rate of 84.4%. Returning to FIGS. 27A-27C, to gain information on the thermal decomposition of boehmite, the boehmite (Catapal 200 alumina) obtained from Sasol North American Inc was used. TGA/DTG curves revealed that there are two step decomposition process: The first step is dehydration, following by dehydroxylation. In this figure, the first decomposition at temperatures, ranging from ˜27° C. to ˜100° C., implicates in dehydration process as minor decomposition. The major decomposition takes place at 470° C. (To) as theoretical dehydroxylation, 2γ-AlOOH→γ-Al₂O₃+H₂O. Computing the dehydroxylation rate by molar mass loss of H₂O, (H₂O/2AlOOH)×100=H₂O %, it was 15.0% which is close enough to 13.1% obtained from TGA. For hydrous ZrO₂·nH₂O, TGA-DTG curves exhibited a typical prolonging dehydration pattern of the water bounded to ZrO₂ over a wide thermal decomposition temperature from 27° to ˜400° C. The TGA curve indicated 23.8% loss of water molecules. Based upon simple dehydration of hydrous ZrO₂·nH₂O, ZrO₂·nH₂O→ZrO₂+nH₂O, the number (n) of water molecules was computed from the following equation, [nH₂O/(ZrO₂+nH₂O)]×100=23.8%. The resulting number (n) was 2.14, so that the formulary of “as-received” hydrous ZrO₂ can be described as ZrO₂·2.14H₂O which is reasonable for meeting a general formula ZrO₂·(2.0-2.3)H₂O.

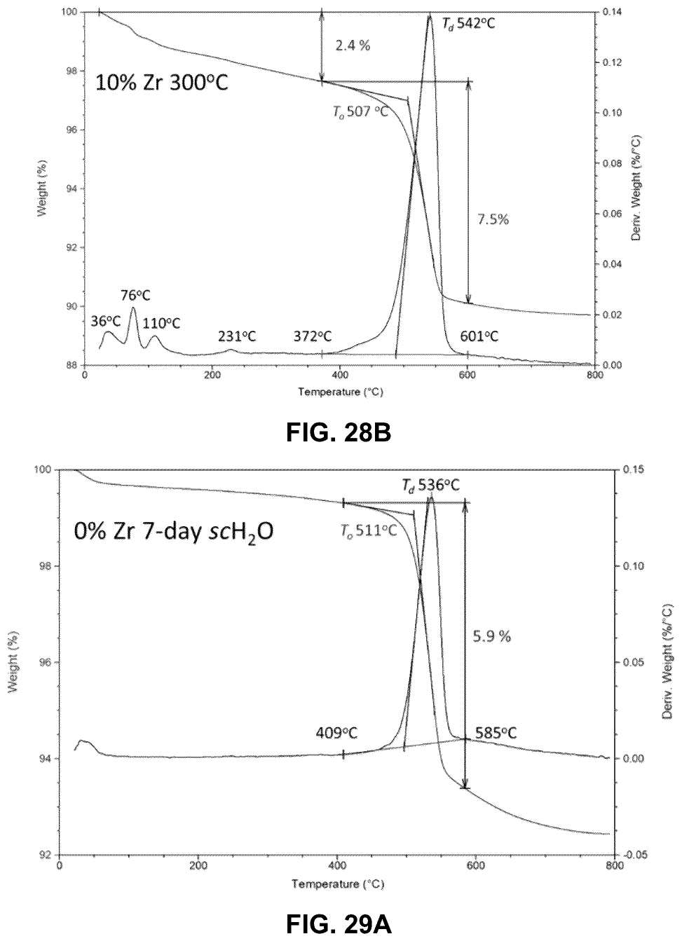

FIGS. 28A-28B illustrate TGA-DTG curves of Zr-free and 10% Zr-incorporating 300° C.-autoclaved cements. For Zr-free cement, the weight loss in range of 50-100° C. is on account of a volatilization of moisture adsorbed to cement. As described in XRD data, the phase composition of this cement consisted of boehmite as major phase and zeolites, analcime [Na(AlSi₂O₆)(H₂O)], and harmotome, Na₃Al₃Si₅O₁₆(H₂O)_{6.5}, as minor ones. As seen in chemical formulas of these zeolites, the first decomposition is dehydration. The dehydration of analcime arises in temperature range between 238° (Tₒ) and 380° C. and molar mass loss in H₂O by TGA was 7.3%. Theoretical molar mass loss of H₂O based on the following dehydration reaction, Na(AlSi₂O₆)(H₂O)→Na(AlSi₂O₆)+H₂O, was 8.17%. Additionally, T_{d} of analcime was 328° C. In this work, for harmotome, although no experimental data is available, the theoretical molar mass loss of H₂O was 17.64%, being tantamount to 2.16-fold higher than theoretical loss of analcime (8.17%). This fact implies that analcime possess a better thermal stability than harmotome. Nevertheless, compering with analcime data in this literature, the resulting TGA-DTG curves exhibited much higher 508° C. (To) and 539° C. (T_{d}), and mass loss of 8.5% in range of 282° C. to 596° C., corresponding to 270° C. and 211° C. lower for To and T_{d}, respectively. Whereas, To and T_{d} values of boehmite were only 38° C. and 37° C. lower, respectively. Thus, regardless of that the mass loss of 8.5% was somewhat lower compared with 13.1% of boehmite, this TGA-DTG curve is likely to be belonged to boehmite as the major phase, strongly verifying that the thermal stability of boehmite was much greater than analcime zeolite.

For 10% Zr-incorporating cement, DTG peaks at 36° C., 76° C., 110° C., 231° C., and 372° C. suggested the presence of hydrous ZrO₂ as starting material in cement body. As aforementioned, the dehydration of hydrous ZrO₂ was characterized as its steady loss behavior over a quite wide temperature range up to nearly 400° C. Hence, assuming this dehydration occurs between 27° C. and 372° C., the mass loss of 2.4% is due to total dehydration of hydrous ZrO₂. Also, this finding demonstrated that the conversion of hydrous ZrO₂ into reactive Zr(OH)₄^{O}_{(aq)} do not occur at 300° C. Thus, as illustrated in FIG. 26, such conversion may take place during 7-day exposure in scH₂O. Since the phase composition of this sample was almost same as that of Zr-free cement, except for incorporation of additional baddeleyite (ZrO₂), the values of Tₒ and T_{d} as 507° C. and 542° C., respectively, were almost same as that from Zr-free cement. Hence the major TGA-DTG curves are associated with boehmite.

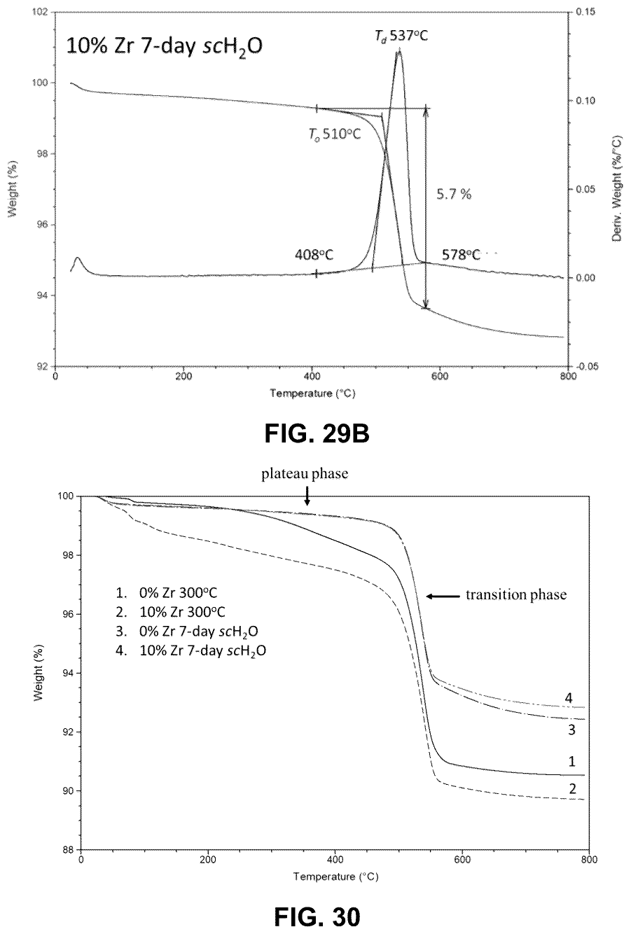

For both Zr-free and -containing cements after 7 days scH₂O exposure, the feature of TGA-DTG curves (FIGS. 29A-29B) was identically similar; in fact, the values of Tₒ and T_{d}, respectively, were 511° C. and 536° C. for Zr-free cement and 510° and 537° C. for 10% Zr cement. Such similarity may be due to the presence of two same major phases, boehmite and paragonite. Additionally, as is evident from the formulary of paragonite [NaAl₂(Si₃Al)O₁₀(OH)₂], like boehmite, this first degradation is dehydroxylation. Compared with 300° C. cements, one obvious difference was the mass loss; namely, the lowest loss of 5.7% was observed from 10% Zr cement after 7 days scH₂O exposure, while second lower loss of 5.9% comes from Zr-free cement after 7-day exposure. Two 300° C. cements showed 8.5 and 7.5% loss for Zr-free and 10% Zr-cements, respectively. Furthermore, the integrated TGA curves of all samples (FIG. 30) clearly visualized that two 7-day scH₂O exposure cements displayed the existence of plateau phase prior to reaching transition phase, highlighting that these cements formed by phase transition exert an improved thermal stability. One major reason for this was the fact that hydroxyl (OH)-incorporated crystalline phases like boehmite and paragonite have a far better thermal stability rather than hydration (H₂O)-incorporated phases like zeolites in scH₂O, thereby resulting in lower mass loss. Since the dehydration of zeolites leads to the distortion of crystal structure, such a distortion may develop an undesirable in-situ mechanical stress in cement matrix. Furthermore, despite being only 0.2% lower than that of 7-day exposed Zr-free cement, the lowest mass loss for 7-day exposed 10% Zr-cement may be due to the presence of highly thermal stable anhydrous vlasovite at >644° C. formed as in-situ supercritical hydrothermal synthesis product despite its limited quantity.

Microstructure Development and Characterization. The study next was centered on exploring the microstructure developed in 300° C.-autoclaved cements with and without Zr before and after exposure for 1 and 7 days in scH₂O. The targeted explorations in basis of SEM image analysis coupled with EDX elemental mass (Wt %) and atomic (%) fractions encompassed the chemical reactivity of silica flour and Zr as fillers with cement matrix, morphological characterization, and identification of major crystalline phases for the physical fracture-induced surfaces of cements. It should be noted that as is seen in EDX, Ag was used as a coating material to avoid charging of the cement surface.

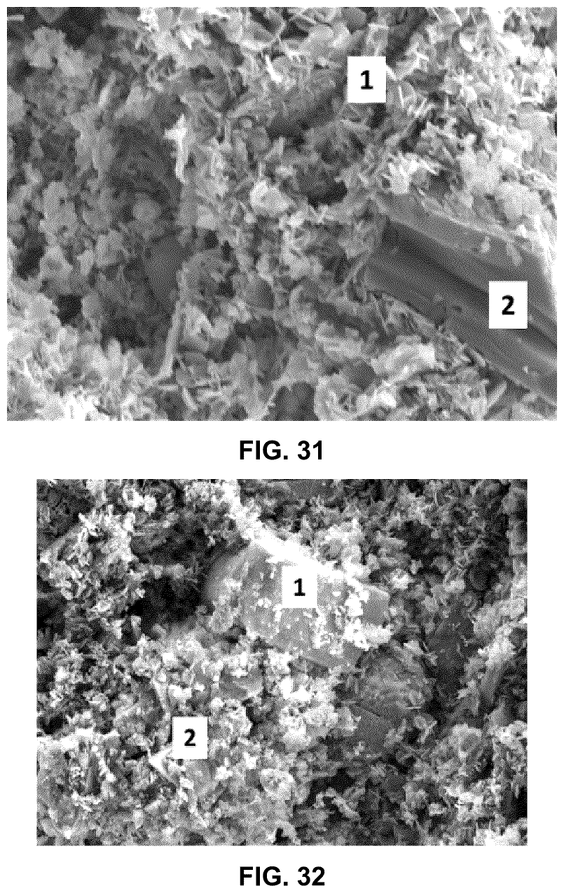

FIG. 31 is the SEM image concomitant with elemental compositions of 300° C.-autoclaved Zr-free cement. In this cement, since the major crystalline phase is boehmite, both major elemental mass and atomic fractions at the site denoted as No. 1 were occupied with O and Al. Furthermore, in the viewpoint of crystal morphology, the plate-like crystals with lath-like profiles can be identified as boehmite which was formed everywhere in the cement except for the site No. 2. As is evident from two major elements, Si and O, the site No. 2 is silica flour (SiO₂).

TABLE 3A
Elemental Analysis for Sample Location 1 in FIG. 31

| Element | Wt % | Wt % Sigma | Atomic % |
|---|---|---|---|
| O | 31.15 | 0.41 | 43.50 |
| Al | 53.24 | 0.38 | 44.08 |
| Si | 15.61 | 0.28 | 12.42 |
| Total | 100.00 | | 100.00 |

TABLE 3B
Elemental Analysis for Sample Location 2 in FIG. 31

| Element | Wt % | Wt % Sigma | Atomic % |
|---|---|---|---|
| O | 22.84 | 0.45 | 34.02 |
| Al | 13.98 | 0.21 | 12.35 |
| Si | 63.19 | 0.42 | 53.63 |
| Total | 100.00 | | 100.00 |

Regarding the reactivity of Zr filler, FIG. 32 shows SEM image of 5% Zr-containing cement after 1 day scH₂O exposure. The images at Nos. 1 and 2 sites along with elemental mass fractions expressed the presence of well-reacted Zr particles with Na, Al, and Si, although some Al might be related to boehmite. At a particular No. 2 site, Zr particle was completely covered with reaction products.

TABLE 4A
Elemental Analysis for Sample Location 1 in FIG. 32

| Element | Wt % | Wt % Sigma | Atomic % |
|---|---|---|---|
| C | 14.71 | 1.84 | 35.47 |
| O | 18.00 | 0.77 | 32.59 |
| Na | 0.50 | 0.15 | 0.63 |
| Al | 5.72 | 0.20 | 6.14 |
| Si | 8.08 | 0.26 | 8.33 |
| Zr | 53.00 | 1.28 | 16.83 |
| Total | 100.00 | | 100.00 |

TABLE 4B
Elemental Analysis for Sample Location 2 in FIG. 32

| Element | Wt % | Wt % Sigma | Atomic % |
|---|---|---|---|
| O | 34.35 | 0.57 | 59.35 |
| Na | 1.41 | 0.15 | 1.70 |
| Al | 16.45 | 0.25 | 16.86 |
| Si | 11.17 | 0.22 | 11.00 |
| Zr | 36.61 | 0.54 | 11.09 |
| Total | 100.00 | | 100.00 |

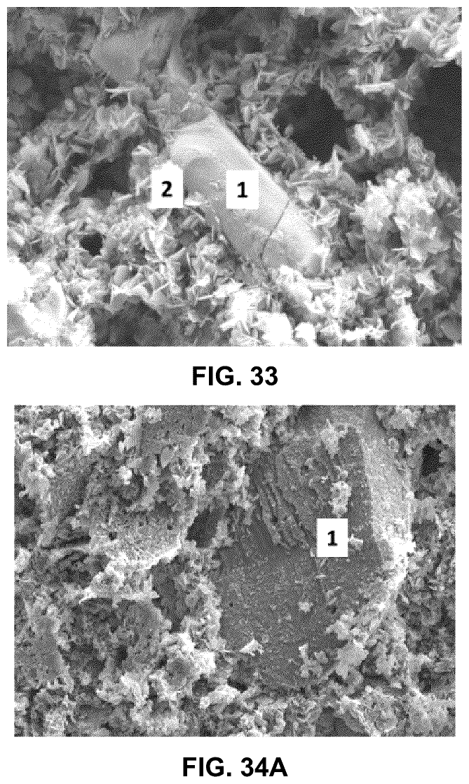

In contrast, despite 7-day-extended exposure for same sample, a poorly, or none reacted Zr filler surrounded by boehmite crystals (No. 2) was observed at site No. 1 in FIG. 33. The presence of such Zr filler may be due to a lack of ionic reactants, Al(OH)₄⁻, Na⁺, and SiO₂(OH)₂⁻². Furthermore, the appearance of smooth surface texture of Zr filler on fractured surface of cement strongly suggested that there is no adhesive bonding of Zr surface to boehmite-based cement matrix. Thus, the disbondment at matrix/Zr filler joint took place at interfaces between matrix and Zr filler as adhesive failure mode. In fact, as seen in SEM image, the presence of large voids may come from the removal of disbonded Zr fillers from cement matrix in preparing fracture surfaces by physical procedure.

TABLE 5A
Elemental Analysis for Sample Location 1 in FIG. 33

| Element | Wt % | Wt % Sigma | Atomic % |
|---|---|---|---|
| C | 12.48 | 1.07 | 35.22 |
| O | 12.80 | 0.42 | 27.12 |
| Na | 0.29 | 0.09 | 0.43 |
| Al | 4.33 | 0.12 | 5.44 |
| Si | 6.51 | 0.16 | 7.85 |
| Ca | 0.69 | 0.13 | 0.59 |
| Zr | 62.90 | 0.87 | 23.37 |
| Total | 100.00 | | 100.00 |

TABLE 5B
Elemental Analysis for Sample Location 2 in FIG. 33

| Element | Wt % | Wt % Sigma | Atomic % |
|---|---|---|---|
| O | 32.58 | 0.42 | 49.17 |
| Na | 1.73 | 0.12 | 1.81 |
| Al | 33.70 | 0.33 | 30.16 |
| Si | 17.45 | 0.25 | 15.00 |
| Zr | 14.55 | 0.51 | 3.85 |
| Total | 100.00 | | 100.00 |

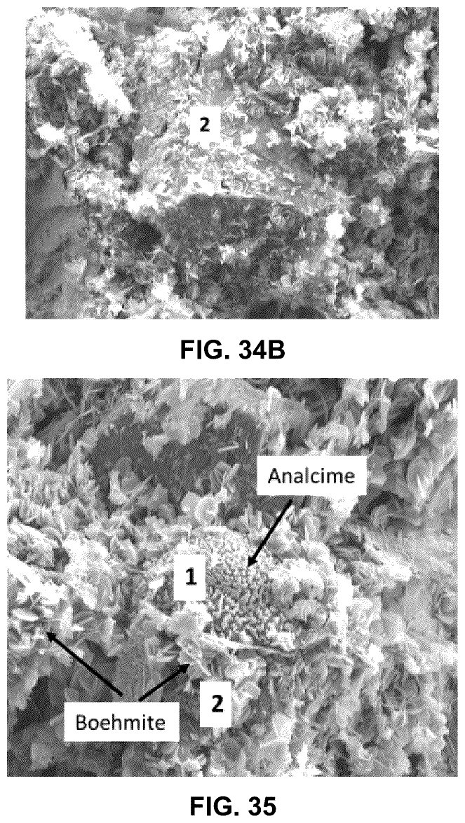

As to the reactivity of silica flour, since silica flour is pozzolan, the attention was paid to its pozzolanic reactivity with alkalis, Na⁺, Al(OH)₄₋, and OH⁻ liberated from hydrolysis of SMS and alkali dissolution of gibbsite. FIGS. 34A-34B display the images of silica flour before and after 7-day scH₂O exposures for 300° C.-autoclaved 10% Zr cements, respectively. For pre-exposure cement (FIG. 33), some pozzolanic reactions at the site No. 1 were observed from the elemental mass fractions of 0.45 and 14.26 wt % for Na and Al, respectively. However, at site No. 2 for the post-exposure cement, no presence of Na and only 4.15 wt % Al was found. Thus, the pozzolanic activity of silica flour is likely to be minimum in this cement system.

TABLE 6A
Elemental Analysis for Sample Location 1 in FIG. 34A

| Element | Wt % | Wt % Sigma | Atomic % |
|---|---|---|---|
| O | 28.90 | 0.22 | 41.41 |
| Na | 0.45 | 0.07 | 0.44 |
| Al | 14.26 | 0.11 | 12.12 |
| Si | 56.39 | 0.20 | 46.03 |
| Total | 100.00 | | 100.00 |

TABLE 6B
Elemental Analysis for Sample Location 2 in FIG. 34B

| Element | Wt % | Wt % Sigma | Atomic % |
|---|---|---|---|
| O | 30.39 | 0.34 | 43.33 |
| Al | 4.15 | 0.11 | 3.51 |
| Si | 65.46 | 0.34 | 53.16 |
| Total | 100.00 | | 100.00 |

On identifying the major crystal phases formed in cements, FIG. 35 exhibits the presence of small cubic 1-4 μm size crystals at site No. 1 for the fractured surfaces of Zr-free cement after 1-day exposure in scH₂O. At the site No. 1, the EDX atomic ratios were as follows, Al/Na=1.4, Si/Na=3.1, Al/Si=0.5 and O/Na=7.3. These atomic ratios closely resembled the atomic ratios (Al/Na=1.1, Si/Na=2.2, Al/Si=0.5 and O/Na=7.5) of analcime [Na_{0.931}(AlSi₂O₆)(H₂O)] as minor phase. These two combined information, cubic-crystal morphology and atomic ratios, appears to be identify that this crystal phase is analcime. The image also revealed the presence of boehmite in around of analcime, expressing that analcime seems to have a good affinity with boehmite.

TABLE 7A
Elemental Analysis for Sample Location 1 in FIG. 35

| Element | Wt % | Wt % Sigma | Atomic % |
|---|---|---|---|
| O | 44.28 | 0.19 | 57.17 |
| Na | 8.71 | 0.11 | 7.83 |
| Al | 14.29 | 0.11 | 10.94 |
| Si | 32.72 | 0.15 | 24.06 |
| Total | 100.00 | | 100.00 |

TABLE 7B
Elemental Analysis for Sample Location 2 in FIG. 35

| Element | Wt % | Wt % Sigma | Atomic % |
|---|---|---|---|
| O | 31.22 | 0.38 | 43.58 |
| Na | 0.79 | 0.13 | 0.77 |
| Al | 48.72 | 0.34 | 40.33 |
| Si | 19.27 | 0.28 | 15.32 |
| Total | 100.00 | | 100.00 |

TABLE 7C
Comparison of Sample Location 1 in FIG. 35 and Analcime

| Atomic Ratio | Location 1 | Analcime |
|---|---|---|
| Al/Na | 1.4 | 1.0 |
| Si/Na | 3.1 | 2.0 |
| Al/Si | 0.5 | 0.5 |
| O/Na | 7.3 | 7.0 |

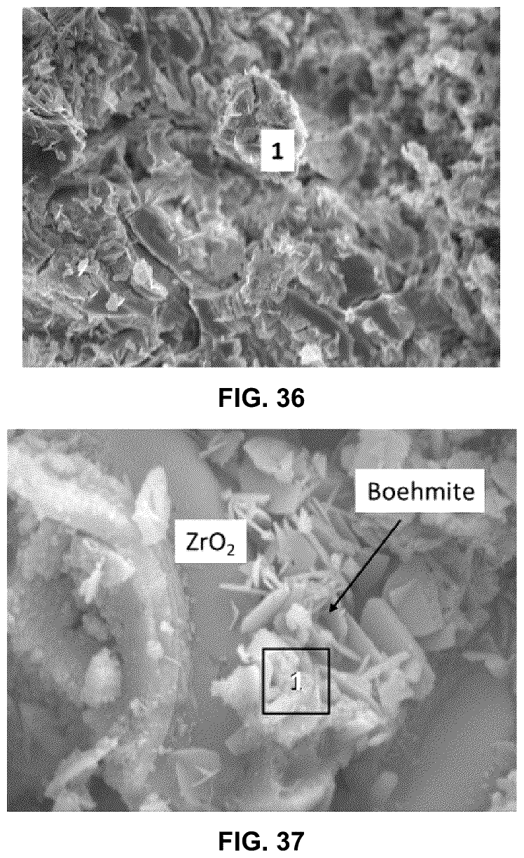

FIG. 36 shows the SEM-EDX result for the post-7 day exposed 5% Zr cement. Since the major phases of this cement are comprised of boehmite ad palagonite, the crystal morphology at the site No. 1 does not associate with neither ZrO₂ nor boehmite. So, assuming this crystal was superficially formed over the underlying ZrO₂, the resulting atomic ratios without oxygen are as follows, Al/Na=2.8, Si/Na=5.2, and Al/Si=0.5. Hence, this crystal may be paragonite [NaAl₂(Si₃Al)O₁₀(OH)₂] having atomic ratios of Al/Na=3, Si/Na=3.0, and Al/Si=1.0.

TABLE 8A
Elemental Analysis for Sample Location 1 in FIG. 36

| Element | Wt % | Wt % Sigma | Atomic % |
|---|---|---|---|
| O | 25.67 | 0.49 | 55.59 |
| Na | 1.67 | 0.14 | 2.52 |
| Al | 5.44 | 0.14 | 6.99 |
| Si | 10.56 | 0.19 | 13.03 |
| Ca | 0.70 | 0.15 | 0.60 |
| Zr | 55.96 | 0.50 | 21.26 |
| Total | 100.00 | | 100.00 |

TABLE 8B
Comparison of Sample Location 1 in FIG. 36 and Paragonite

| Atomic Ratio | Location 1 | Paragonite |
|---|---|---|
| Al/Na | 2.8 | 3.0 |
| Si/Na | 5.2 | 3.0 |
| Al/Si | 0.5 | 1.0 |

For the post-7 day exposed 10% Zr cement (FIG. 37), the EDX atomic % of aggregated crystals (in squire area) precipitated in crossly proximity to boehmite indicated three major atoms, O, Al, and Si and two minors, Na and Zr. Assuming most of two major atoms, O and Al, are implicated in boehmite, the atomic rates of rest atoms were Na/Zr=0.60, Si/Zr=2.6, and Si/Na=4.4. The atomic ratios of vlasovite (Na₂ZrSi₄O₁₁) are Na/Zr=2.0, Si/Zr=4.0, and Si/Na=2.0. Thus, although Na content of aggregated crystals was much smaller than that of vlasovite, conceivably, they are likely to be poorly formed vlasovite.

TABLE 9A
Elemental Analysis for Sample Location 1 in FIG. 37

| Element | Wt % | Wt % Sigma | Atomic % |
|---|---|---|---|
| O | 38.98 | 0.46 | 58.21 |
| Na | 2.94 | 0.15 | 3.05 |
| Al | 22.88 | 0.25 | 20.25 |
| Si | 15.74 | 0.22 | 13.39 |
| Zr | 19.47 | 0.45 | 5.10 |
| Total | 100.00 | | 100.00 |

TABLE 9B
Comparison of Sample Location 1 in FIG. 37 and Vlasovite

| Atomic Ratio | Location 1 | Vlasovite |
|---|---|---|
| Na/Zr | 0.6 | 2.0 |
| Si/Zr | 2.6 | 4.0 |
| Si/Na | 4.4 | 2.0 |

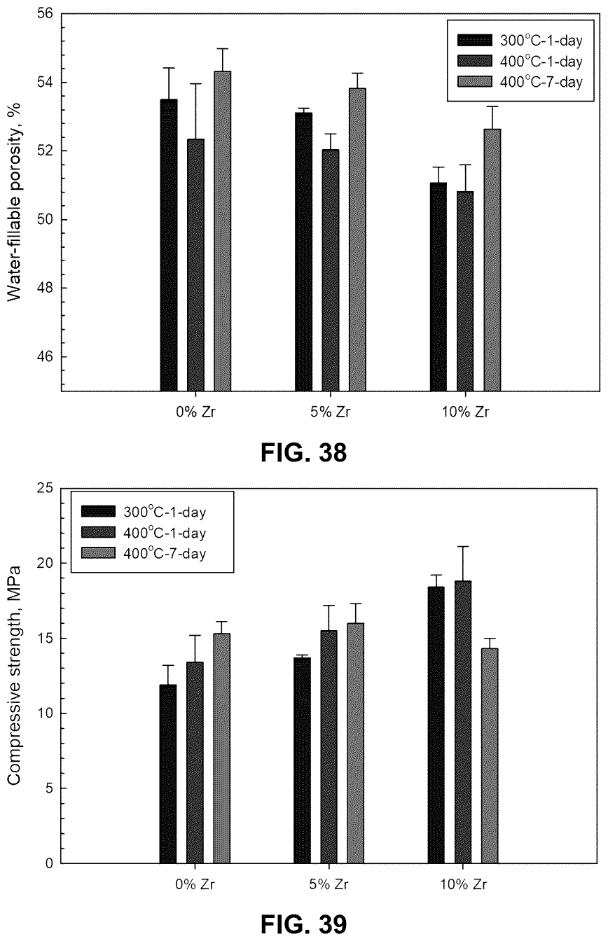

Mechanical and Physical Properties: Water-Fillable Porosity. FIG. 38 exhibits the water-fillable porosity for water-saturated samples after exposure in 300° C. autoclave and 400° C. scH₂O. The porosity of 300° C.-1-day-aged sample was 53.5%. This porosity declines with adding Zr to 53.1 for 5% and 51.1 for 10%, suggesting that Zr filler acts to densify the cement. Compared with 300° C. samples, the 400° C.-1-day-aged samples indicated a lowering of porosity in range of 52.4 to 50.8% as well as similar downward trend to reducing porosity with increasing Zr content. In contrast, all samples after 400° C.-7-day exposure showed the increase in porosity over the 300° C. and 400° C.-1-day samples to 54.3, 53.8, and 52.6% for Zr free, 5% Zr, and 10% Zr, respectively. Although averaged increasing rate of 3.5% was not significant, the major reason for such increasing may be due to the crystal structural transformation of analcime (zeolite)→paragonite (mica) in 400° C.-7-day exposure. Such a transformation between the different mineral groups might affect for the development of porous structure. Furthermore, the lowest increasing rate of 10% Zr may come from the existence of a certain amount of unreacted Zr fillers and the formation of vlasovite responding to the creation of densified structure. On the other hand, it is possible to rationalize that zeolite→zeolite structural transformation like harmotome→analcime after 400° C.-1-day exposure in same mineral family does not affect for an undesirable alteration toward porous structure. In fact, harmotome→analcime phase transition served in providing a reduced porosity. However, there is unknown as to whether the porosity, ranging from ˜50 to ˜54%, is acceptable as scGWC.

Mechanical and Physical Properties: Compressive Strength. FIG. 39 depicts the changes in compressive strength for samples after exposure in 300° C. autoclave and 400° C. scH₂O. As seen in figure, excepting 10% Zr sample after 7-day scH₂O exposure, the strength of all other samples tends to rise with increasing Zr contents and extended scH₂O exposure time to 7 days. In the viewpoint of increased strength, the compressive strength seems to be dependent on phase composition, but not independent on the porosity in narrow range of 53.5 to 50.8%. As to the effectiveness of phase composition in improving strength, the ranking of best composition system is as follows, boehmite and paragonite combination as major phases>boehmite as major and analcime as minor>boehmite as major and analcime and harmotome as minor. The highest compressive strength of 18.8 MPa was obtained from 10% Zr sample made in 1-day scH₂O. However, this strength value decreased by ˜24% to 14.3 MPa after extending exposure of 7 days. Since there is no strength reduction for 5% Zr, the reason for declined strength of 10% Zr may be the formation of excessive vlasovite, but there is no experiment evidence. Nevertheless, Zr as alkali-reactive filler appears to contribute to the strength improvement of cement.

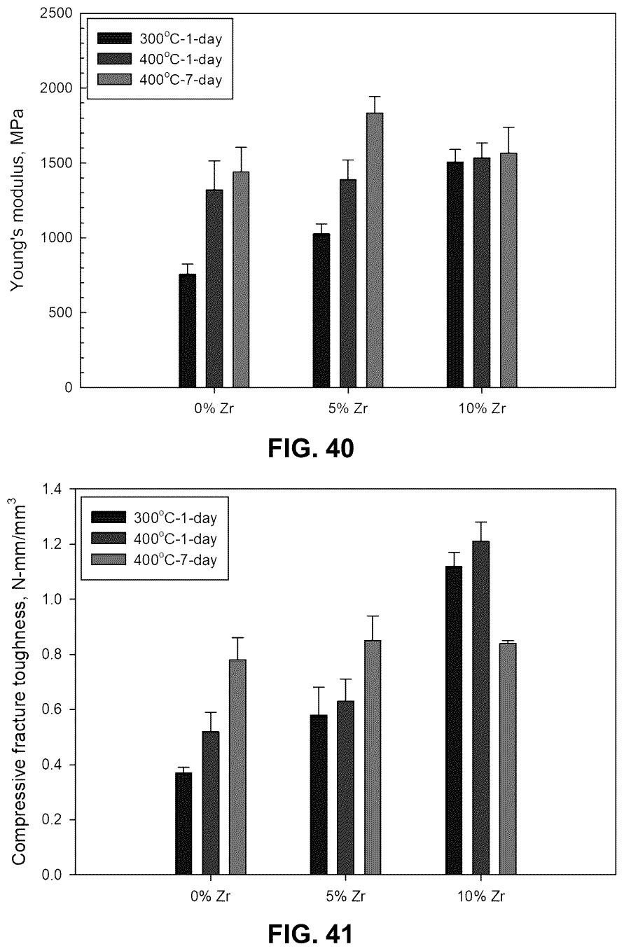

Mechanical and Physical Properties: Young's Modulus. FIG. 40 represents the resulting young's modulus referring to stiffness behavior of cements. In a previous study on self-healing geothermal well cements, the stiffness behaviors were classified in three categories, 1) over stiffness called as hard brittleness, 2) moderate stiffness, and 3) lack stiffness defined as soft, in a wide modulus region from as high as 500×10³ psi (3447 MPa) to as low as 50×10³ psi (345 MPa). As a result, the classification was as follows: the over stiffness (hard brittleness)>2068 MPa, ideal moderate stiffness in range of 2068 to 690 MPa, and lack stiffness<690 MPa. The data revealed the ideal moderate stiffness for all tested samples. The data also showed that the extending scH₂O exposure to 7 days offered the improved stiffness for all samples. The mostly improved stiffness of 1833 MPa was 5% Zr sample, corresponding to 22% and 15% higher than 0% Zr and 10% Zr, respectively, for same 7 days exposure samples. Interestingly, 10% Zr samples provided a great average stiffness under three different exposure conditions. Thus, Zr filler not only was responsible for strengthening cement, but also offered improved stiffness.

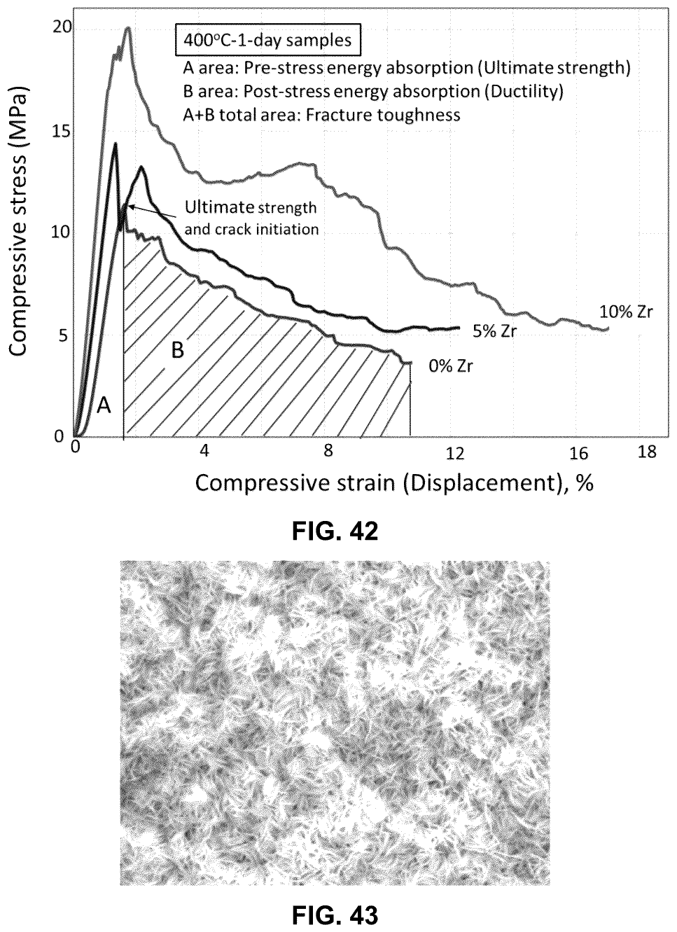

Mechanical and Physical Properties: Compressive Fracture Toughness. FIG. 41 illustrates the compressive fracture toughness referring to the combination of ultimate strength and ductility for 0, 5, and 10% Zr samples. For Zr-free samples, the 0.37 N-mm/mm³ toughness of 300° C. sample was enhanced in scH₂O; in fact, this value increased by ˜1.6- and ˜3.0-fold after 1- and 7-day exposure, respectively. Similarly, 300° C. 5% Zr samples exhibited toughness enhancement with extended scH₂O exposure. Most impressed toughness as 1.12 and 1.21 N-mm/mm³ was observed from 10% Zr samples after 300° C.- and 400° C.-1-day exposures. However, like compressive strength, the extended exposure to 7 days engendered the lowering of toughness because an excellent toughness comes from the combination of high ultimate compressive strength and good ductility. Hence, similar statement to compressive strength results can be described: Adequate content of Zr like 5% exerted the improved toughness on cement, whereas the formation of excessive vlasovite by 10% Zr engendered the reduction of toughness. Nevertheless, FIG. 42 illustrates the toughness measurement and comparison between features of compressive stress (MPa)-compressive strain (%) relation curves for 1-day-scH₂O-exposed 0, 5, and 10% Zr samples. As seen in the figure, a good compressive fracture toughness appeared to be due to a good combination of ultimate strength and ductility.

### CONCLUSIONS

The cementitious materials consisting of boehmite as major phase and zeolites, harmotome and analcime, as minor ones were hydrothermally synthesized at 300° C. by using the starting materials including gibbsite cement, sodium metasilicate (SMS) as alkali activator, silica flour as filler, and with and without hydrous zirconium oxide (Zr) as reactive filler of 5 and 10% for evaluating the potentials as supercritical geothermal well cements (scGWC) withstanding in supercritical water (scH₂O) at 400° C. and 24.1 MPa pressure. In any phase transitions, first, the boehmite was induced from alkali dissolution of gibbsite, while zeolites were precipitated by hydrothermal interactions between Al(OH)₄ from gibbsite and Na⁺ and SiO₂(OH)₂⁻² from SMS. The factors to be evaluated included thermal stability, porosity, and mechanical properties like compressive strength, young's modulus (stiffness), and compressive fracture toughness for 300° C.-synthesized cements after a short-term scH₂O exposure of 1 and 7 days. All these properties obtained were correlated directly with crystal phase-composition and -transition and crystal structural transformation occurring for a duration of scH₂O exposure. Harmotome→analcime phase transition took place after 1 day exposure in scH₂O exposure, reflecting the phase composition of boehmite as major and analcime as minor. No reaction product of Zr was found in 1-day-exposure cements. Extended exposure to 7 days led to the analcime (zeolite)→paragonite (mica) phase transition as well as crystal structural transformation from the zeolite mineral to mica mineral. The phase composition in this cement was comprised of two major phases, boehmite and paragonite. Furthermore, anhydrous vlasovite crystal as in-situ supercritical hydrothermal synthesis product (scHSP) of Zr was formed as minor phase. Additionally, the pozzolanic activity of silica flour filler as pozzolan with alkalis, Na⁺, Al(OH)₄⁻, and OH⁻ liberated from alkali dissolution of gibbsite and hydrolysis of SMS was minimum in this cement system.

Based upon the information above, the thermal stability of cements depended primary on hydrated (H₂O) and hydroxylated (OH) phases. Since the first thermal degradations in these phases come from the elimination of (H₂O)ₓ as dehydration and OH groups as dehydroxylation, the OH-incorporated crystalline phases like boehmite and paragonite had a far better thermal stability rather than H₂O-incorporated phases like zeolites in scH₂O, thereby resulting in lower mass loss and preventing mechanical distortion of crystal structure by dehydration. The presence of highly thermal stable anhydrous vlasovite further improved the thermal stability of boehmite/paragonite-based cement. As a result, 10% Zr-modified cement after exposure for 7 days in scH₂O exhibited onset decomposition at 510° C. and peak decomposition at 537° C. Thus, this cement appears to possess excellent thermal stability. On the other hand, the structural transformation between different mineral families like analcime (zeolite)→paragonite (mica) engendered the increase in water-fillable porosity although averaged rate of increasing porosity is only 3.5%. In contrast, the boehmite/analcime-based cements with and without Zr yielded in 1-day scH₂O exposure had a lower porosity than boehmite/analcime/harmotome-based cements formed at 300° C. The porosity for all cements was in the range of ˜50 to ˜54%, raising concern as to whether this porosity range is acceptable as scGWC. As for the compressive strength, there are two factors contributing to strength improvement: One was relevant to phase composition, the other was Zr contents. For the former, the ranking of effective phase compositions in improving strength was as follow: boehmite and paragonite as major phases>boehmite as major and analcime as minor>boehmite as major and analcime and harmotome as minors. However, the declining strength of 10% Zr cement assembled in 7-day scH₂O exposure may be due to the excessing vlasovite precipitations. For the latter, the strength was dependent on Zr contents, but not independent on the porosity in such narrow range of 53.5 to 50.8%. Thus, the upward trend of strength with increasing Zr contents can be seen, suggesting that the chemically reacted or unreacted Zr fillers are responsible for strengthening cements. Since 5% Zr cement also yields vlasovite, the 5% may be adequate amount leading to moderate formation of vlasovite for avoiding any strength reductions. For young's modulus referring to stiffness behavior, the extent of stiffness for all cements with and without Zr assembled at 300° C. was enhanced with a prolonged exposure time in scH₂O. The cements containing Zr had a better stiffness over the Zr-free ones. Regarding the compressive fracture toughness referring to the combination of ultimate compressive strength and ductility, like compressive strength, the fracture toughness was primarily governed by two factors, phase composition and Zr content. For the latter factor, the incorporation of 10% Zr offered a great fracture toughness of 1.12 N-mm/mm³ on 300° C.-autocalved cement, corresponding to 3.0- and 1.9-fold higher than that of Zr-free and 5% Zr cements autoclaved at same temperature. Furthermore, a further improved toughness of 1.21 N-mm/mm³ was observed from 10% Zr cement after 1-day scH₂O exposure, despite the extended exposure to 7 days engendered the decline of toughness. This declined toughness value of 0.84 N-mm/mm³ was still higher than that of 7-day-exposed Zr-free cement, suggesting that Zr appeared to serve in improving the toughness as wall, thereby leading to delaying and suppressing the propagation of cracks. Nevertheless, there are remain some concerns about the integrity and reliability as scGWC encompassing advanced phase-transition and -stabilization, and alteration of porous microstructure to densified one for a duration of long-term scH₂O exposure.

Finally, regarding the alternative resources of gibbsite, the bayerite, Al(OH)₃, as by-product precipitated in hydrogen (H₂) energy production brought about by aluminum-water reactions, 2Al+6H₂O=2Al(OH)₃+3H₂ may be applicable.

### Example 3: Calcium-Free Supercritical Cement Compositions

### General Approach

Cement formulations should have a compressive strength of no less than 1000 psi after 24 h under supercritical conditions with minimal volumetric expansion. Formulations should have an increase in water-fillable porosity of no more than 3% after 24 h of super critical curing. Formulations should experience a minimum number of phase transitions that affect mechanical properties, with a phase composition comparable to that found under natural supercritical conditions to be long-term stable. Aluminum presence was desirable for (1) high temperature and acid stability, (2) favorable casing-cement interactions in geothermal wells, (3) better heat conductivity, and (4) formation of target phases that should be stable under supercritical conditions (e.g. anorthite, dmisteinbergite, boehmite, and/or mica-type minerals).

### Rapture Disk Studies

A Hastelloy rapture disk was covered with Si-rich scale after a 7-day exposure to pure water (FIG. 43). Elemental analysis is shown in Table 10:

TABLE 10
Elemental Analysis of Rapture Disk
Surface, 7-Day Water Exposure

| Element | Wt % | Atomic % |
|---|---|---|
| O | 32.66 | 57.42 |
| Al | 1.35 | 1.40 |
| Si | 17.81 | 17.84 |
| Cr | 2.77 | 1.50 |
| Fe | 3.47 | 1.75 |
| Ni | 41.93 | 20.09 |
| Total | 100.00 | 100.00 |

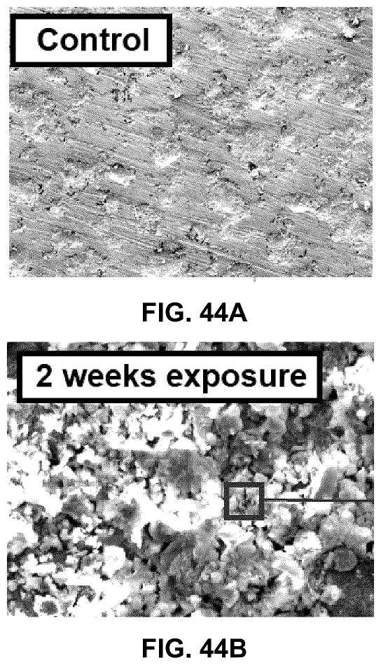

Comparative SEM images for a Ni-alloy cement sample are shown in FIG. 44A (control) and FIG. 44B (sample after two weeks of exposure in supercritical conditions). Elemental analysis is shown in Tables 11A-11B:

TABLE 11A
Elemental Analysis of Rapture Disk
Surface, Ni Alloy Sample, Control

| Element | Wt % | Atomic % |
|---|---|---|
| Cr | 12.64 | 15.52 |
| Ni | 66.30 | 72.07 |
| Mo | 16.03 | 10.66 |
| W | 5.03 | 1.75 |

TABLE 11B
Elemental Analysis of Rapture Disk Surface, Ni
Alloy Sample, 14 Days Supercritical Exposure

| Element | Wt % | Atomic % |
|---|---|---|
| C | 19.34 | 35.91 |
| O | 24.49 | 34.13 |
| Na | 1.19 | 1.15 |
| Al | 4.52 | 3.73 |
| Si | 13.31 | 10.57 |
| P | 0.16 | 0.12 |
| Ca | 1.23 | 0.68 |
| Cr | 2.52 | 1.08 |
| Fe | 0.40 | 0.16 |
| Ni | 32.85 | 12.47 |

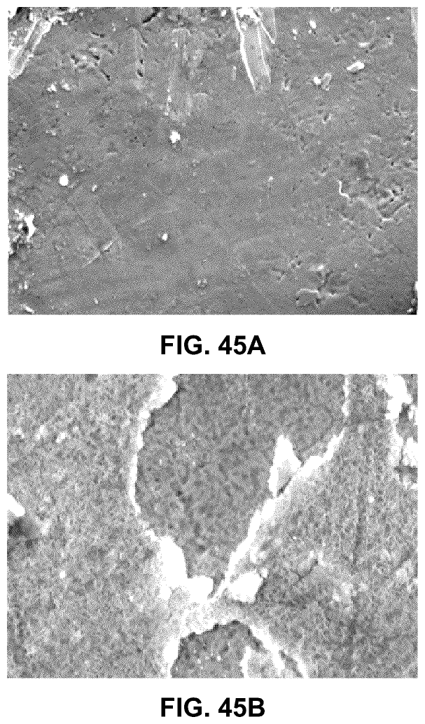

Comparative SEM images for a second Ni-alloy cement sample are shown in FIG. 45A (control) and FIG. 45B (sample after two weeks of exposure in supercritical conditions). Elemental analysis is shown in Tables 12A-12B:

TABLE 12A
Elemental Analysis of Rapture Disk Surface,
Second Ni Alloy Sample, Control

| Element | Wt % | Atomic % |
|---|---|---|
| C | 14.99 | 47.47 |
| Al | 1.27 | 1.79 |
| Cr | 13.44 | 9.83 |
| Fe | 2.29 | 1.56 |
| Ni | 52.02 | 33.7 |
| Mo | 12.42 | 4.92 |
| W | 3.57 | 0.74 |

TABLE 12B
Elemental Analysis of Rapture Disk Surface, Second
Ni Alloy Sample, 14 Days Supercritical Exposure

| Element | Wt % | Atomic % |
|---|---|---|
| O | 33.02 | 58.52 |
| Al | 1.07 | 1.12 |
| Si | 16.82 | 16.98 |
| Cr | 8.58 | 4.68 |
| Fe | 1.40 | 0.71 |
| Ni | 34.35 | 16.59 |
| Mo | 4.77 | 1.41 |

### Mechanical Properties or Ordinary Portland Cement (OPC) Based Systems

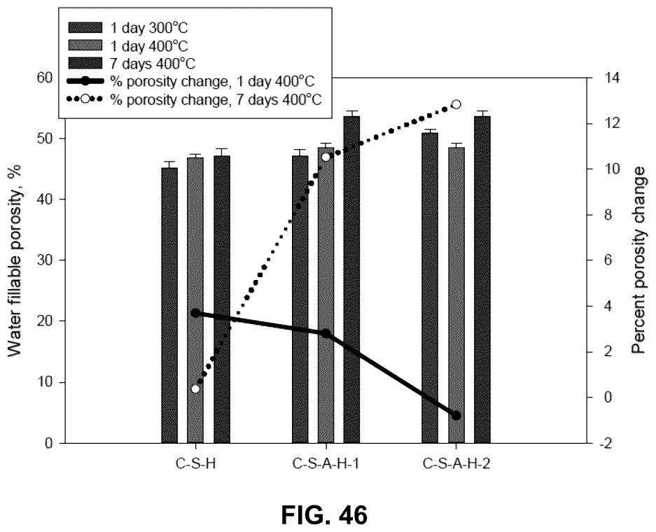

C—S—H is a control high temperature OPC formulation while C-S-A-H-1 and C-S-A-H-2 are OPC modified with metakaolin (MK). C represents calcium, S represents SiO₂, A represents Al, and H represents water. FIG. 46 shows water fillable porosity and changes thereto based on different formulations. The porosity increase was 0.4% for control formulations without metakaolin, while it was 10.5% and 12%, respectively, for two tested metakaolin concentrations after 7 days under supercritical conditions. The addition of metakaolin that increases water demand to obtain similarly leveling slurries is not favorable for OPC-based composites. After a short hydrothermal curing at 400° C., metakaolin additions cause dramatic increases in the porosity of the cement.

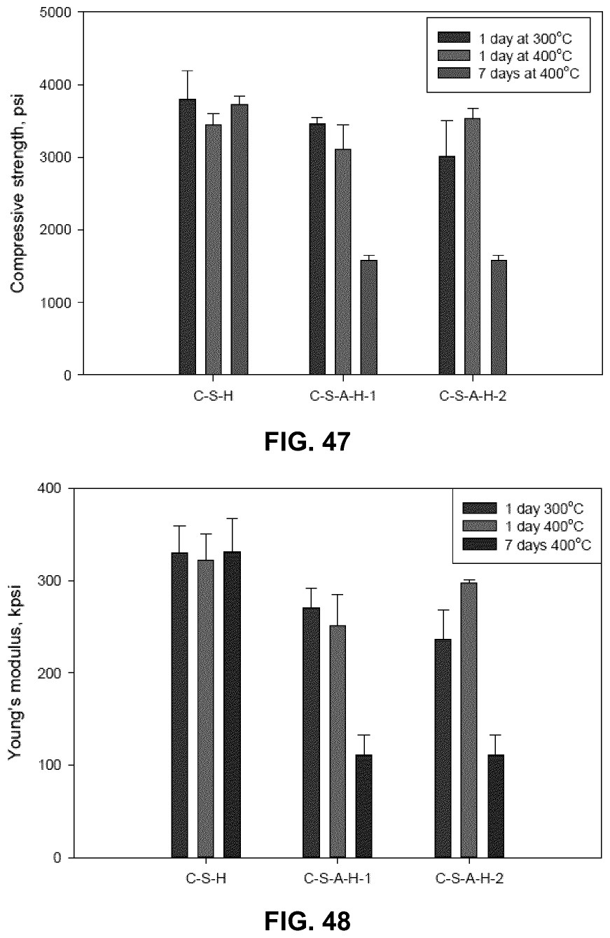

FIGS. 47-48 show, respectively, compressive strength and Young's modulus for the same formulations as described in FIG. 46. Compressive strength and Young's modulus remained relatively stable after 7 days of curing under supercritical environments for control formulations, but compositions modified with metakaolin showed significant degradation of mechanical properties after the same exposure.

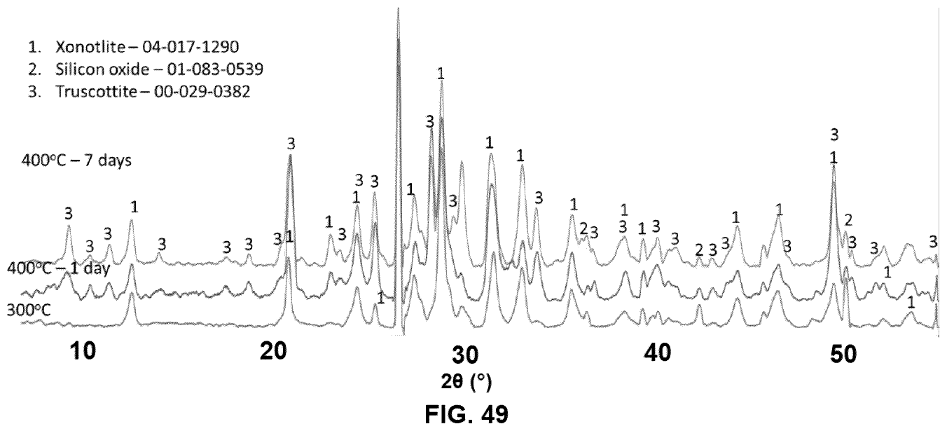

In OPC-based systems, there are noticeable changes in the XRD patterns as temperature and exposure time increase, indicating phase changes (FIG. 49). Silica is still present at 300° C. but disappears after supercritical curing, while xonotlite persists (FIG. 2). A new calcium silicate (truscottite) forms after 7 days at 400° C. Furthermore, the morphology of the xonotlite changes after a longer exposure at 400° C., with the size of needles increasing, likely causing an increase in cement porosity. Silica crystal disappearance also causes increased porosity after longer supercritical curing.

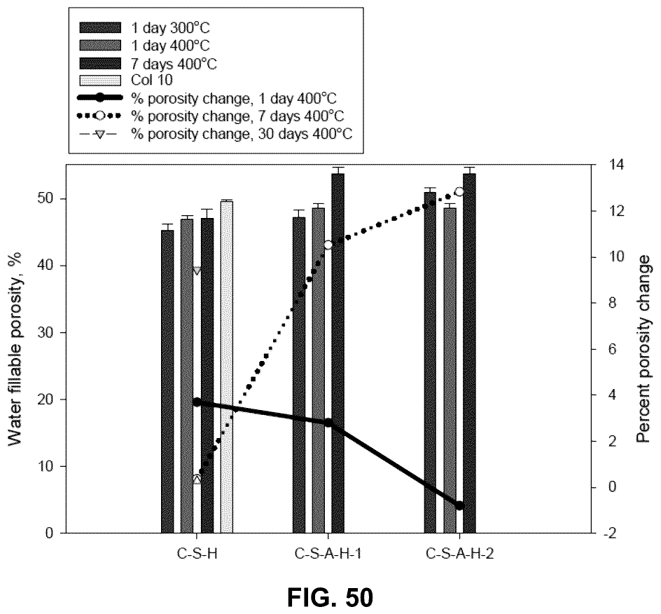

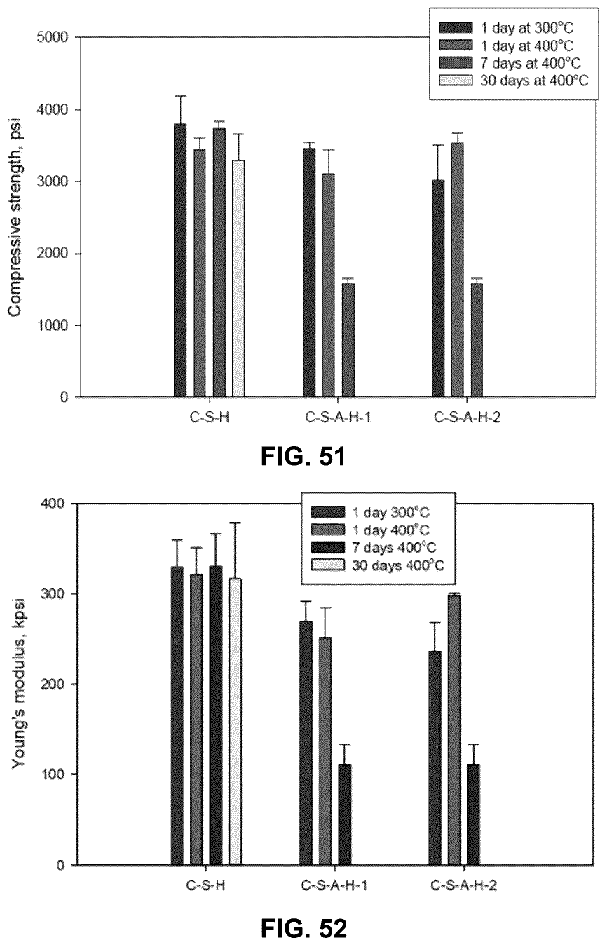

Porosity of this system increases by more than 9% after 30 days of supercritical exposure (FIG. 50). Compressive strength and Young's modulus decline after the same period of time (FIGS. 51-52, respectively).

### Mechanical Properties of Calcium Aluminate Cement (CAC) Based Systems

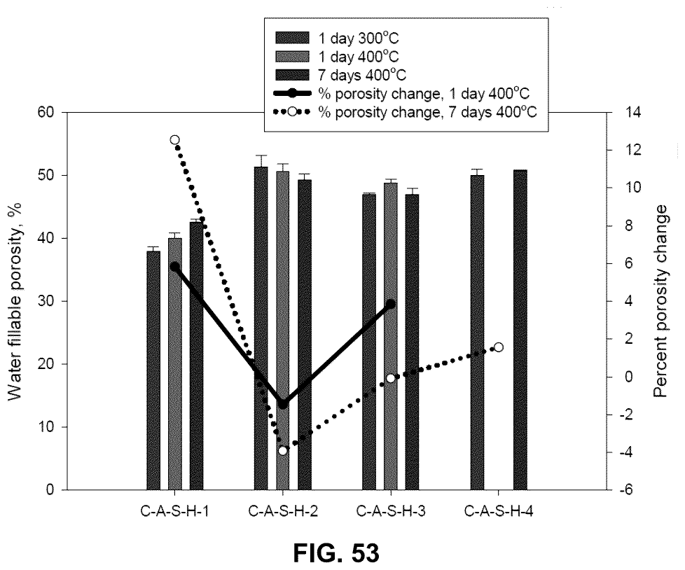

C-A-S-H-1 and C-A-S-H-3 are different grades of CAC, while C-A-S-H-2 and C-A-S-H-4 are those same grades, respectively, modified with MK. In these experiments, different grades of CAC perform differently, with a first CAC added to silica experiencing increased porosity after supercritical curing, while a second CAC added to silica having stable porosity (FIG. 53). Addition of MK could be beneficial for the first grade (porosity decreases) but not for the second grade (stable but higher porosity than for non-modified blends).

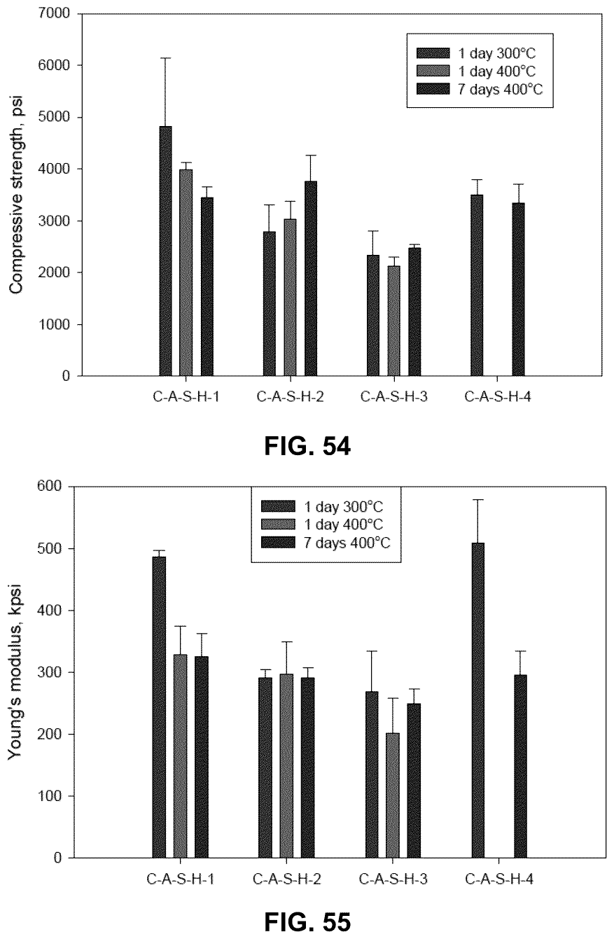

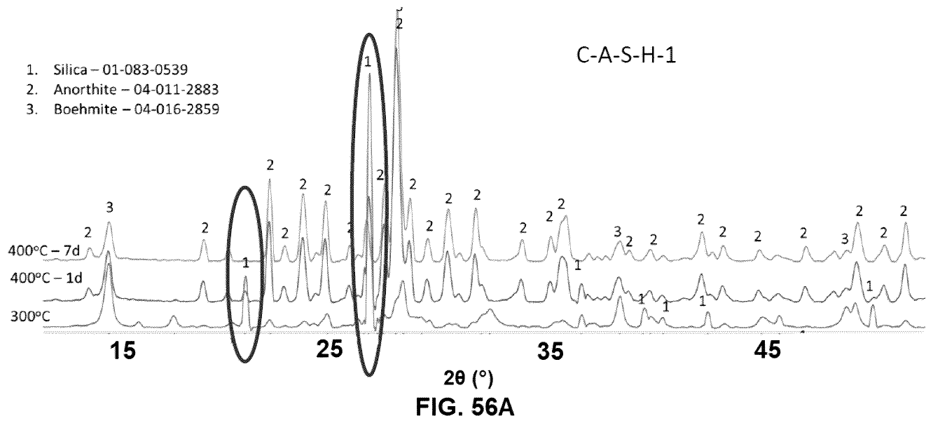

Compressive strength and Young's modulus for these samples are shown in FIGS. 54-55, respectively. Very high compressive strength (>4000 psi) was reached by C-A-S-H-1, but this decreased by 28% as the porosity of the cement increased with supercritical exposure. When this formulation was modified with MK, the trend reversed, with the strength increasing after the 400° C., reaching nearly 4000 psi after the 7 day exposure. Despite the strength increase, the modulus of the MK-modified sample (C-A-S-H-2) persisted around 300 kpsi, indicative of the moderate fracture nature that is preferable to a brittle material. Strength of the second formulation (samples C-A-S-H-3 and -4) persisted around 2000 psi throughout the testing. The high modulus (>500 kpsi) measured after 300° C. dropped to the desirable region of moderate fracture failure after 7 days at 400° C.

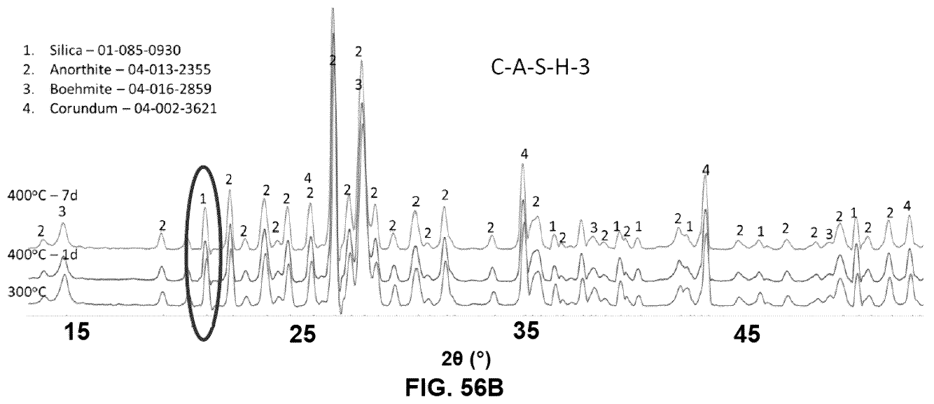

XRD analysis of C-A-S-H-1 and C-A-S-H-3 is presented in FIGS. 56A-56B, respectively. C-A-S-H-1 shows a simple composition of desirable crystalline hydration products, anorthite and boehmite. A sharp decrease in quartz is observed after 400° C. curing. Quartz reactions under supercritical conditions result in porosity increases, but the supercritical reactions of quartz depend on the grade of CAC. Phase stabilization may occur after all the quartz in the system has reacted.

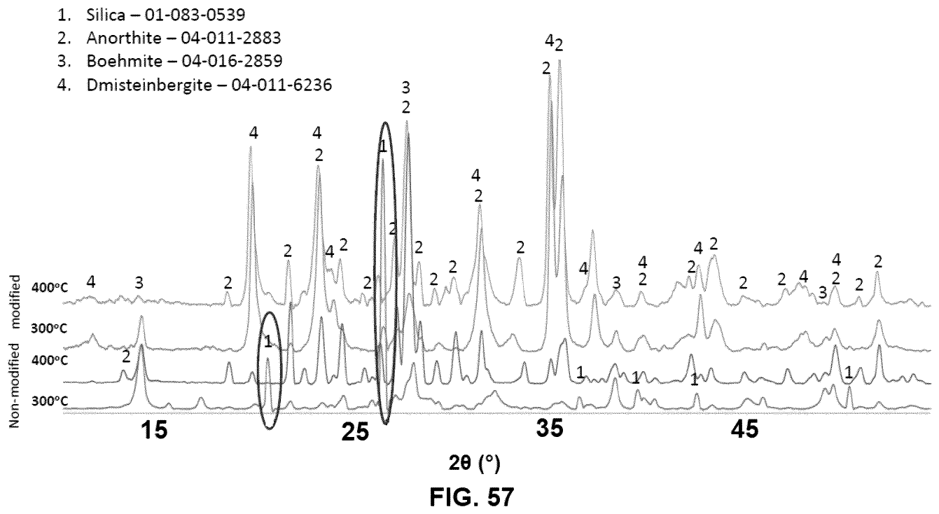

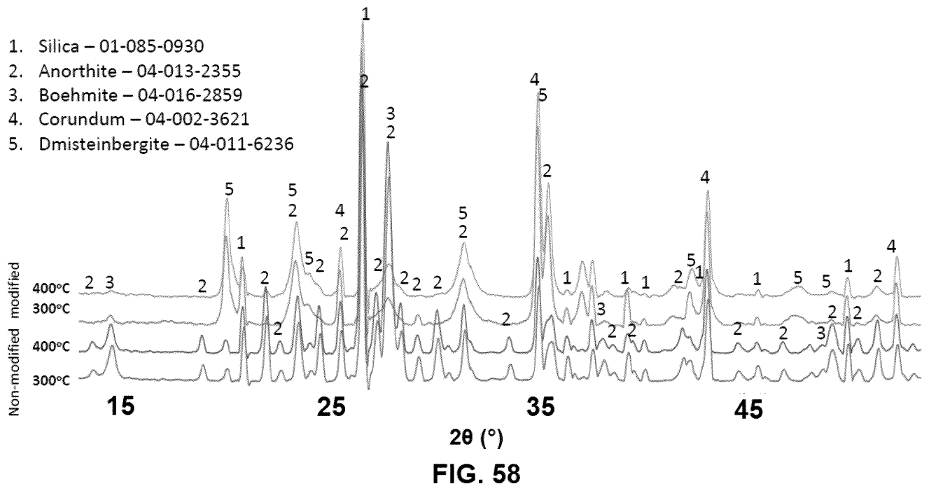

Effects of modifications of formulations with reactive silica-aluminate in formulations with different CAC grades is seen in FIG. 57 (C-A-S-H-1 and -2) and FIG. 58 (C-A-S-H-3 and -4). Modification with MK resulted in increased Si reactivity, with peaks disappearing at 300° C. and preferential formation of a kinetically-favorable isomorph of anorthite (dmisteinbergite) and destabilization of boehmite for C-A-S-H-1/2. For C-A-S-H-3/4, similar results were observed, although Si reactivity did not increase as much as for the C-A-S-H-1/2 modification.

### Mechanical Properties of Calcium Phosphate Cement (CAP) Systems

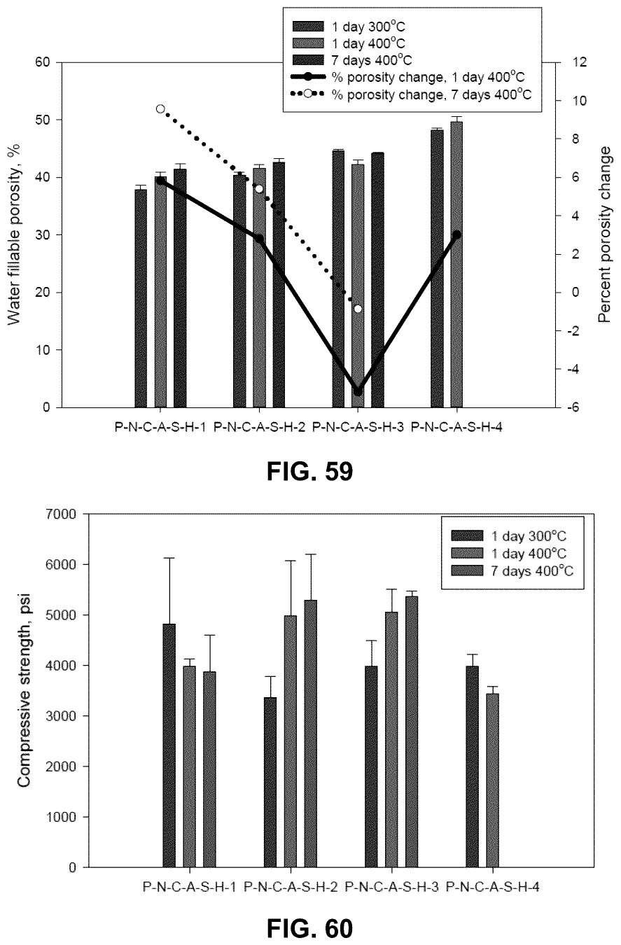

P-N-C-A-S-H-1 is a CAP chemical cement not modified with MK, where P represents phosphorus and N represents sodium, and other abbreviations are described above. Porosity of CAP slurries was, on average, 9% below that of other systems because of lower water demand with the dispersing effect of sodium hexametaphosphate. Porosity increased for all CAP cement formulations except one after supercritical curing (FIG. 59). When modified with the appropriate MK concentration, water fillable porosity of CAP cement persisted through the supercritical curing (P-N-C-A-S-H-3), slightly decreasing (1%) compared to the cement after 300° C. exposure.

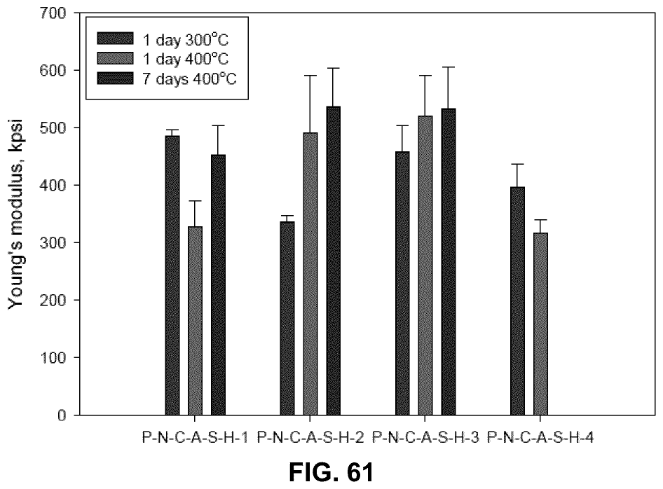

Compressive strength and Young's modulus for these systems are shown in FIGS. 60-61, respectively. The strength of the non-modified formulation decreased after the initial supercritical exposure for 1 day but was stable after a longer 7-day during period, remaining high at 3900 psi. The strength of the CAP cement formulations modified with MK (Formulations 2 and 3 in FIGS. 59-61) increased successively with 1 and 7 days of supercritical exposure to above 5000 psi for both formulations. For MK-modified cement, the Young's modulus mirrored compressive strength trends. The modulus values above 500 kpsi for MK-modified cement indicate brittle failure mode of the samples.

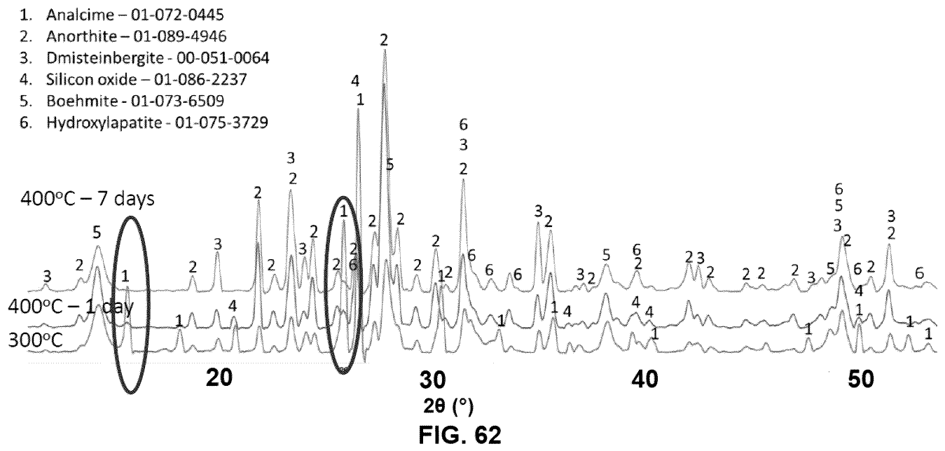

SEM images of these systems are seen in FIG. 6. XRD analysis (FIG. 62) shows desirable crystalline phases form after 7 days under supercritical conditions (anorthite, hydroxyapatite, dmisteinbergite, boehmite). Analcime that forms at 300° C. disappears after supercritical curing. This undesirable phase transition results in increased porosity and decreased strength after the supercritical curing. The dense matrix morphology comes from the small crystal size and low initial water content.

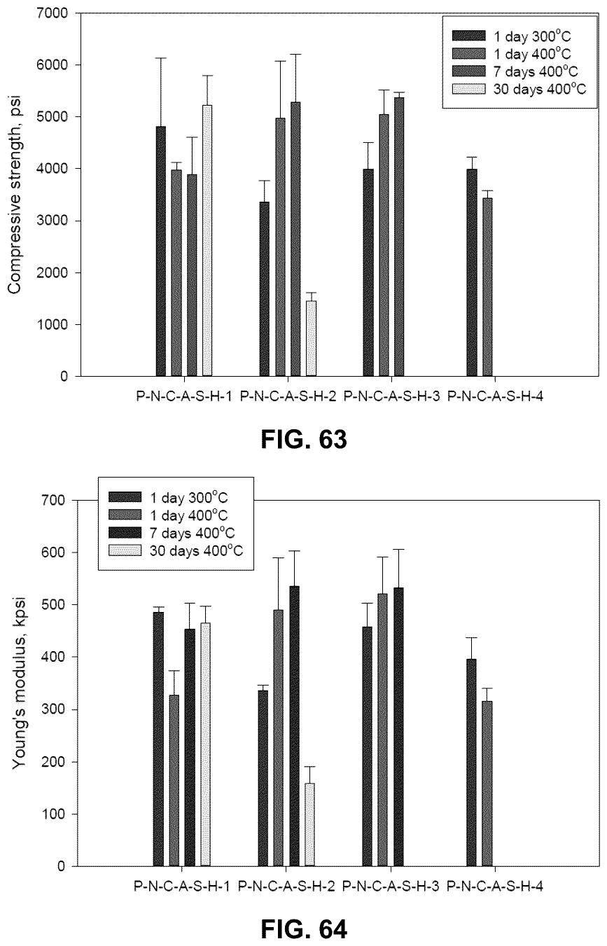

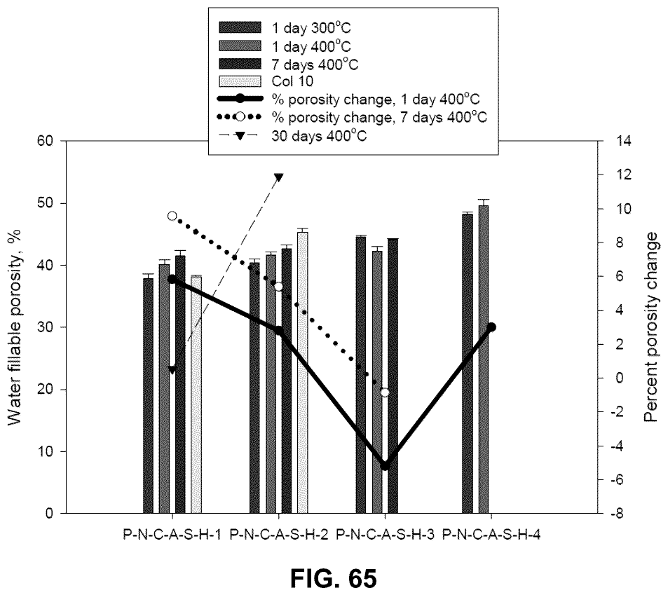

Compressive strength and Young's modulus after 30 days in CAP-based systems are shown in FIGS. 63-64, respectively. Good performance of non-modified cement and dramatic deterioration of mechanical properties in the presence of reactive aluminum silicate are observed. Water fillable porosity is shown in FIG. 65. Decreased porosity of nonmodified cement and increased porosity of the MK-modified cement after 30 days under supercritical conditions is observed.

### Physical Properties of Al-Based Systems (Ca-Free)

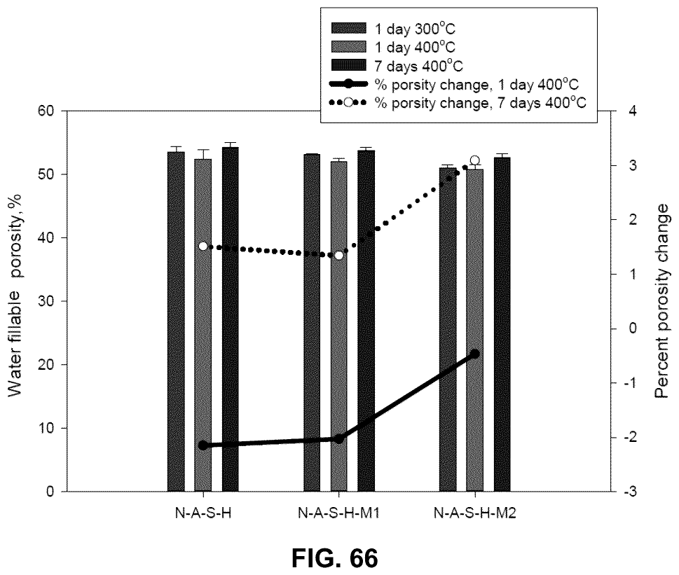

N-A-S-H samples are calcium free, aluminum based cement systems, with samples N-A-S-H-M1 and -M2 being the original system doped with a transition metal. Porosity is shown in FIG. 66. The porosity of the metal doped samples was lower than for formulations without metal (about 4.6% lower porosity for the M2 formulation compared to the control). For all calcium-free, aluminum-based systems, porosity persisted through supercritical exposure with some decrease after the first day and a minor increase after 7 days of supercritical curing.

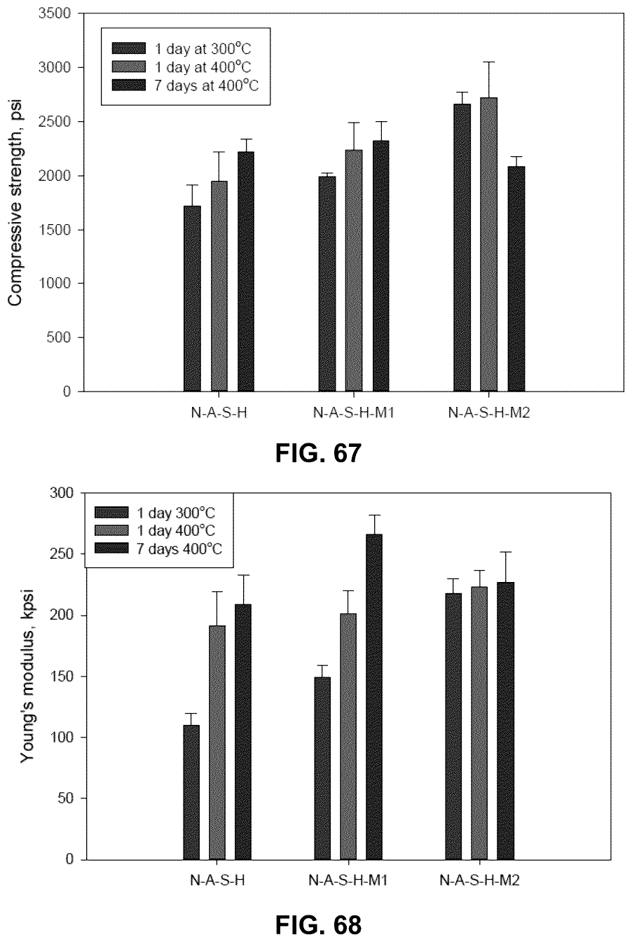

Compressive strength and Young's modulus are shown in FIGS. 67-68, respectively, for this system. Both the control and the M1 formulations increased in strength after the supercritical exposures (29% and 17% increases, respectively). The strength of the M2 formulation with higher metal doping initially increased after 1 day of supercritical curing but dropped after 7 days (2670 psi at 300° C. to 2720 PSI after 1 day at 400° C. to 2100 psi after 7 days at 400° C.). The Young's modulus of these formulations was desirable (about 200 kpsi), suggesting strong enough but not brittle cement properties. These formulations possessed outstanding toughness values having a good combination of strength and ductility between 0.84 and 0.89 N-mm/mm³. The toughness of the reference OPC-based system was 0.65, and the toughness of very high strength CAP formulations was between 0.35 and 0.67.

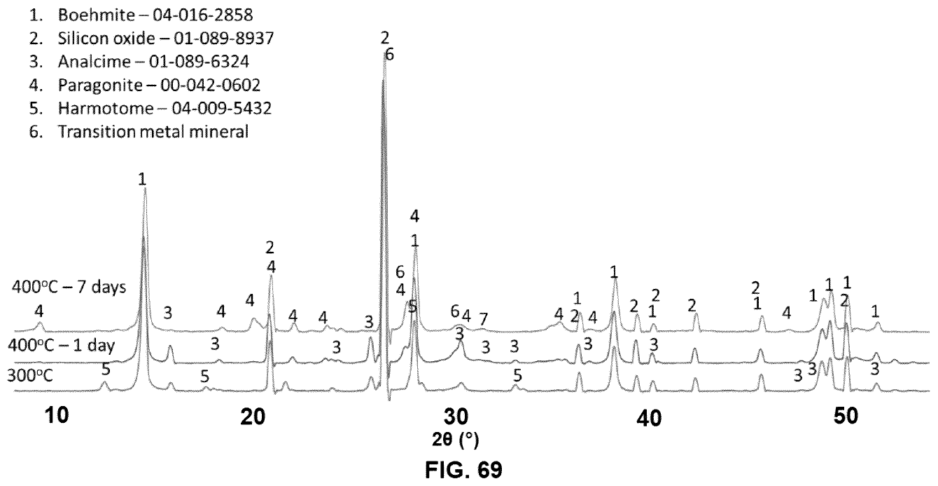

XRD analysis of Al-based system M1 is shown in FIG. 69, with corresponding SEM image in FIG. 36. Some transitions in crystalline composition during temperature increase visible in the XRD patterns do not result in significant porosity changes based on the porosity measurements. All three crystalline phases detected after the 7-day during at 400° C. are expected to be stable under supercritical conditions for extended periods of time. The morphology of the cement shows small crystals formed in a dense amorphous cement matrix rich in silica and aluminum. The numbered location has a composition typical for a high temperature stable mica-type phase paragonite.

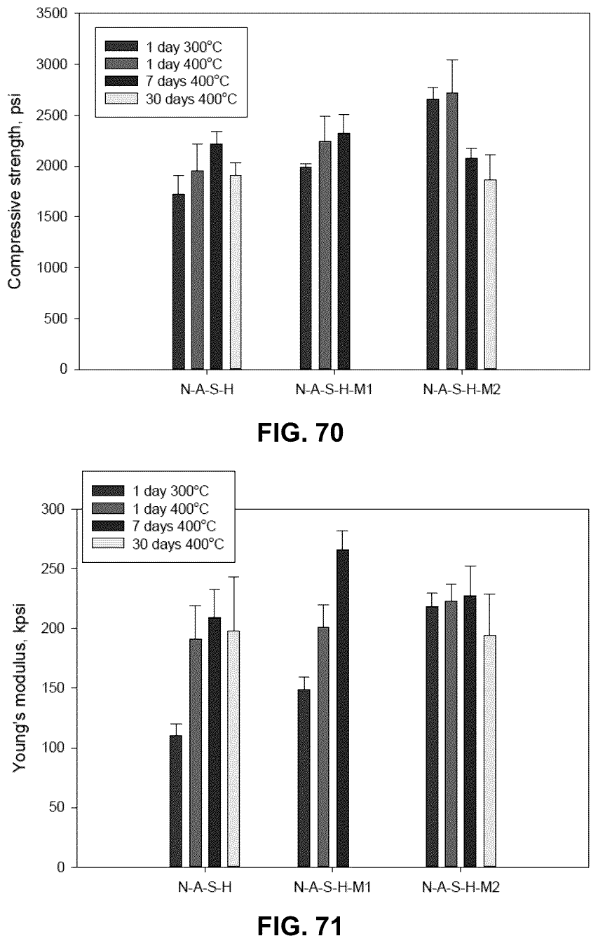

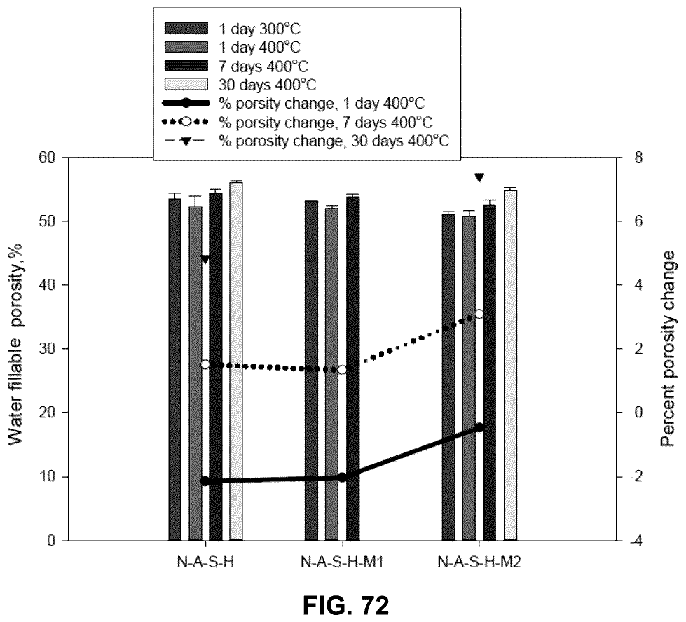

Compressive strength and Young's modulus after 30 days of supercritical exposure are seen in FIGS. 70-71, respectively. Some degradation of mechanical properties is observed over time. Porosity after 30 days under supercritical conditions for these samples is summarized in in FIG. 72. A slight increase is observed.

### Comparative Studies

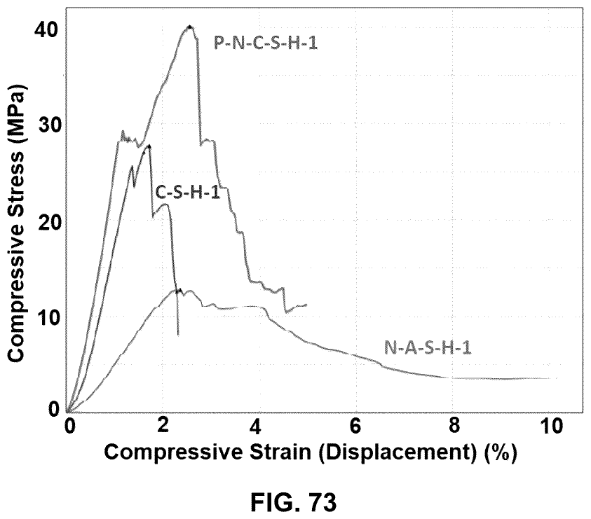

A typical stress-strain curve for selected formulations after 30-day supercritical curing is seen in FIG. 73. OPC is strong but brittle (>3000 psi, 21 MPa), phosphate cement is very strong but brittle (>5000 psi, 34 MPa), and aluminum cement is not strong and is ductile (2000 psi, 14 MPa).

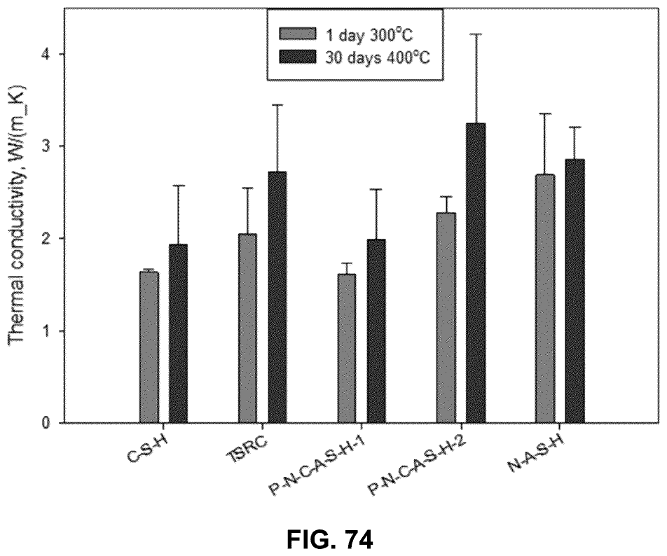

Thermal conductivity of supercritical cements after 1 day at 300° C. and 30 days at 400° C. is presented in FIG. 74. Generally, thermal conductivity is higher for aluminum-based cements. Thermal conductivity increases after longer exposure to supercritical conditions for most tested cements.

### SUMMARY

Several formulations met material requirements after 7 days of supercritical exposure. These include CAC-based hydraulic systems, CAC-based chemical cements with sodium hexametaphosphate, and calcium-free aluminum-based alkali activated cement. Phase characterizations allowed designing targeted modifications of the supercritical formulations to achieve desirable properties under the experimental conditions.

Performance of MK-modified CAC-based chemical cement with sodium hexametaphosphate degraded dramatically after 30 days of supercritical exposure; performance of OPC-based cement also degraded; some decrease in mechanical properties and increase of porosity was observed for aluminum-based cement.

Non-modified CAC-based chemical cement with sodium hexametaphosphate improved its mechanical properties and decreased in porosity after 30 days of exposure.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

1. Aja, S U et al: The aqueous geochemistry of Zr and the solubility of some Zr-bearing minerals. Applied Geochemistry 10 (1995) 603-620.
2. Allahdin, O et al: Hydroxylation and dealumination of a methakaolinite-rich brick under acid conditions, and their influence on metal adsorption: One- and two-dimensional (1H, 27Al, 23Na, 29Si) MAS NMR, and FTIR studies. Microporous and Mesoporous Materials 226 (2016) 360-368.
3. Arnorsson, S. et al: The chemistry of geothermal waters in Iceland. II. Mineral equilibria and independent variables controlling water compositions. Geochimica et Cosmochimica Acta 47 (1983) 547-566.
4. Asanuma, H., et al. Concept of development of supercritical geothermal resources in Japan. in International Conference on Geothermal Energy in Taiwan (2015).
5. Asanuma, H., et al. The concept of the Japan Beyond-Brittle project (JBBP) to develop EGS reservoirs in ductile zones. in GRC Transactions, Vol 36 (2012).
6. Bejar, A. et al: Mn-analcime: Synthesis characterization and application to cyclohexane oxidation. Microporous and Mesoporous Materials 196 (2014) 158-164.
7. Benezeth, P et al: Dissolution/precipitation kinetics of boehmite and gibbsite: Application of a pH-relaxation technique to study near-equilibrium rates. Geochimica et Cosmochimica Acta 72 (2008) 2429-2453.
8. Bignall, G. et al. A deep (5 km?) geothermal science drilling project for the Taupo Volcanic Zone-who wants in? in New Zealand Geothermal Workshop Proceedings (2011).
9. Bonneville, A., et al. Toward Super Hot EGS: The Newberry Deep Drilling Project. in GRC Transactions, Vol. 42 (2018).
10. Boumaza, A et al: Transition alumina phases induced by heat treatment of boehmite: An X-ray diffraction and infrared spectroscopy study. Journal of Solid Chemistry 182(2009) 1171-1176.
11. Boumaza, A. et al: Specific signatures of a-alumina powders prepared by calcimnation of boehmite or gibbsite. Powder Technology 201 (2010) 177-180.
12. Camilleri, J et al: Hydration characteristics of zirconium oxide replaced Portland cement for use as a root-end filling material. Dental Material 27 (2011) 845-854.
13. Cerrato, G et al: Surface characterization of monoclinic ZrO2 I. Morphology, FTIR spectral features, and computer modelling. Applied Surface Science 115 1997 53-65.
14. Chen, B et al: Transformation behavior of gibbsite to boehmite by steam-assisted synthesis. Journal of Solid State Chemistry 265 (2018) 237-243.
15. Chen, Y et al: Ultrahigh-strength alumina ceramic foams via gelation of foamed boehmite sol. Journal of American Ceramic Society 102 (2019) 5503-5513.
16. Chukanov, N V et al: Martinandresite, Ba2(Al4Si12O32)·10H2O, a new zeolite from Wasenalp, Switzerland. Physics and Chemistry of Minerals 45 (2018) 511-521 doi.org/10.1007/s00269-017-0938-6
17. Cruciani, G et al: Dehydration dynamics of analcime by in situ synchrotron powder diffraction. American Mineralogist 84 (1999) 112-119.
18. Currie, K L et al: The relative stability of elpidite and vlasovite: A-P-T indicator for peralkaline rocks. Canadian Mineralogist 23 (1985) 577-582.
19. Demichelis, R et al, Structure and stability of aluminium trihydroxides bayerite and gibbsite: A quantum mechanical ab initio study with the CRYSTAL06 code. Chemical Physics Letters 465 (2008) 220-225.
20. Dou, X et al: Remediating fluoride from water using hydrous zirconium oxide. Chemical Engineering Journal 198-199 (2012) 236-245.
21. Earnest, C M et al: Improve quantification of gibbsite in bauxite ores by thermogravimetric methods (TGA and DTG. Advances in Applied Chemistry and Biochemistry 1(2018) 9-17.
22. Egorova, S R et al: Formation of closed mesopores in boehmite during the phase transformation of gibbsite under hydrothermal conditions. Reaction Kinetics, Mechanisms and Catalysis 125 (2018) 873-885.
23. Elders, W. A., et al. Iceland deep drilling project: The first well, IDDP-1, drilled into magma. Geothermics 49, 1 (2014).
24. Ferraro, JR: Infrared absorption of sodium silicate glasses at high pressures. Journal of Applied Physics 43, 4595 (1972); doi.org/10.1063/1.1660971
25. Fidalgo, A et al: The defect structure of sol-gel-derived silica/polytetrahydrofuran hybrid films by FT-IR. Journal of Non-Crystalline Solids 283 (2001) 144-154.
26. Fridleifsson, G O et al: The concept of the Iceland deep drilling project. Geothermic 49 (2014) 2-8.
27. Fridleifsson, G O et al: The Iceland deep drilling project: A search for deep unconventional geothermal resources. Geothermic 34 (2005) 269-285.
28. Garrison, G. et al. Resource Potential of SuperHot Rock. in GRC Transactions, Vol 44 (2020) 1218-1227.
29. Ghobarkar, H et al: Effect of temperature on hydrothermal synthesis of analcime and viseite. Materials Science and Engineering B 60 (1999) 163-167.
30. Gobechiya, E R et al: New data on vlasovite: Refinement of the crystal structure and the radiation damage of the crystal during the X-ray diffraction experiment. Crystallography Reports 48 (2003) 750-754.
31. Hiraki, T et al: Hydrogen production from waste aluminum at different temperature, with LCA. Materials Transactions 46 (2005) 1052-1057.
32. Hoss, H et al: Zeolite studies Ill: On natural phillipsite, gismondite, harmotome, chabazite, and gmelinite. Beitrage zur Mineralogie und Petrographie 7 (1960) 389-408.
33. Hsiang, H-I et al, Preparation of superhydrophobic boehmite and anatase nanocomposite coating films: Material Research Bulletin 42 (2007) 420-427.
34. Huang, C et al: Differences between zirconium hydroxide (Zr(OH)4·nH2O) and hydrous zirconia (ZrO2·nH2O). Journal of American Ceramic Society 84 (2001) 1637-1638.
35. Husung, R. D. et al: The infrared transmission spectra of four silicate glasses before and after exposure to water. Journal of Materials Research 5 (1990) 2209-2217.
36. Innocenzi, P. et al: Order-disorder transitions and evolution of silica structure in self-assembled mesostructured silica film studied through FTIR spectroscopy. Journal of Physical Chemistry B 107 (2003) 4711-4717.
37. Irvine, TN: A guide to the chemical classification of the common volcanic rocks. Canadian Journal of Earth Sciences 8 (1971) 523-548. Bibcode:1971CaJES . . . 8 . . . 5231. doi:10.1139/e71-055.
38. Jimenez, A. et al: Synthesis of pollucite and analcime zeolites by recovering aluminum from a saline slag. Journal of Cleaner Production 297 (2021) 126667.
39. Karingithi, C W et al: Processes controlling aquifer fluid compositions in the Olkaria geothermal system, Kenya. Journal of Volcanology and Geothermal Research 196 (2010) 57-76.
40. Kobayashi, T. et al: Solubility of zirocnium (IV) hydrous oxides. Journal of Nuclear Science and Technology 44 (2007) 90-94.
41. Königsberger, E et al: The boehmite ‘solubility gap’. Dissolution/precipitation kinetics of boehmite and gibbsite: Application of a pH-relaxation technique to study near-equilibrium rates. Hydrothermal 110 (2011) 33-39.
42. Kosa, S A et al: Characterization and structure elucidation of binary Zr:Ti MEL structure; Simultaneous photodegradation/removal of organic-inorganic pollutant. Catalysts 11 (2021) 633. doi.org/10.3390/catal11050633.
43. Kwakye-Awuah, B et al: Production of silver-doped analcime by isomorphous substitution technique. Journal of Chemical Technology and Biotechnology 83 (2008) 1255-1260.
44. Li, B et al: Calcined sodium silicate as an efficient and benign heterogeneous catalyst for the transesterification of natural lecithin to L-a-glycerophosphocholine. Green Process Synthesis 8(2019)78-84.
45. Li, X et al: Modified tricalcium silicate cement formulations with added ziconium oxide. Clinical Oral Investigations 21 (2017) 895-905 DOI 10.1007/s00784-016-1843-y.
46. Liu, B S et al: Fabrication of analcime zeolite fibers by hydrothermal synthesis. Microporous and Mesoporous Materials 86 (2005) 106-111.
47. Liu, C et al: Hydrothermal processing on potassic syenite powder: Zeolite synthesis and potassium release kinetics. Advanced Powder Technology 30 (2019) 2483-2491.
48. Luo, Z: Structure of boehmite-derived c-alumina and its transformation mechanism revealed by electron crystallography. Acta Crystallographica B 77 (2021) 772-784.
49. Mantovani, M et al: Effect of pressure on kaolinite illitization. Applied Clay Science 50 (2010) 342-347.
50. Marulanda, V et al: Supercritical water oxidation of a heavily PCB-contaminated mineral transformer oil: Laboratory-scale data and economic assessment. Journal of Supercritical Fluids 54 (2010) 258-265.
51. Mehta, S K et al: A new approach to phase transformations in gibbsite: the role of the crystallinity. Thermochimica Acta, 205 (1992) 191-203.
52. Mozgawa, W et al: FT-IR studies of zeolites from different structural groups. Chemik 65 (2011) 671-674.
53. Muraoka, H., et al. The Japan Beyond-Brittle project. Sci. Drill 17, (2014), 51-59.
54. Palin, E J et al: Computational study of tetrahedral Al—Si ordering in muscovite. Phys Chem Minerals 28 (2001) 534-544.
55. Pyatina, T. et al: Cements with supplementary cementitious materials for high-temperature geothermal wells. Geothermics 86 (2020) 101840. DOI:10.1016/j.geothermics.2020.101840
56. Ragnarsdottir, K V et al: Experimental determination of corundum solubilities in pure water between 400-700° C. and I-3 kbar. Geochimica et Cosmochimica Acta 49 (1985) 2109-2115.
57. Rajaram, K et al: Surfactant assisted fabrication of different nanostructure of boehmite by hydrothermal process. International Journal of Application Engineering Research 12 (2017) 2781-2787.
58. Ramasamy, V et al: Mineral characterization and crystalline natural of quartz in ponnaiyar river sediments, tamilnadu, India. American-Eurasian Journal of Scientific Research 4 (2009) 103-107.
59. Reinsch, T. et al. Utilizing supercritical geothermal systems: a review of past ventures and ongoing research activities. Geotherm. Energy 1-25 (2017). doi:10.1186/s40517-017-0075-y
60. Roy, D M, et al. New high temperature cementing materials for geothermal wells: stability and properties. Final report. United States: N. p., 1980. Web. doi:10.2172/6765245.
61. Sakuma, S., et al. Evaluation of High-Temperature Well Cement for Supercritical Geothermal Drilling. in GRC Transactions, Vol. 45 268-283 (2021).
62. Samarakoon, M H et al: Carbonation-induced properties of alkali-activated cement exposed to saturated and supercritical CO2. International Journal of Greenhous Gas Control 110 (2021) 103429.
63. Santosa, P D S et al: Synthesis of well-crystallised boehmite crystals of various shapes. Materials Research 12 (2009) 437-445.
64. Sarkar, D. et al, Synthesis and characterization of sol-gel derived ZrO2 doped Al₂O₃ nanopowder, Ceram. Int. 33 (2007) 1275-1282.
65. Sauki, A B et al: Effects of pressure and temperature on well cement degradation by supercritical CO2. International Journal of Engineering & Technology 53 (2015) 53-61.
66. Shveikin, G P et al: Particle-size hierarchy in zirconium hydroxide deposits on inert supports. Inorganic Materials 41 (2005) 476-482.
67. Sokolova, E et al: Vlasovite, Na2Zr(Si4011), from the kipawa alkaline complex, Quebec, Canada: Crystal-structure refinement and infrared spectroscopy. The Canadian Mineralogist 44 (2006) 1349-1356.
68. Stefansson, A et al: Isotope systematics of Icelandic thermal fluids. Journal of Volcanology and Geothermal Research 337 (2017) 146-164.
69. Sugama, T. Alkali-Activated Cement Composites for High Temperature Goethermal Wells.

United States: N. p., 2018. Web. doi:10.2172/1501578.
70. Sugama, T., et al. Sodium-polyphosphate-modified fly ash/calcium aluminate blend cement: durability in wet, harsh geothermal environments. Mater. Lett. 44, 45-53 (2000).
71. Sunil Kumar, C et al: Monohydroxy oxide (boehmite, AlOOH) as a reactive binder for extrusion of alumina ceramics. Journal of the European Ceramic Society 17 (1997) 1167-1171.
72. Tarte, P: Infra-red spectra of inorganic aluminates and characteristic vibrational frequencies of AlO4 tetrahedra and AlO6 octahedra. Spectrochimica Acta Part A: Molecular Spectroscopy 23A (1967) 2127-2143.
73. Tsuchida, T: Hydrothermal synthesis of submicrometer crystals of boehmite. Journal of the European Ceramic Society 20 (2000) 1759-1764.
74. Vereshchagina, T et al: Hydorthermal Co-processing of coal fly ash cenospheres and soluble Sr(II) as environmetally sustainable approach to Sr-90 immobilization in a mineral-like form. Materials 2021, 14, 5586. doi.org/10.3390/ma14195586.
75. Vereshchagina, T A et al: Synthesis and structure of analcime and analcim-zirconia composite derived from coal fly ash cenospheres. Microporous and Mesoporous Materials 258 (2018) 228-235.
76. Walther, C et al: Invesigaion of polynyclear Zr(IV) hydroxide complexes by nanoelectrospray mass-spectrometry combined with XAFS. Analytical and Bioanalytical Chemistry 388 (2007) 409-431.
77. Woodland, A B et al: Experimental determination of the solubility of the assemblage paragonite, albite, and quartz in supercritical H2O. Geochimica et Cosmochimica Acta 51 (1987) 365-372.
78. Xyla, A G et al: Quantitative analysis of calcium carbonate polymorphs by infrared spectroscopy. Journal of Chemical Society, Faraday Trans. I 85 (1986)3165-3172.
79. Yang, X et al: A study of sodium silicate in aqueous solution and sorbed by synthetic magnetite using in situ ATR-FTIR spectroscopy. Journal of Colloid and Interface Science 328 (2008) 41-47.
80. Ylmen, R et al: Carbonation of Portland cement studied by diffuse refection Fourier transform infrared spectroscopy. International Journal of Concrete Structure and Materials 7 (2013) 119-125.

What is claimed is:

1. A cementitious material composition, comprising an aluminum source, a filler; and an alkali activator.

2. The cementitious material composition of claim 1, wherein the aluminum source comprises aluminum hydroxide, aluminum chloride, aluminum sulfate, aluminum nitrate, or any combination thereof.

3. The cementitious material composition of claim 1, wherein the filler comprises silica flour, hydrous Zr (IV) oxide, metakaolin, fly ash, diatomaceous earth, perlite, silica fume, blast furnace slag, rice husk ash, or any combination thereof.

4. The cementitious material composition of claim 1, wherein the alkali activator comprises sodium metasilicate, potassium silicate, sodium hydroxide, potassium hydroxide, or any combination thereof.

5. The cementitious material composition of claim 1, wherein the aluminum source is greater than 50% by weight of the cementitious material.

6. The cementitious material composition of claim 1, further comprising one or more transition metals.

7. The cementitious material composition of claim 6, wherein the one or more transition metals comprise Zr, Ni, Zn, or any combination thereof.

8. The cementitious material composition of claim 6, wherein the one or more transition metals is from about 1% by weight to about 15% by weight of the aluminum source.

9. The cementitious material composition of claim 1, further comprising thermally conductive particles.

10. The cementitious material composition of claim 9, wherein the thermally conductive particles comprise graphene, carbon nanotubes, carbon fibers, carbon black, graphite, or any combination thereof.

11. The cementitious material composition of claim 1, wherein the aluminum source is about 50% to 90% by weight of the cementitious material;
wherein filler is about 0.1% to 90% by weight of the cementitious material; and
wherein the alkali activator is about 0.1% to 90% by weight of the cementitious material.

12. The cementitious material composition of claim 1, wherein the cementitious material composition is at least 50% calcium free.

13. A method for making a cementitious article, the method comprising:
(a) admixing an aluminum source, a filler, and an alkali activator to form a slurry;
(b) admixing a sufficient amount of water with the slurry to form a self-flowing slurry;
(c) pouring the self-flowing slurry into a mold; and
(d) curing the self-flowing slurry to form a cementitious article;
wherein curing the cementitious article comprises an initial curing step at 85° C., a second curing step at 300° C., and a final curing step conducted at a temperature of about 400° C. and a pressure of about 24.5 MPa to about 25.5 MPa.

14. The method of claim 13, wherein at least one intermediate phase selected from harmotome, p-zeolite, and analcime is suppressed during curing of the cementitious article.

15. A cementitious article made by the method of claim 13.

16. The cementitious article of claim 15, wherein the cementitious article includes one or more crystalline phases selected from boehmite, paragonite, and vlasovite.

17. The cementitious article of claim 15, wherein the cementitious article has a change in water-fillable porosity of about 10% or less after 7 days at 400° C.

18. The cementitious article of claim 15, wherein the cementitious article has a compressive strength of about 2000 psi or greater after 7 days at 400° C.

19. The cementitious article of claim 15, wherein the cementitious article has a Young's modulus of about 200 kpsi or greater after 7 days at 400° C.

20. The cementitious article of claim 15, wherein the cementitious article comprises a sheath for a geothermal well.
